(19) United States
(12) Patent Application Publication
(10) Pub. No.: US 2026/0335889 A1
(43) Pub. Date: Oct. 29, 2026

(54) VERTICAL FLOW CELL FOR BIOMOLECULE EXTRACTION

(71) Applicant: Twist Bioscience Corporation, South San Francisco, CA (US)

(72) Inventors: Anthony DE LA CRUZ, San Francisco, CA (US); Pranav SUNDARAM, San Francisco, CA (US); Roger RUDOFF, Cupertino, CA (US); Scott INDERMUEHLE, Danville, CA (US)

(73) Assignee: Twist Bioscience Corporation, South San Francisco, CA (US)

(21) Appl. No.: 19/157,171

(22) PCT Filed: Feb. 16, 2024
(86) PCT No.: PCT/US2024/016177

§ 371 Date: Aug. 15, 2025

Related U.S. Application Data
(60) Provisional application No. 63/485,672, filed on Feb. 17, 2023.

(51) Int. Cl. B01L 3/00

(52) U.S. Cl. CPC B01L 3/502738; B01L 2200/0647; B01L 2200/16; B01L 2300/0663; B01L 2400/0487; B01L 2400/06

(57) ABSTRACT

Described herein are systems and methods for extracting biomolecules. Systems for extracting biomolecules can comprise a flow cell, a first reservoir, and a second reservoir. Methods for extracting molecules can comprise introducing liquid to the flow cell, evacuating the liquid from the flow cell, determining an amount of liquid recovered from the cavity, and adjusting a parameter of the system to determine conditions for recovering the maximum amount of liquid from the cavity.

### CROSS-REFERENCE TO RELATED APPLICATIONS

This application claims priority to U.S. Provisional Application No. 63/485,672, filed on Feb. 17, 2023, which is hereby incorporated by reference in its entirety.

### BACKGROUND

Biomolecules on an array can be extracted using flow devices (e.g., flow cells). A reagent can be introduced to a flow device with a substrate. The reagent can be held in the device for a predetermined period of time, and subsequently drained to force out the liquid.

### SUMMARY

Provided herein is a system for extracting biomolecules from a substrate, comprising: (a) a flow cell comprising a cavity, wherein the cavity comprises a planar surface that is substantially parallel to a body force, and wherein the planar surface comprises a substrate comprising a plurality of biomolecules; (b) a first reservoir connected to the flow cell, wherein the first reservoir comprises a liquid for extracting the plurality of biomolecules from the substrate; and (c) a second reservoir connected to the flow cell for displacing liquid in the cavity. In some instances, further comprising a controller communicatively coupled to one or more actuators that open and close valves connected to the flow cell, the first reservoir, or the second reservoir. In some instances, the controller is communicatively coupled to one or more electronic sensors, mechanical sensors, or both that sense conditions of the flow cell, wherein the controllers is programed to regulate flow of fluids in the system. In some instances, the cavity comprises a first opening and a second opening. In some instances, further comprising a first manifold connecting the cavity and the first reservoir, wherein the first manifold is connected to the first opening. In some instances, further comprising a second manifold connecting the cavity and the second reservoir, wherein the second manifold is connected to the second opening. In some instances, the first opening, the second opening, or both are located on opposite sides of the cavity. In some instances, the first opening, the second opening, or both comprises a plurality of holes. In some instances, the plurality of holes comprises two to fifteen holes. In some instances, each of the plurality of holes are 100 microns to 400 microns. In some instances, the second reservoir comprises a pressurized reservoir. In some instances, the second reservoir comprises a pump. In some instances, further comprising a sample collection reservoir connected to the flow cell for collecting the plurality of biomolecules. In some instances, the sample collection reservoir is connected to the flow cell through the first manifold. In some instances, the flow cell and the second reservoir are connected through a second manifold. In some instances, further comprising a waste reservoir connected to the flow cell for collecting waste from the system. In some instances, the waste reservoir is connected to the flow cell through the first manifold, the second manifold, or both. In some instances, further comprising a plurality of reservoirs for holding liquid. In some instances, each liquid of the plurality of reservoirs comprises a different liquid. In some instances, the liquid comprises a reagent for biomolecule extraction. In some instances, the liquid has a surface tension of 1×10⁻³ N/m to 90×10⁻³ N/m. In some instances, the liquid has a viscosity of 0.1×10⁻³ Pa s to 5×10⁻³ Pa s. In some instances, the cavity is oriented at a first angle of 90° relative to a horizontal plane, wherein the horizontal plane is perpendicular to the body force. In some instances, the cavity is further oriented a second angle of 45° relative to the horizontal plane. In some instances, the cavity has a first length of 15 mm to 22 mm and a second length of 15 mm to 22 mm. In some instances, the cavity has third length of 0.1 mm to 0.4 mm. In some instances, the cavity is formed from a recess in the flow cell. In some instances, the cavity is enclosed by an O-ring, wherein the O-ring creates a fluidic boundary. In some instances, the flow cell comprises a Hele-Shaw flow cell.

Further provided herein is a flow cell device comprising: (a) a cavity comprising a first opening and a second opening, wherein the cavity comprises a planar surface that is substantially parallel to a body force; (b) a first manifold connected to the first opening; and (c) a second manifold is connected to the second opening, wherein the second manifold is located diagonally from the first manifold. In some instances, the body force comprises a gravitational force. In some instances, the cavity is oriented at a first angle of 90° relative to a horizontal plane, wherein the horizontal plane is perpendicular to the body force. In some instances, the cavity is further oriented a second angle of 45° relative to the horizontal plane. In some instances, the cavity has a first length of 15 mm to 22 mm and a second length of 15 mm to 22 mm. In some instances, the cavity has third length of 0.1 mm to 0.4 mm. In some instances, the cavity is formed from a recess in the flow cell. In some instances, the cavity is enclosed by an O-ring, wherein the O-ring creates a fluidic boundary. In some instances, the flow cell comprises a Hele-Shaw flow cell. In some instances, the first opening, the second opening, or both are located on opposite sides of the cavity. In some instances, the first opening, the second opening, or both comprises a plurality of holes. In some instances, the plurality of holes comprises about two to fifteen holes. In some instances, each of the plurality of holes are 100 microns to 400 microns.

Also provided herein is a method for determining one or more conditions for recovering a maximum amount of liquid from a cavity in a flow cell, comprising: (a) providing a system comprising: (i) a flow cell comprising a cavity, wherein the cavity comprises a first opening and a second opening, wherein the cavity comprises a planar surface that is substantially parallel to a body force; (ii) a first reservoir for holding a liquid connected to the first opening; and (iii) a second reservoir connected to the second opening; (b) introducing the liquid to the cavity of the flow cell; (c) evacuating the liquid from the cavity of the flow cell; (d) determining an amount of the liquid recovered from the cavity; (e) adjusting a parameter of the system, wherein the parameter comprises a fill rate of the liquid, a volume of the liquid, the liquid, an evacuation rate of the liquid, a capillary number, or one or more angles of the flow cell relative to a horizontal plane, wherein the horizontal plane is perpendicular to a body force; (f) repeating (b)-(e) to determine the one or more conditions for recovering the maximum amount of liquid from the cavity of the flow cell. In some instances, determining the amount of the liquid recovered from the cavity comprises comparing a property of the liquid after evacuating the liquid from the cavity to the property of the liquid before filling the cavity with the liquid. In some instances, the property comprises weight, density, or volume. In some instances, determining the amount of the liquid recovered from the cavity further comprises determining a recovery efficiency. In some instances, the body force comprises a gravitational force. In some instances, the fill rate of the liquid is 10 uL/s to 50 uL/s. In some instances, the volume of the liquid is 500 uL to 700 uL. In some instances, the evacuation rate of the liquid is about 0.5 uL/s to 50 uL/s. In some instances, the cavity is oriented at a first angle of 90° relative to the horizontal plane, wherein the horizontal plane is perpendicular to the body force. In some instances, the cavity is further oriented a second angle of 45° relative to the horizontal plane. In some instances, the cavity has a first length of 15 mm to 22 mm and a second length of 15 mm to 22 mm. In some instances, the cavity has third length of 0.1 mm to 0.4 mm. In some instances, the cavity is formed from a recess in the flow cell. In some instances, the cavity is enclosed by an O-ring, wherein the O-ring creates a fluidic boundary. In some instances, the flow cell comprises a Hele-Shaw flow cell. In some instances, the first opening, the second opening, or both are located on opposite sides of the cavity. In some instances, the first opening, the second opening, or both comprises a plurality of holes. In some instances, the plurality of holes comprises two to fifteen holes. In some instances, each of the plurality of holes are 100 microns to 400 microns.

Further provide herein is a method of extracting biomolecules from a substrate, comprising: (a) providing a system comprising: (i) a flow cell comprising a cavity, wherein the cavity comprises a first opening and a second opening, wherein the cavity comprises a planar surface that is substantially parallel to a body force; (ii) a first reservoir for holding a liquid connected to the first opening; and (iii) a second reservoir connected to the second opening; (b) providing a substrate comprising a plurality of biomolecules to the cavity; (c) introducing the liquid to the cavity of the flow cell through the first opening; (d) evacuating the liquid from the cavity of the flow cell through the first opening, wherein the liquid comprises the plurality of biomolecules, thereby extracting the plurality of biomolecules from the substrate. In some instances, further comprising removing the liquid in excess from the second opening after introducing the liquid to the cavity of the flow cell. In some instances, evacuating the liquid from the cavity of the flow cell through the first opening comprises introducing air to the cavity through the second opening. In some instances, further comprising collecting the liquid comprising the plurality of biomolecules in a sample collector. In some instances, further comprising storing the sample collector. In some instances, the liquid is introduced at a fill rate of 10 uL/s to 50 uL/s. In some instances, a volume of the liquid introduced to the cavity is 500 uL to 700 uL. In some instances, the liquid is evacuated from the cavity at an evacuation rate of 0.5 uL/s to 50 uL/s. In some instances, further comprising mixing more than one liquid from a plurality of reservoirs, each holding a different liquid. In some instances, the liquid comprises a reagent for biomolecule extraction. In some instances, the liquid has a surface tension of 1×10⁻³ N/m to 90×10⁻³ N/m. In some instances, the liquid has a viscosity of 0.1×10⁻³ Pa s to 5×10⁻³ Pa s. In some instances, the cavity is oriented at a first angle of 90° relative to the horizontal plane, wherein the horizontal plane is perpendicular to the body force. In some instances, the cavity is further oriented a second angle of 45° relative to the horizontal plane. In some instances, the cavity has a first length of 15 mm to 22 mm and a second length of 15 mm to 22 mm. In some instances, the cavity has third length of 0.1 mm to 0.4 mm. In some instances, the cavity is formed from a recess in the flow cell. In some instances, the cavity is enclosed by an O-ring, wherein the O-ring creates a fluidic boundary. In some instances, the flow cell comprises a Hele-Shaw flow cell. In some instances, the first opening, the second opening, or both are located on opposite sides of the cavity. In some instances, the first opening, the second opening, or both comprises a plurality of holes. In some instances, the plurality of holes comprises two to fifteen holes. In some instances, each of the plurality of holes are 100 microns to 400 microns.

Further provided herein is a platform for biomolecule extraction, comprising: (a) a biomolecule extraction system comprising one or more components, wherein the one or more components comprise a flow cell comprising a cavity for holding a substrate comprising biomolecules, a first reservoir, and a second reservoir; and (b) an apparatus comprising at least one logic element for performing one or more operations based on sensor data from one or more components of the biomolecule extraction system; wherein one or more operations comprise: (i) determining a timing for opening or closing one or more valves connecting the one or more components; (ii) adjusting one or more parameters of the biomolecule extraction system, wherein the one or more parameters comprises a fill rate of the liquid, a volume of the liquid, the liquid, an evacuation rate of the liquid, a capillary number, or one or more angles of the flow cell relative to a horizontal plane, wherein the horizontal plane is perpendicular to a body force; (iii) determining a recovery efficiency of the liquid evacuated from the cavity comprising biomolecules; or (iv) any combination thereof. In some instances, further comprising a cloud computing resource communicably coupled to the apparatus. In some instances, the computer-implemented system comprises at least one processor, a memory, and instructions executable by at least one processor. In some instances, the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC). In some instances, the body force comprises gravity. In some instances, the platform further comprises a synthesis module, a sequencing module, an amplification module, or any combination thereof.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a front view of a flow cell, according to some embodiments. The directionality of the liquid flow is illustrated during the process of filling the cavity.

FIG. 2 shows a non-limiting example of a front view of a flow cell, according to some embodiments. The directionality of the liquid flow is illustrated during the process of evacuating the cavity.

FIG. 3 shows a non-limiting example of a front view of a prototype of a flow cell, according to some embodiments. The fluidic boundary and the Kalrez O-ring in the prototype are labelled.

FIG. 4 shows a non-limiting example of a sideview of a flow cell, according to some embodiments. The inlet and outlet holes interfacing with the manifolds are labeled.

FIG. 5 shows a non-limiting example of a sideview of a flow cell at an orientation (z-axis orientation) at an angle α, representing the angle the cavity plane makes with the horizontal plane (x-y plane), according to some embodiments.

FIG. 6 shows a non-limiting example of a front view of a flow cell at an orientation (z-axis orientation) along the corner of the flow cell at an angle β, representing the angle the bottom of the cavity makes with the horizontal plane (x-y plane), according to some embodiments.

FIG. 7 shows a non-limiting example of a snapshot during liquid evacuation by air (from right to left) in a horizontal Hele-Shaw flow cell, according to some embodiments. The snapshot demonstrates the unstable interface (labeled) in the flow cell. The orientation of the flow cell is indicated by the x-y-z axes shown.

FIG. 8 shows a non-limiting example of a snapshot during liquid evacuation by air in a vertical Hele-Shaw flow cell demonstrating control of the air-liquid interface, according to some embodiments. The orientation of the flow cell is indicated by the x-y-z axes shown, and the respective free body diagram of the forces acting on the interface are also shown.

FIG. 9 shows a non-limiting example of a free body diagram of forces involved in the secondary oscillating flow phenomenon for a 0° angle of β, representing the angle formed between the bottom of the cavity and the horizontal plane (x-y plane), according to some embodiments.

FIG. 10 shows a non-limiting example of a free body diagram of forces involved in a flow cell with 45° angle of β, representing the angle formed between the bottom of the cavity and the horizontal plane (x-y plane), according to some embodiments. The free body diagram demonstrates the role of gravity in draining the liquid from the manifold to reduce the number of orifices acting as sources for the oscillating flow.

FIG. 11 shows a non-limiting example of an experimental setup for demonstrating the concept and method development of a flow cell, according to some embodiments.

FIG. 12 shows a graph illustrating volume loss (μL) as a function of flow rate of evacuation of a fluid (μL/s) for water from a flow cell, according to some embodiments. Data is shown for two angles 0° and 45° angle of β, representing the angle formed between the bottom of the cavity and the horizontal plane (x-y plane).

FIG. 13 shows a graph illustrating volume loss (μL) as a function of capillary number (“Ca”) for water from a flow cell, according to some embodiments. Data is shown for two angles 0° and 45° for angle β, representing the angle formed between the bottom of the cavity and the horizontal plane (x-y plane).

FIG. 14 shows a graph illustrating volume loss (μL) as a function of flow rate of evacuation of a fluid (μL/s) for a extraction reagents from a flow cell, according to some embodiments. Data is shown for two angles 0° and 45° for angle β, representing the angle formed between the bottom of the cavity and the horizontal plane (x-y plane).

FIG. 15 shows a non-limiting example of a flow cell design comprising a single-inlet and single-outlet for liquid extraction, according to some embodiments. The flow cell is oriented at an angle α of 90° and β of 45°, where angle α represents the angle the cavity planes and the horizontal plane (x-y plane) and angle β represents the angle formed between the bottom of the cavity and the horizontal plane (x-y plane).

FIG. 16 shows a non-limiting example of a piping and instrumentation diagram (P&ID) of an automated setup for extraction of biomolecules from substrates in a flow cell, according to some embodiments.

FIG. 17 shows a non-limiting example of a setup of the flow cell integrated with a liquid handling system to provide an automated system for extracting biomolecules from a substrates, according to some embodiments.

FIG. 18 shows a non-limiting example of system for synthesizing, storing, and sequencing a plurality of polynucleotides, according to some embodiments.

FIGS. 19A-19G show non-limiting examples of structures for storing a plurality of polynucleotides, according to some embodiments. FIG. 19A shows a structure that is substantially tubular. FIG. 19B shows a structure comprising a cap and a body that are flush-welded together. FIG. 19C shows structure comprising a removable screw-cap. FIG. 19D shows a structure comprising a septum. FIG. 19E shows a structure comprising two rounded, pill-shaped halves that form a seal when one half is inserted into the other. FIG. 19F shows a structure comprising a substantially flat, disc container with sealable lid. FIG. 19G shows a structure comprising a box with an optionally attached lid.

FIG. 20 shows a non-limiting example of a computing device; in this case, a device with one or more processors, memory, storage, and a network interface.

### DETAILED DESCRIPTION

Standard processes for extracting a certain control volume of liquid completely from a cavity of a flow cell by displacing the liquid with air can be subject to interfacial instabilities due to viscosity differences between the two mediums, also referred to as Saffman-Taylor instability. This instability can generate droplets and fingers of liquid in the cavity that may not be retrieved altogether. This can lead to incomplete or partial removal of liquid from the cavity with some remnant volume still left behind. Conventional systems and methods may not have effective means of confining and growing the gas phase necessary to vacate the flow cell. This can be especially true in a flow cell oriented horizontally. For applications that involve complete retrieval of precious material and biomolecules, for example extraction of polynucleotides, this remnant volume would imply loss of critical material. Thus, there is a need for a solution to stabilize the air-liquid interface, so as to maximize extraction of liquid from a flow cell.

Provided herein are methods and systems for stabilizing a two-phase interface, such as an air-liquid interface, during fluid displacement in a flow cell. Stabilizing the interface can generally comprise a balancing force acting on fluid or the two-phase interface. In some instances, the systems and methods provided herein mitigate interfacial instabilities (e.g., Saffman-Taylor instability) by leveraging orientational techniques. For example, a flow cell may be oriented in a partially or fully vertical position. In some instances, orienting the flow cell vertically comprises orienting a flow cell such that a planar surface of the flow cell is substantially parallel to a body force. In some examples, the body force is a spatially uniform body force. In some examples, the body force comprises a gravitational force. In some examples, the body force further comprises a inertial force, which can depend on the flow rate. In some examples, the force acting on the interface further comprises surface tension. In some examples, the controlled balance between the body force acting on the fluid and the surface tension acting on the interface helps to stabilize the interface in the flow cell. In some examples, the flow cell is a Hele-Shaw flow cell.

The systems and methods provided herein may be applied to recover material on a surface placed in or located in the flow cell. In some instances, the flow cell comprises a cavity in to which a substrate can be placed and enclosed. In some instances, the substrate is integrated in the cavity of the flow cell. In some examples, the flow cell is used to generate biomolecules (e.g., polynucleotide synthesis). In some examples, a flow cell is used to recovery of biomolecules, such as polynucleotides or proteins, or any other biomolecules that have been extracted (e.g., cleaved) from a surface and are suspended in solution. In some instances, the system and methods provided herein maximize recovery of liquid from a flow cell (e.g., Hele-Shaw flow cell) by optimizing design and process parameters (e.g., forces acting on the fluid or interface in the cavity).

In some instances, provided herein is a system for extracting biomolecules from a substrate, comprising one of more of: (a) a flow cell comprising a cavity; (b) a first reservoir connected to the flow cell; and (c) a second reservoir connected to the flow cell. In some examples, the cavity comprises a planar surface that is substantially parallel to a body force. In some examples, the planar surface comprises a substrate comprising a plurality of biomolecules. In some examples, the first reservoir comprises a liquid for extracting the plurality of biomolecules from the substrate. In some examples, the second reservoir is used for displacing liquid from the cavity.

In some instances, provided herein is a flow cell comprising one or more of: (a) a cavity comprising a first opening and a second opening; (b) a first manifold connected to the first opening; and (c) a second manifold for connected to the second opening. In some examples, the cavity comprises a planar surface that is substantially parallel to a body force. In some examples, the second manifold is located diagonally from the first manifold. In some examples, the second opening is located diagonally from the first opening.

In some instances, provided herein is a method for determining one or more conditions for recovering a maximum amount of liquid from a cavity in a flow cell, comprising one or more of: (a) providing a system comprising one or more of: (i) a flow cell comprising a cavity; (ii) a first reservoir for holding a liquid connected to the first opening; and (iii) a second reservoir connected to the second opening; (b) introducing the liquid to the cavity of the flow cell; (c) evacuating the liquid from the cavity of the flow cell; (d) determining an amount of the liquid recovered from the cavity; (e) adjusting a parameter of the system; (f) repeating (b)-(e) to determine the one or more conditions for recovering the maximum amount of liquid from the cavity of the flow cell. In some instances, the cavity comprises a first opening and a second opening. In some instances, the cavity comprises a planar surface that is substantially parallel to a body force. In some instances, the parameter comprises a fill rate of the liquid, a volume of the liquid, the liquid, an evacuation rate of the liquid, a capillary number, or one or more angles of the flow cell relative to a horizontal plane. In some instances, the horizontal plane is perpendicular to a body force.

In some instances, provided herein is a method of extracting biomolecules from a substrate, comprising one or more of: (a) providing a system comprising one or more of: (i) a flow cell comprising a cavity; (ii) a first reservoir for holding a liquid connected to the first opening; and (iii) a second reservoir connected to the second opening; (b) providing a substrate comprising a plurality of biomolecules to the cavity; (c) introducing the liquid to the cavity of the flow cell through the first opening; (d) evacuating the liquid from the cavity of the flow cell through the first opening. In some examples, the cavity comprises a first opening and a second opening. In some examples, the cavity comprises a planar surface that is substantially parallel to a body force. In some examples, the liquid comprises the plurality of biomolecules, thereby extracting the plurality of biomolecules from the substrate.

In some instances, provided herein is a platform for biomolecule extraction, comprising one or more of: (a) a biomolecule extraction system comprising one or more components; and (b) an apparatus comprising at least one logic element for performing one or more operations based on sensor data from one or more components of the biomolecule extraction system. In some instances, the one or more components comprise a flow cell comprising a cavity for holding a substrate comprising biomolecules, a first reservoir, and a second reservoir. In some instances, the one or more operations comprise one or more of: (i) determining a timing for opening or closing one or more valves connecting the one or more components; (ii) adjusting one or more parameters of the biomolecule extraction system; (iii) determining a recovery efficiency of the liquid evacuated from the cavity comprising biomolecules; or (iv) any combination thereof. In some instances, the one or more parameters comprises a fill rate of the liquid, a volume of the liquid, the liquid, an evacuation rate of the liquid, a capillary number, or one or more angles of the flow cell relative to a horizontal plane. In some instances, the horizontal plane is perpendicular to a body force.

### Systems and Devices for Biomolecule Extraction

Provided herein are flow cell devices for extracting biomolecules from a substrate. In some instances, the flow cell comprises a housing defining a flow chamber, i.e., a cavity. In some instances, the flow cell comprises an opening for receiving a substrate. In some instances, the substrate is integrated into the cavity of a flow cell. The substrate can comprise a surface comprising a plurality of biomolecules, such as polynucleotides or proteins. In some instances, the cavity can enclose a substrate and be fluidically sealed. In some examples, the opening of the flow cell can be configured to be sealable after the array substrate is placed therein, to prevent the leakage of fluids from the flow cell through the opening. Such seals may include a flexible material that is sufficiently flexible or compressible to form a fluid tight seal that may be maintained under increased pressures encountered in the use of the device. The flexible member may be, for example, rubber, flexible plastic, flexible resins, and the like and combinations thereof. In one aspect, the flexible material is substantially inert with respect to the fluids introduced into the device and does not interfere with the reactions that occur within the device. The flexible member may be a gasket. The flexible member may be in any shape such as, for example, circular, oval, rectangular, and the like, e.g., the flexible member may be in the form of an O-ring (e.g., FFKM Kalrez O-ring), in certain embodiments.

In some instances, the flow cell can comprise two halves. In some examples, the two halves can be brough into proximity to enclose a substrate and may fluidically seal the substrate. In some examples, when the flow chamber comprises two halves, the halves may be stably associated by providing mating elements (e.g., a prong on one half that fits into an opening of another half). However, in another aspect, the two halves may be stably associated by clamps or other pressure sealing mechanisms. In one aspect, the two halves are sealable and engaged during reaction steps (e.g., synthesis steps) and are separable at other times to permit the support to be placed into and removed from the chamber of the flow cell. Movement of the one half with respect to the other may be achieved by means of, for example, pistons, and so forth. The movement may be controlled electronically by means that are conventional in the art.

The dimension of the flow cell, the cavity therein, or both can be varied. In some instances, the dimension of flow cell, the cavity, or both is varied depending on the dimension of the substrate that is placed in the flow cell. In some instances, the substrate comprises an array on to which a chemical compounds is synthesized. In some examples, the cavity has a first length and a second length (e.g., length and width). In some examples, the cavity is substantially rectangular. In some instances, a first length, a second length, or both, of cavity is about 15 to 22 mm. In some instances, a first length, a second length, or both, of cavity is about 15 to 16, 15 to 17, 15 to 18, 15 to 19, 15 to 20, 15 to 21, 15 to 22, 16 to 17, 16 to 18, 16 to 19, 16 to 20, 16 to 21, 16 to 22, 17 to 18, 17 to 19, 17 to 20, 17 to 21, 17 to 22, 18 to 19, 18 to 20, 18 to 21, 18 to 22, 19 to 20, 19 to 21, 19 to 22, 20 to 21, 20 to 22, or 21 to 22 mm. In some instances, a first length, a second length, or both, of cavity is about 15, 15.5, 16, 16.5, 17, 17.5, 17.9, 18, 18.5, 19, 19.5, 19.9, 20, 20.5, 21, 21.5, or 22 mm. In some instances, a first length, a second length, or both, of cavity is at least about 15, 15.5, 16, 16.5, 17, 17.5, 18, 18.5, 19, 19.5, 20, 20.5, 21, or 21.5 mm. In some instances, a first length, a second length, or both, of cavity is at most about 15.5, 16, 16.5, 17, 17.5, 18, 18.5, 19, 19.5, 20, 20.5, 21, 21.5, or 22 mm. In some instances, the first length of the cavity is about 17.9 mm and the second length of the cavity is about 19.9 mm. In some instances, the cavity comprises a third length (e.g., height). In some examples, the cavity is formed in a recess in the body of the flow cell. In some examples, the cavity is formed via a separate shim with both surface planar. In some examples, a top surface can comprise a polymer, such as PEEK or PPS, or any other suitable polymer known in the art. In some examples, a top surface can comprise a metal (e.g., solid metal) or plated plastic. In some instances, the top surface can comprise an out of plane cathode, for example, using a conductive material. In some examples, a metal, such as platinum is used for the plating, or stainless steel, which may also plated.

In some examples, a third length of a cavity is about 0.1 to 0.5 mm. The third length of the cavity may refer to the gap between the top and the bottom planar surface of the cavity. In some instances, a third length of cavity is about 0.1 to 0.15, 0.1 to 0.2, 0.1 to 0.25, 0.1 to 0.3, 0.1 to 0.35, 0.1 to 0.4, 0.1 to 0.45, 0.1 to 0.5, 0.15 to 0.2, 0.15 to 0.25, 0.15 to 0.3, 0.15 to 0.35, 0.15 to 0.4, 0.15 to 0.45, 0.15 to 0.5, 0.2 to 0.25, 0.2 to 0.3, 0.2 to 0.35, 0.2 to 0.4, 0.2 to 0.45, 0.2 to 0.5, 0.25 to 0.3, 0.25 to 0.35, 0.25 to 0.4, 0.25 to 0.45, 0.25 to 0.5, 0.3 to 0.35, 0.3 to 0.4, 0.3 to 0.45, 0.3 to 0.5, 0.35 to 0.4, 0.35 to 0.45, 0.35 to 0.5, 0.4 to 0.45, 0.4 to 0.5, or 0.45 to 0.5 mm. In some instances, a third length of cavity is about 0.1, 0.15, 0.2, 0.25, 0.3, 0.35, 0.4, 0.45, or 0.5 mm. In some instances, a third length of cavity is at least about 0.1, 0.15, 0.2, 0.25, 0.3, 0.35, 0.4, or 0.45 mm. In some instances, a third length of cavity is at most about 0.15, 0.2, 0.25, 0.3, 0.35, 0.4, 0.45, or 0.5 mm. In some instances, the flow cell is a Hele-Shaw flow cell, where the height of the cavity is much smaller in comparison to the length and the width. In some instances, the dimensions of the substrate are less than the dimensions of the cavity. In some instances, the dimension of the flow cell is greater than the dimensions of the cavity. In some instances, the gap is formed by machined recesses. In some instances, the gap is formed using shims to set the gap, and the top and bottom are allowed to be machined, and optionally further lapped flat. In some examples, this fabrication can be easier to machine, can result in a more accurate gap size (or third length), or both.

The volume containable by the cavity of the flow cell can vary. In some instances, the volume in the cavity is about 22 to about 242 mm³. In some instances, the volume in the cavity is about 22 to 45, 22 to 53, 22 to 68, 22 to 89, 22 to 95, 22 to 115, 22 to 125, 22 to 145, 22 to 194, 22 to 242, 45 to 53, 45 to 68, 45 to 89, 45 to 95, 45 to 115, 45 to 125, 45 to 145, 45 to 194, 45 to 242, 53 to 68, 53 to 89, 53 to 95, 53 to 115, 53 to 125, 53 to 145, 53 to 194, 53 to 242, 68 to 89, 68 to 95, 68 to 115, 68 to 125, 68 to 145, 68 to 194, 68 to 242, 89 to 95, 89 to 115, 89 to 125, 89 to 145, 89 to 194, 89 to 242, 95 to 115, 95 to 125, 95 to 145, 95 to 194, 95 to 242, 115 to 125, 115 to 145, 115 to 194, 115 to 242, 125 to 145, 125 to 194, 125 to 242, 145 to 194, 145 to 242, or 194 to 242 mm³. In some instances, the volume in the cavity is about 22, 45, 53, 68, 89, 95, 115, 125, 145, 194, or 242 mm³. In some instances, the volume in the cavity is at least about 22, 45, 53, 68, 89, 95, 115, 125, 145, or 194 mm³. In some instances, the volume in the cavity is at most about 45, 53, 68, 89, 95, 115, 125, 145, 194, or 242 mm³.

The flow cell device provided herein can comprise an insulating member around at least a portion of the device. The flow cell device can expose a substrate within the cavity to a flow of fluid, where a first end of the substrate and/or a second end of the substrate is exposed to a fluid comprising substantially the same composition at a given time interval. In some instances, the flow cell can be used for extracting biomolecules from a substrate. In some instances, the flow cell can be used for performing in situ synthesis of biomolecules (e.g., polynucleotides or polypeptides) on the substrate.

The flow cell can have an opening. In some instances, the flow cell comprises at least two openings. In some instances, the flow cell comprises first opening and a second opening, for example, an inlet and an outlet. In some instances, in operation, outlet port(s) sit vertically above inlet port(s). In some instances, in operation, outlet port(s) sit diagonal to inlet port(s). In some examples, the flow cell comprises 1 to 25 inlet holes, outlet holes, or both. In some instances, the flow cell comprises 1 to 2, 1 to 5, 1 to 8, 1 to 10, 1 to 12, 1 to 15, 1 to 20, 1 to 22, 1 to 25, 2 to 5, 2 to 8, 2 to 10, 2 to 12, 2 to 15, 2 to 20, 2 to 22, 2 to 25, 5 to 8, 5 to 10, 5 to 12, 5 to 15, 5 to 20, 5 to 22, 5 to 25, 8 to 10, 8 to 12, 8 to 15, 8 to 20, 8 to 22, 8 to 25, 10 to 12, 10 to 15, 10 to 20, 10 to 22, 10 to 25, 12 to 15, 12 to 20, 12 to 22, 12 to 25, 15 to 20, 15 to 22, 15 to 25, 20 to 22, 20 to 25, or 22 to 25 inlet holes, outlet holes, or both. In some instances, the flow cell comprises 1, 2, 5, 8, 10, 12, 15, 20, 22, or 25 inlet holes, outlet holes, or both. In some instances, the flow cell comprises at least 1, 2, 5, 8, 10, 12, 15, 20, or 22 inlet holes, outlet holes, or both. In some instances, the flow cell comprises at most 2, 5, 8, 10, 12, 15, 20, 22, or 25 inlet holes, outlet holes, or both. In some instances, the number and position of inlet holes, outlet holes, or both is varied to bias flow across different regions of the flow cell. However, in some instances, the number of inlet holes and outlet holes are uniform to provide for an unbiased flow. In some instances, inlet holes are uniformly spaced along the bottom of the cavity. In some instances, the outlet holes are uniformly spaced along the top of the cavity. In some instances, inlet holes are not uniformly spaced along the bottom of the cavity. In some instances, the outlet holes are not uniformly spaced along the top of the cavity. In some instances, uniform flow is attained, provided the inlet and outlet are symmetric. In some examples, uniform flow is attained, provided the inlet and outlet are symmetric, but the spacing between the inlet holes or outlet holes are not uniform.

The at least two openings of the cavity can vary in size. The at least two openings may be drilled into the housing of the flow cell. In some instances, the at least two openings are located on opposite sides of the cavity, for example in diagonal corners of a rectangular cavity, or along opposing sides of a rectangular cavity. In some instances, each of the at least two openings (e.g., inlet and outlet hole(s)) is about 100 to 500 μm. In some instances, each of the at least two openings has a diameter of about 100 to 150, 100 to 200, 100 to 250, 100 to 300, 100 to 350, 100 to 400, 100 to 450, 100 to 500, 150 to 200, 150 to 250, 150 to 300, 150 to 350, 150 to 400, 150 to 450, 150 to 500, 200 to 250, 200 to 300, 200 to 350, 200 to 400, 200 to 450, 200 to 500, 250 to 300, 250 to 350, 250 to 400, 250 to 450, 250 to 500, 300 to 350, 300 to 400, 300 to 450, 300 to 500, 350 to 400, 350 to 450, 350 to 500, 400 to 450, 400 to 500, or 450 to 500 μm. In some instances, each of the at least two openings has a diameter of about 100, 150, 200, 250, 300, 350, 400, 450, or 500 μm. In some instances, each of the at least two openings has a diameter of at least about 100, 150, 200, 250, 300, 350, 400, or 450 μm. In some instances, each of the at least two openings has a diameter of at most about 150, 200, 250, 300, 350, 400, 450, or 500 μm. In some examples, the one or more openings of the cavity are connected to one or more manifolds for feeding fluid (e.g., liquid, gas, or both) in and/or out of the cavity. In some instance, the diameter of a first opening and a second opening of the at least two openings are the same. In some instance, the diameter of a first plurality of opening and a second plurality of opening of the at least two openings are the same. In some instance, the diameter of a first opening and a second opening of the at least two openings are different. In some instance, the diameter of a first plurality of opening and a second plurality of opening of the at least two openings are different.

In some instances, high pressure at one or more openings (e.g., inlet holes) equalizes pressure in a manifold. In some instances, a manifold provides a mechanism for removing bubbles, or to reduce the presence of bubbles in the one or more openings (e.g., inlet holes). In some instances, the diameter of an outlet hole in the flow cell which connects or is connectable to a manifold is larger than the diameter of an inlet hole, e.g., at least about 1-fold larger, at least about 1.5-fold larger, at least about 2-fold larger or at least about 4-fold larger. In some instances, flow through the inlet and/or outlet hole(s) to the manifolds is controlled by providing a valve whose opening and closing is controlled by a controller, such as a micro-processor.

In some instances, roles of one or more manifolds may be reversed between or during operation of the flow cell device. In some examples, it is advantageous to introduce a fresh reagent from the top of the flow cell (e.g., such as when the fresh reagent is less dense than the resident liquid). In some instances, a valve can be shut in a manifold (e.g., top manifold) to increase pressure in the manifold for introducing liquid into the flow cell through the outlets and the manifold (e.g., bottom manifold) can be used to vent the flow cell device.

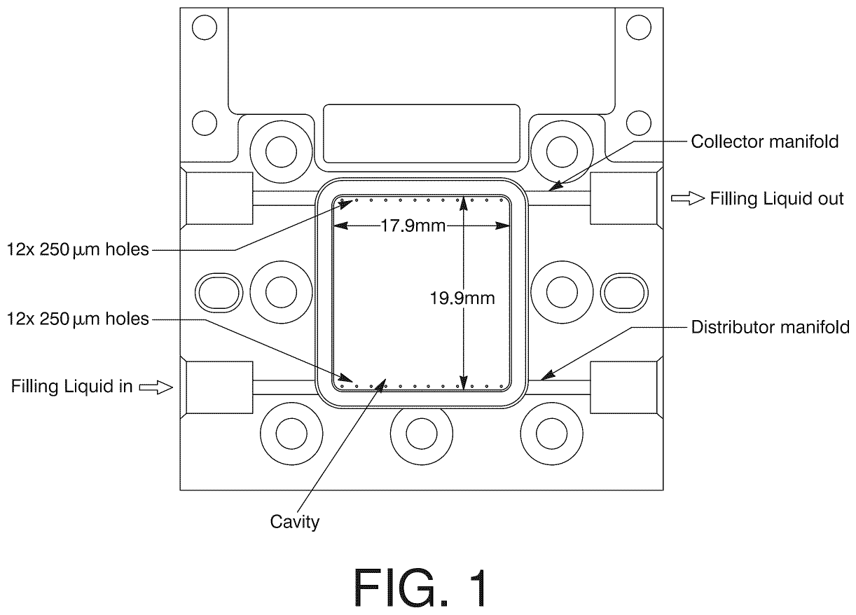

An exemplary diagram of a flow cell is provided in FIG. 1. A first and second length of the cavity of the flow cell is shown (e.g., 17.9 mm×19.9 mm). A plurality of openings are shown lining the top and the bottom of the flow cell. In this exemplary embodiment, the top and bottom of the flow cell are each lined uniformly with 12 holes, where each of the holes is about 250 μm. Arrows are shown indicating the directionality of a fluid flow during the process of filing the cavity. The liquid is filled through a first manifold (bottom left, e.g., distributor manifold) and excess fluid leaves the cavity through a second manifold (top right, e.g., collector manifold). In some examples, the plurality of openings (e.g., outlet holes) lining the top of the cavity are connected to the second manifold (top right) in order to remove the liquid from the cavity of the flow cell. In some examples, the plurality of openings (e.g., inlet holes) lining the bottom of the cavity are connected to the first manifold (bottom left) in order to fill the cavity with the liquid.

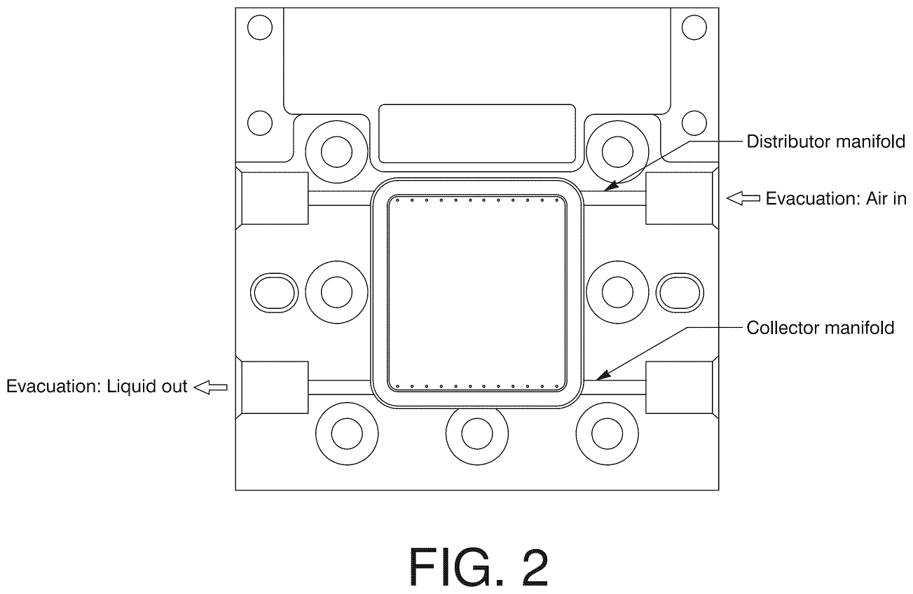

FIG. 2 illustrates the exemplary flow cell with arrows shown indicating the directionality of the fluid during evacuation from the cavity. During evacuation, air is added to the cavity from the second manifold (top right, e.g., distributor manifold) and liquid is removed from the cavity through the first manifold (bottom left, e.g., collector manifold).

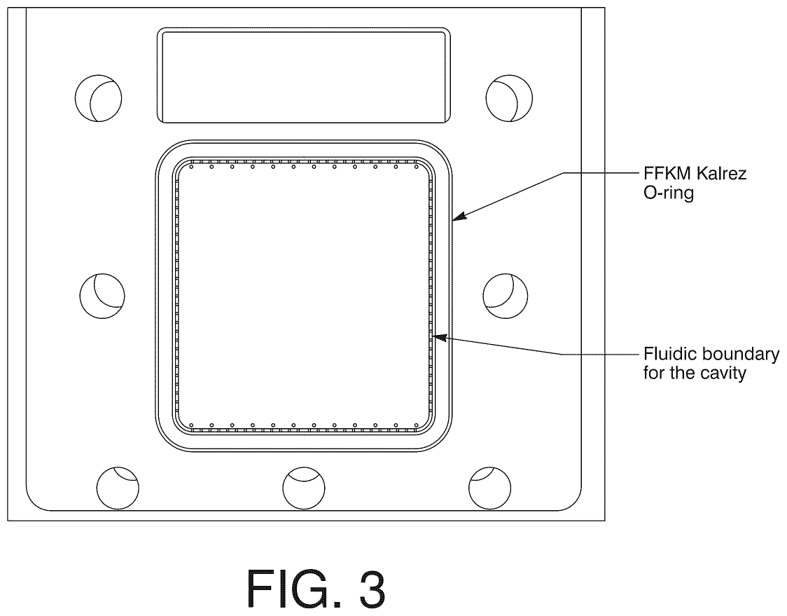

A prototype of the flow cell is provided in FIG. 3, with the cavity of the flow cell surrounded by the Kalrez O-ring forming the fluidic boundary, as labeled.

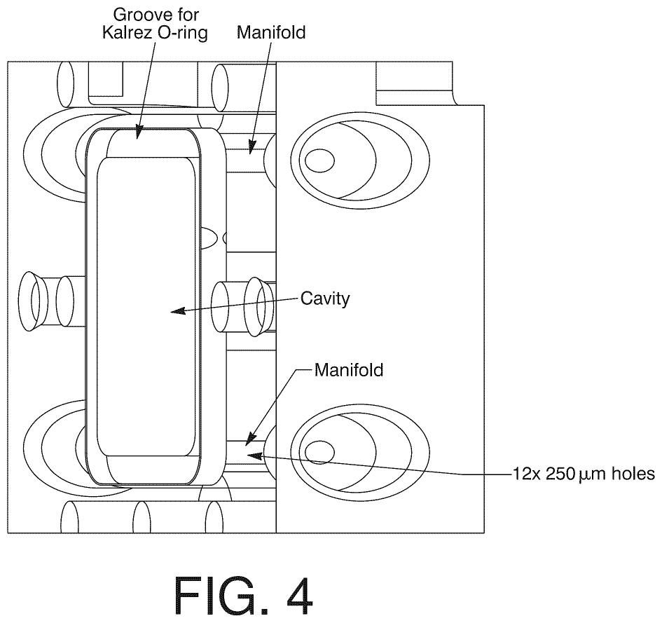

FIG. 4 illustrates a sideview of the exemplary flow cell. The manifolds on the top and bottom are labeled that provide a fluidic connection to the cavity of the flow cell. As shown, the inlet and outlet holes interface with the manifolds underneath. The fluidic connection allow for fluid (e.g., liquid, gas, or both) to enter or leave the cavity through a plurality of holes lining the top and bottom of the flow cell. The cavity is lined uniformly with twelve holes on the top and bottom, each about 250 μm. In some examples, the cavity is formed from a recess in the flow cell, so that the cavity is about 0.25 mm in height. The groove for a Kalrez O-ring is also shown and labeled. The groove may be dovetailed to ensure the O-ring is retailed. In some instances, the groove is a single-sided dovetail. In some instances, the groove is double-sided dovetail.

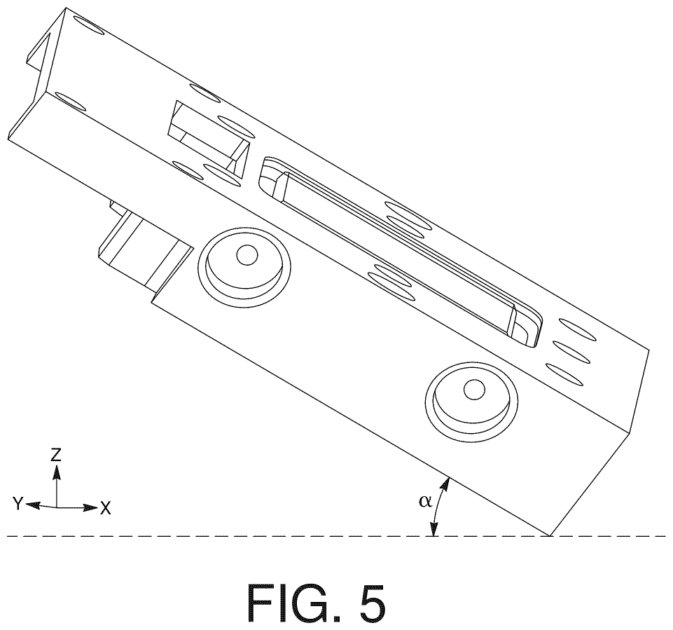

One or more angles of the orientation of the flow cell may be adjusted. In some instances, the flow cell may be partially or fully vertical during operation of the flow cell. In some instances, “at least partially vertical” refers to an orientation in which a planar surface of the cavity comprising the inlet hole(s) and outlet hole(s) is placed is at an angle of greater then about 0° relative to a horizonal plane (x-y plane), as shown for example in FIG. 5. As shown in FIG. 5, the flow cell can be in a z-axis orientation, so that the cavity plane is oriented at an angle α with respect to the horizontal plane. In some instances, angle α is about 0° to 90°. As used herein, angle α refers to the angle between the planar surface of the cavity relative to a horizontal plane, as illustrated in FIG. 5. In some instances, angle α is about 0° to 10°, 0° to 20°, 0° to 30°, 0° to 40°, 0° to 50°, 0° to 60°, 0° to 70°, 0° to 80°, 0° to 90°, 10° to 20°, 10° to 30°, 10° to 40°, 10° to 50°, 10° to 60°, 10° to 70°, 10° to 80°, 10° to 90°, 20° to 30°, 20° to 40°, 20° to 50°, 20° to 60°, 20° to 70°, 20° to 80°, 20° to 90°, 30° to 40°, 30° to 50°, 30° to 60°, 30° to 70°, 30° to 80°, 30° to 90°, 40° to 50°, 40° to 60°, 40° to 70°, 40° to 80°, 40° to 90, 50° to 60°, 50° to 70°, 50° to 80°, 50° to 90°, 60° to 70°, 60° to 80°, 60° to 90°, 70° to 80°, 70° to 90°, or 80° to 90°. In some instances, angle α is about 0°, 10°, 20°, 30°, 40°, 50°, 60°, 70°, 80°, or 90°. In some instances, angle α is at least about 0°, 10°, 20°, 30°, 40°, 50°, 60°, 70°, or 80°. In some instances, angle α is at most about 10°, 20°, 30°, 40°, 50°, 60°, 70°, 80°, or 90°.

The planar surface of the cavity may be substantially parallel to a body force. In some examples, the body force comprises a gravitational force, electric force, or magnetic force. In some examples, the body force comprises a fictitious force, such as a centrifugal force, Coriolis force, or Euler force. In some instances, the planar surface of the cavity is substantially parallel to a gravitational force. Referring to FIG. 5, a planar surface of the cavity being substantially parallel to a gravitational force comprises an orientation of the flow cell at an angle α of about 90°.

The flow cell may be placed in a vertical orientation using a stand or base. The flow cell may comprises or may be connectable to a base station or platform to which, in some instances, one or more fluid dispensing stations can be stably associated (e.g., by mounting). In some examples, a mount is used to place the flow cell on a stand or base, such that the flow cell can be oriented at one or more angles.

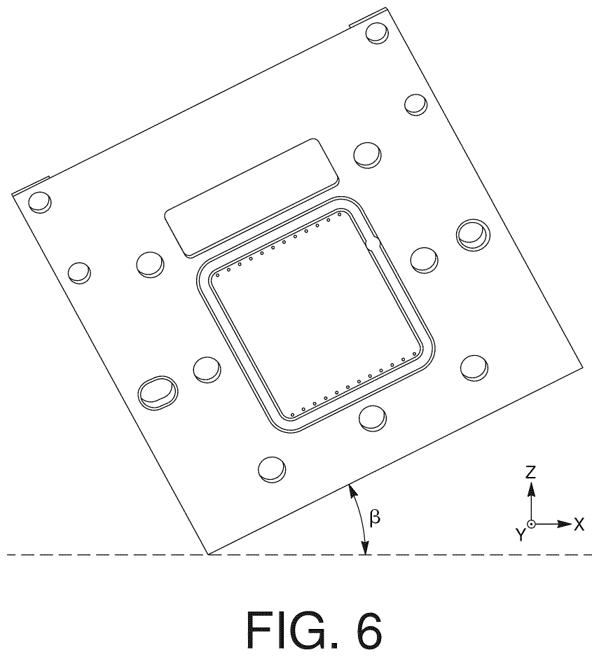

The flow cell may further be oriented at a second angle. The second angle may be an orientation of the flow cell device along the corner of the flow cell relative to a horizonal plane, as exemplary illustrated in FIG. 6. This angle may be referred to as angle β. Angle β as used herein refers to the angle formed between the corner of the bottom of the flow cell device and the horizontal plane, as illustrated in FIG. 6. In some instances, angle β is about 0° to 60°. In some instances, angle β is about 0° to 5°, 0° to 10°, 0° to 15°, 0° to 20°, 0 to 25, 0 to 30, 0° to 35°, 0° to 40°, 0° to 45°, 0° to 50°, 0° to 55°, 0° to 60°, 5° to 10°, 5° to 15°, 5° to 20°, 5° to 25°, 5° to 30°, 5° to 35°, 5° to 40°, 5° to 45°, 5° to 50°, 5° to 55°, 5° to 60°, 10° to 15°, 10° to 20°, 10° to 25°, 10° to 30°, 10° to 35°, 10° to 40°, 10° to 45°, 10° to 50°, 10° to 55°, 10° to 60°, 15° to 20°, 15° to 25°, 15° to 30°, 15° to 35°, 15° to 40°, 15° to 45°, 15° to 50°, 15° to 55°, 15° to 60°, 20° to 25°, 20° to 30°, 20° to 35°, 20° to 40°, 20° to 45°, 20° to 50°, 20° to 55°, 20° to 60°, 25° to 30°, 25° to 35°, 25° to 40°, 25° to 45, 25° to 50°, 25° to 55°, 25° to 60°, 30° to 35°, 30° to 40°, 30° to 45°, 30° to 50°, 30° to 55°, 30° to 60°, 35° to 40°, 35° to 45°, 35° to 50°, 35° to 55°, 35° to 60°, 40° to 45°, 40° to 50°, 40° to 55°, 40° to 60°, 45° to 50°, 45° to 55°, 45° to 60°, 50° to 55°, 50° to 60°, or 55° to 60°. In some instances, angle β is about 0°, 5°, 10°, 15°, 20°, 25°, 30°, 35°, 40°, 45°, 50°, 55°, or 60°. In some instances, angle β is at least about 0°, 5°, 10°, 15°, 20°, 25°, 30°, 35°, 40°, 45°, 50° or 55°. In some instances, angle β is at most about 5°, 10°, 15°, 20°, 25°, 30°, 35°, 40°, 45°, 50°, 55° or 60°. In some instances, the flow cell is oriented at an angle α of about 90° and an angle β of about 45°.

The flow cell may be placed in a vertical orientation and/or rotated using a stand or base. The flow cell may comprises or may be connectable to a base station or platform to which, in some instances, one or more fluid dispensing stations can be stably associated (e.g., by mounting). In some examples, a mount is used to place the flow cell on a stand or base. In some instances, the stand or the base allows the flow cell to be oriented at one or more angles, such as angles α or β as described herein. In some instances, a user or an automated system (e.g., robotic system) is used to adjust or orient the flow cell at one or more angles (e.g., angles α or β). In some instances, angle β is built into the flow cell. In such instances, there may not be a need for an external mount to rotate the flow cell since the cavity (or groove) is built into the flow cell at an angle. In such instances, the true angle β may be zero.

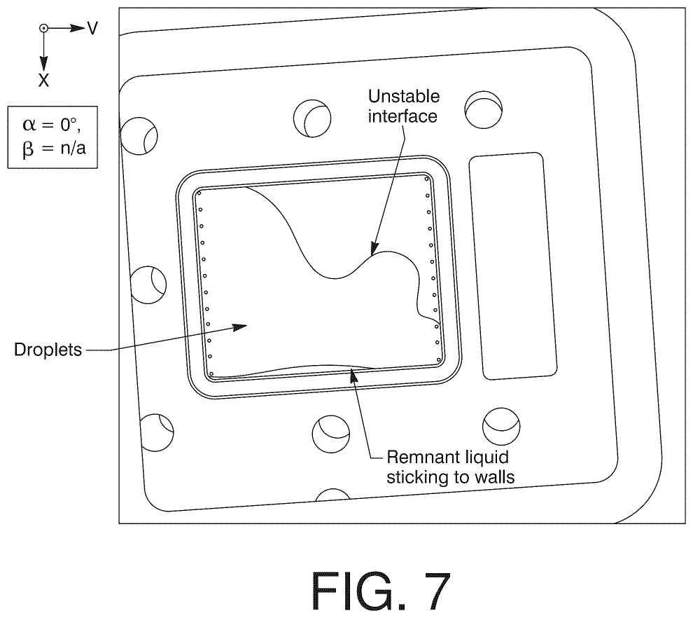

In some instances, when two mediums of different viscosities such as air and liquid interact with each other, the interface can develop instabilities known as Saffman-Taylor instability. This can cause growing fingers of one phase presented into another phase. An exemplary snapshot demonstrating this unstable interface is shown in FIG. 7, where a Hele-Shaw flow cell is oriented horizontally (in an x-y plane) on a table. As shown by the axes, the flow cell is oriented at an angle α of 0°. The flow cell contains an orange-colored reagent inside the cavity. The liquid is extracted out of the flow cell from right to left by displacing the liquid with air in a controlled manner. The unstable interface between the liquid and air is labeled, in addition to remanent liquid sticking on the walls. In addition, the cavity includes the remanent droplets in the cavity.

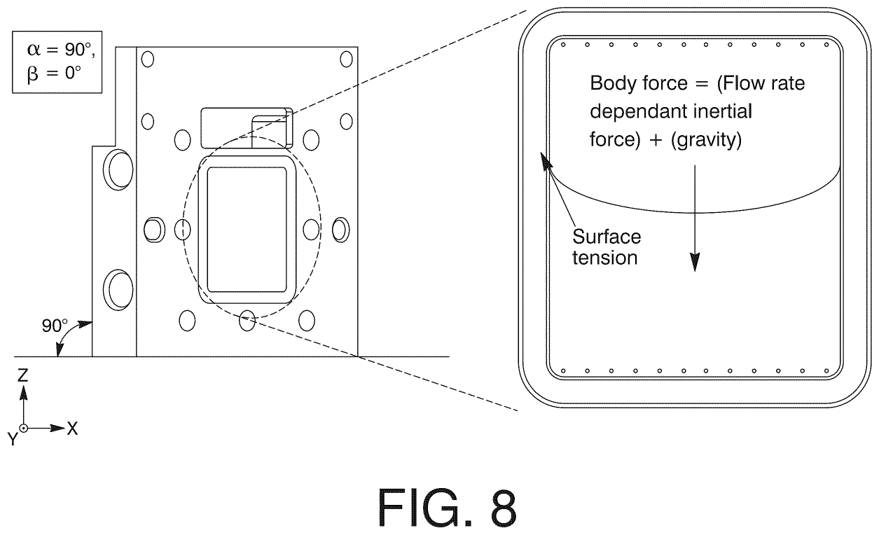

Orientating the flow cell vertically can reduce instability (e.g., Saffman-Taylor instability) between two phases in the cavity. In some instances, the instability is resolved partially or fully by making use of gravity as a spatially uniform body force to control the behavior of this air-liquid interface. A snapshot of an exemplary flow cell model and prototype in a vertical orientation (angle α of 90° and β of 45°) is shown in FIG. 8. The orientation of the flow cell is illustrated by the axes on the model (FIG. 8, left) and the respective free body diagram of the forces acting on the interface are shown on the image of the prototype (FIG. 8, right). As shown, the interface in FIG. 8 does not comprise the unstable interface, remanent liquid, or droplets, which were present in FIG. 7. Instead, the planar surface of the cavity is substantially parallel to a body force, creating a stable interface. In some example, the body force comprises a flow rate dependent inertial force, gravity, or both. In some examples, the body force comprises a summation of a flow rate dependent inertial force and gravity. In some examples, the stability of the air-liquid interface is impacted by the balance of this body force and the surface tension forces present due to the interaction of the interface with the walls and flat surfaces enclosing the cavity (as labeled in FIG. 8).

The stability of the interface can be quantified using one or more quantitative parameters. This parameter may be referred to as a critical parameter. The one or more parameters may represent or comprise one or more forces (e.g., gravity, surface tension, inertial force, etc.) acting within the cavity of the flow cell. In some instances, the parameter comprises a capillary number. The capillary number comprises a single dimensionless number, generally calculated using the following formula: Ca=μV/γ, where μ is the dynamic viscosity of the liquid, V is the average velocity, and γ is the surface tension forces. Thus, the capillary number may be calculated by bulk inertial forces divided by the surface tension forces. In some instances, the capillary number precisely measures this relative contribution from the body forces versus the surface tension forces. In some instances, the capillary number acts as an important parameter that needs to be controlled to show good stability of the interface and maximize liquid recovery. In some instances, methods provided herein allow for precise control of the capillary number via the flow rate and optimization of process variables such as angular orientation (e.g., angles α and β). In some instances, methods demonstrated herein show a stable air-liquid interface that allow for smooth extraction of fluid from the cavity.

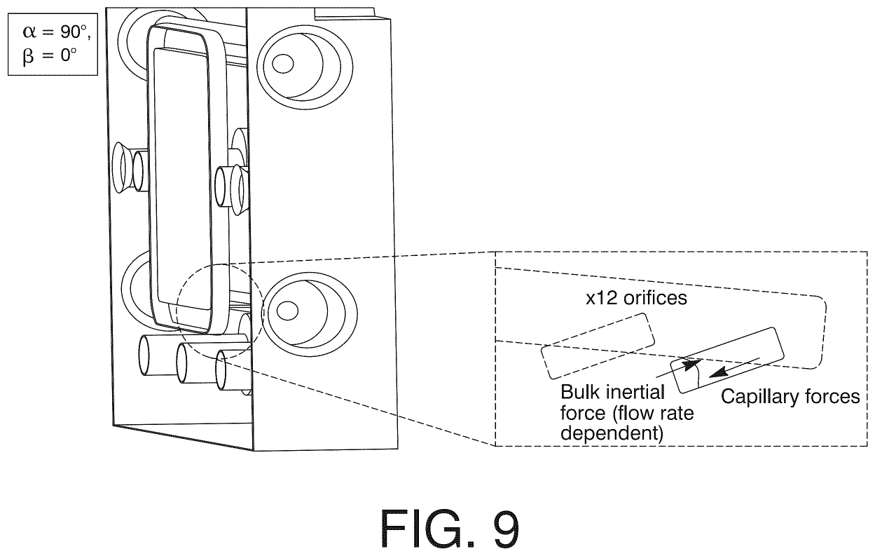

In some instances, a flow cell brings about a secondary phenomenon related to the interplay between capillary forces and body forces on the fluid present in the one or more manifolds. For example, it can be empirically observed that when the angle β is at 0°, the body force on the fluid in the manifold orifices or openings (e.g., inlet and outlet holes) can compete against the capillary pressure on the same, thereby generating an oscillating flow that has a flow-rate dependent frequency and amplitude. An illustration of this phenomenon is provided in FIG. 9, which shows a side view of a vertical flow cell (i.e., α=90°) with a free body diagram of forces involved in the secondary oscillating flow phenomenon for angle β at 0°.

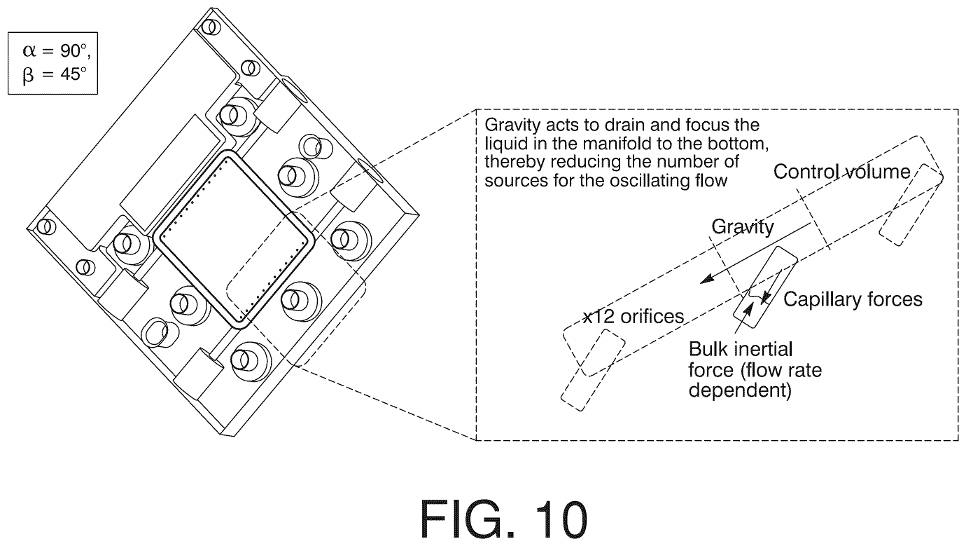

In some instances, the oscillating flow results in remnant volume in the cavity as fluid is pushed back into the flow cell via one or more orifices or openings (e.g., inlet and outlet holes). In some examples, this remnant volume cannot be evacuated, leading to a further decrease in the efficiency of fluid retrieval from the flow cell. The underlying manifold and multiple orifices can lead to flow complexity by acting as reservoirs and multiple sources of oscillating flow, leading to more liquid entrained in the cavity. In some instances, this secondary phenomenon can resolved by optimizing angle β. In some examples, angle β is optimized through experimentation based on the flow rate, fluid, volume, capillary number, or any combination thereof. In some examples, angle β is greater than 0°. In some examples, angle β is 45°. In some instances, optimizing angle β, for example, angle β is 45°, minimizes the oscillating flow reliably by essentially draining the liquid by tilting and exploiting gravity as a body force to counteract the capillary forces. An illustration of this is provided in FIG. 10, which shows front view of a vertical flow cell (i.e., α=90°) with a free body diagram of forces involved in the secondary oscillating flow phenomenon for angle β at 45°. The free body diagram demonstrates the role of gravity in draining the fluid from the manifold to reduce the number of orifices acting as sources for the oscillating flow.

A flow cell may comprise no more than two openings. In some instances, the presence of multiple orifices and a manifold, such as the twelve holes connected to a collector or a distributor manifold as shown in FIG. 1, results in the secondary phenomenon of oscillating flow. In some examples, each orifice of the multiple orifices acts as a source for this oscillating flow to develop, which can further increase the volume entrapped in the cavity of the flow cell. Thus, in some instances, a flow cell comprising a single inlet and single outlet design is contemplated. In some examples, other process parameters (e.g., angles α or β) are maintained to further simplify the design, minimize this phenomenon, or both.

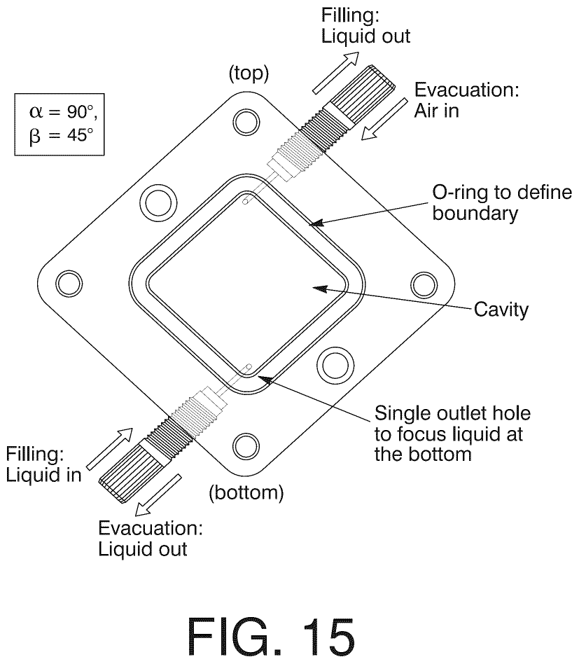

For example, a flow cell oriented at angles α=90° and β=45°, as shown in FIG. 15, may comprise no more than two openings. The cavity may be substantially rectangular or square. The fluidic boundary of the cavity may be defined by the O-ring, which can fluidically seal the cavity. In some instances, the O-ring comprises a Kalrez O-ring. In some instances, the O-ring comprises FFKM polymers. In some instances, the material of the O-ring depends on the one or more reagents, reactions, or processes carried out in the cavity. For example, for enzymatic synthesis, a standard O-ring material, such as those known in the art, can be used. Non-limiting examples of O-ring material may comprise nitrile, neoprene, ethylene propylene, silicone, fluorocarbon, or PTFE. In some instances, the flow cell comprises a first opening at the bottom and a second opening at the top. In an exemplary embodiment, when the cavity is being filled, the liquid can enter from the first opening (bottom), and any excess liquid can be removed from the second opening (top). Further, when the cavity is being evacuated, air may be filled through the second opening (top) and the liquid in the cavity is evacuated through the first opening (bottom).

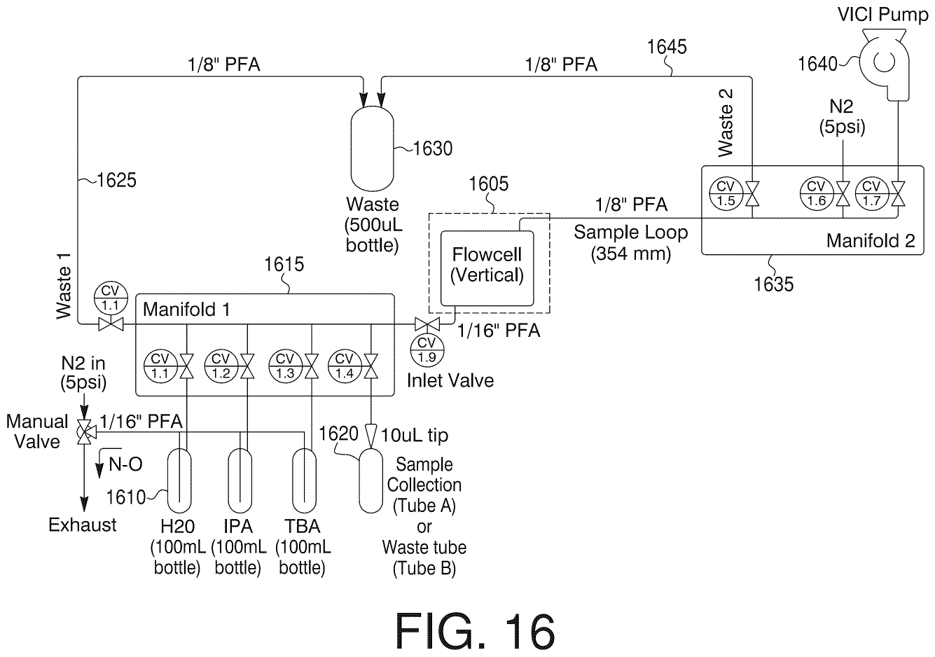

A flow cell as provided herein can be integrated into a system, such as system for extracting material on a surface. In some instances, the system extracts biomolecules, such as polynucleotides, from a substrate. In some instances, the flow cell comprising a cavity is oriented such that a planar surface of the cavity is substantially parallel to a body force in the system. In some examples, a substrate comprising a plurality of biomolecules is placed within the cavity or integrated into the cavity, and is fluidically sealed (e.g., using an O-ring). An exemplary system is provided in FIG. 16.

The system can comprise a reservoir or one or more reservoirs 1610. In some instances, the reservoir 1610 is connected or connectable to a flow cell 1605. In some examples, the flow cell 1605 is the same or similar to the flow cell shown for example in FIG. 15. In some examples, the flow cell 1605 is the same or similar to the flow cell shown for example in FIG. 6. In some examples, the flow cell 1605 is at an orientation such that α>0°, β>0°, or both. In some examples, the flow cell 1605 is at an orientation such that α≤90°, β≤45°, or both. In some examples, the flow cell 1605 is at an orientation such that 0°<α≤90°, 0°<β≤45°, or both. In some examples, the flow cell 1605 is at an orientation such that a planar surface of the cavity is substantially parallel to a body force, such as gravity. In some instances, the reservoir 1610 and the flow cell are stably associated using a base station, platform, or any other suitable equipment (e.g., mounting equipment). In some instances, the reservoir 1610 is part of a fluid dispensing assembly that can be employed to dispense fluids (e.g., water, aqueous media, organic solvents, ionic liquids and the like). In some instances, the system comprises a plurality of reservoirs 1610, each comprising a different fluid. In some instances, the reservoir comprises a liquid for extracting the plurality of biomolecules from the substrate. As provided in FIG. 16, the system may have a plurality of reservoirs 1610, each comprising a different solution. In some instances, a reservoir of the plurality of reservoirs comprises a reagent for synthesis of biomolecules, such as polynucleotides. In some instances, a reservoir of the plurality of reservoirs comprises a reagent for extraction of biomolecules, such as polynucleotides. In some instances, a reservoir comprises water, IPA, or an TBA, as shown in FIG. 16 for simulation of the flow cell development. In some instances, a reservoir of the plurality of reservoirs comprises a reagent for polynucleotide cleavage, for example, TBA, monomethyl ammonia, or any other reagent for cleavage known in the art. It shall be understood by one of ordinary skill in the art that the size of a reservoir comprising a fluid may be adjusted. The size of a reservoir, may be, but is not limited to, about 0.1 mL, 0.2 mL, 0.5 mL, 0.7 mL, 1 mL, 5 mL, 10 mL, 25 mL, 50 mL, 75 mL, 100, or about 2 L. In some examples, the size of the reservoir is at least about 0.1 mL, 0.2 mL, 0.5 mL, 0.7 mL, 1 mL, 5 mL, 10 mL, 25 mL, 50 mL, 75 mL, 100 mL, 250 mL, 500 mL, 750 mL, 1 L, 1.25 L, 1.5 L, 1.75 L, or about 2 L. In some examples, the size of the reservoir is at most about 0.2 mL, 0.5 mL, 0.7 mL, 1 mL, 5 mL, 10 mL, 25 mL, 50 mL, 75 mL, or 100 mL, 250 mL, 500 mL, 750 mL, 1 L, 1.25 L, 1.5 L, 1.75 L, or about 2 L. In some examples, the size of the reservoir is about 0.1 mL to 0.2 mL, 0.1 mL to 0.5 mL, 0.1 mL to 0.7 mL, 0.1 mL to 1 mL, 0.1 mL to 5 mL, 0.1 mL to 10 mL, 0.1 mL to 25 mL, 0.1 mL to 50 mL, 0.1 mL to 75 mL, 0.1 mL to 100 mL, 0.1 mL to 250 mL, 0.1 mL to 500 mL, 0.1 mL to 750 mL, 0.1 mL to 1 L, 0.1 mL to 1.25 L, 0.1 mL to 1.5 L, 0.1 mL to 1.75 L, or about 0.1 mL to 2 L, 0.2 mL to 0.5 mL, 0.2 mL to 0.7 mL, 0.2 mL to 1 mL, 0.2 mL to 5 mL, 0.2 mL to 10 mL, 0.2 mL to 25 mL, 0.2 mL to 50 mL, 0.2 mL to 75 mL, 0.2 mL to 100 mL, 0.2 mL to 250 mL, 0.2 mL to 500 mL, 0.2 mL to 750 mL, 0.2 mL to 1 L, 0.2 mL to 1.25 L, 0.2 mL to 1.5 L, 0.2 mL to 1.75 L, or about 0.2 mL to 2 L, 0.5 mL to 0.7 mL, 0.5 mL to 1 mL, 0.5 mL to 5 mL, 0.5 mL to 10 mL, 0.5 mL to 25 mL, 0.5 mL to 50 mL, 0.5 mL to 75 mL, 0.5 mL to 100 mL, 0.5 mL to 250 mL, 0.5 mL to 500 mL, 0.5 mL to 750 mL, 0.5 mL to 1 L, 0.5 mL to 1.25 L, 0.5 mL to 1.5 L, 0.5 mL to 1.75 L, or about 0.5 mL to 2 L, 0.7 mL to 1 mL, 0.7 mL to 5 mL, 0.7 mL to 10 mL, 0.7 mL to 25 mL, 0.7 mL to 50 mL, 0.7 mL to 75 mL, 0.7 mL to 100 mL, 0.7 mL to 250 mL, 0.7 mL to 500 mL, 0.7 mL to 750 mL, 0.7 mL to 1 L, 0.7 mL to 1.25 L, 0.7 mL to 1.5 L, 0.7 mL to 1.75 L, or about 0.7 mL to 2 L, 1 mL to 5 mL, 1 mL to 10 mL, 1 mL to 25 mL, 1 mL to 50 mL, 1 mL to 75 mL, 1 mL to 100 mL, 1 mL to 250 mL, 1 mL to 500 mL, 1 mL to 750 mL, 1 mL to 1 L, 1 mL to 1.25 L, 1 mL to 1.5 L, 1 mL to 1.75 L, or about 1 mL to 2 L, 5 mL to 10 mL, 5 mL to 25 mL, 5 mL to 50 mL, 5 mL to 75 mL, 5 mL to 100 mL, 5 mL to 250 mL, 5 mL to 500 mL, 5 mL to 750 mL, 5 mL to 1 L, 5 mL to 1.25 L, 5 mL to 1.5 L, 5 mL to 1.75 L, or about 5 mL to 2 L, 10 mL to 25 mL, 10 mL to 50 mL, 10 mL to 75 mL, 10 mL to 100 mL, 10 mL to 250 mL, 10 mL to 500 mL, 10 mL to 750 mL, 10 mL to 1 L, 10 mL to 1.25 L, 10 mL to 1.5 L, 10 mL to 1.75 L, or about 10 mL to 2 L, 25 mL to 50 mL, 25 mL to 75 mL, 25 mL to 100 mL, 25 mL to 250 mL, 25 mL to 500 mL, 25 mL to 750 mL, 25 mL to 1 L, 25 mL to 1.25 L, 25 mL to 1.5 L, 25 mL to 1.75 L, or about 25 mL to 2 L, 50 mL to 75 mL, 50 mL to 100 mL, or 50 mL to 250 mL, 50 mL to 500 mL, 50 mL to 750 mL, 50 mL to 1 L, 50 mL to 1.25 L, 50 mL to 1.5 L, 50 mL to 1.75 L, or about 50 mL to 2 L, 75 mL to 100 mL, 75 mL to 250 mL, 75 mL to 500 mL, 75 mL to 750 mL, 75 mL to 1 L, 75 mL to 1.25 L, 75 mL to 1.5 L, 75 mL to 1.75 L, or about 75 mL to 2 L, 100 mL to 250 mL, 100 mL to 500 mL, 100 mL to 750 mL, 100 mL to 1 L, 100 mL to 1.25 L, 100 mL to 1.5 L, 100 mL to 1.75 L, 100 mL to 2 L, 250 mL to 500 mL, 250 mL to 750 mL, 250 mL to 1 L, 250 mL to 1.25 L, 250 mL to 1.5 L, 250 mL to 1.75 L, 250 mL to 2 L, 500 mL to 750 mL, 500 mL to 1 L, 500 mL to 1.25 L, 500 mL to 1.5 L, 500 mL to 1.75 L, 500 mL to 2 L, 750 mL to 1 L, 750 mL to 1.25 L, 750 mL to 1.5 L, 750 mL to 1.75 L, 750 mL to 2 L, 1 L to 1.25 L, 1 L to 1.5 L, 1 L to 1.75 L, 1 L to 2 L, 1.25 L to 1.5 L, 1.25 L to 1.75 L, 1.25 L to 2 L, 1.5 L to 1.75 L, 1.5 L to 2 L, or 1.75 L to 2 L.

In some instances, the fluid dispensing assembly comprises a second reservoir for moving fluid to or from a reservoir or a plurality of reservoirs 1610. In some instances, the second reservoir comprises a pressurized reservoir or a pressure feed. In some instances, the second reservoir comprises a pump. In some instances, the second reservoir is used to transfer reagents in and out of the cavity. However, in some instances, gravity-based draining may be used to remove liquid from the cavity. In some instances, the fluid dispensing assembly comprises a manifold, a valve assembly, or both 1615 (labeled “Manifold 1” in FIG. 16). In certain aspects, the assembly comprises a mechanism for delivering predetermined quantities of fluid to the flow cell 1605. The fluids may be dispensed by a pumping mechanism. A standard pumping technique for pumping fluids known in the art may be employed in the system. Non-limiting examples of pumping may comprise means of a peristaltic pump, a pressurized fluid bed, a positive displacement pump, e.g., a syringe pump, and the like. In some examples, the system additionally comprises heating and/or cooling elements and/or insulating elements for controlling the temperature within various fluid reservoir(s) 1610, the flow cell 1605, or within the mechanisms for transferring the fluid between the reservoir(s) and flow cell (e.g., manifold 1615), or any combination thereof. In some examples, a heating element comprises a heating jacket, a cartridge heater, or a film heater.

In some examples, a manifold connects or is connectable (e.g., directly or indirectly) to one or more reservoirs, as exemplary shown in FIG. 16. In this way, different fluid reagents can be contacted to a substrate in the flow cell. In some examples, reagents for performing different steps in the synthesis of a chemical compound (e.g., a nucleic acid or polypeptide) may be introduced sequentially into the flow cell.

The system can comprise a top manifold 1635 and a bottom manifold 1615. In some examples, a top manifold and bottom manifold both connect to a same one or more reservoirs. In some examples, a top manifold and bottom manifold each connect to a different one or more reservoirs. The reservoirs may comprise, a waste reservoir, a sample collection reservoir, or one or more reservoirs, each comprising a different fluid. In some examples, a top manifold 1635 and a bottom manifold 1615 both connect to a waste reservoir 1630. In some examples, the top manifold, the bottom manifold, or both, comprise a separate waste reservoir. In some examples, the bottom manifold 1615 is connected to a sample collection reservoir 1620. In some examples, a top manifold is connected to a sample collection reservoir. In some examples, the bottom manifold 1615 is connected to one or more reservoirs, each comprising a different fluid 1610. In some examples, a top manifold is connected to one or more reservoirs, each comprising a different fluid. In some instances, the top manifold connects, or is connectable to, a second reservoir, such as a pump 1640, for displacing fluid from the flow cell. In some instances, the top manifold connects, or is connectable to, a pressurized reservoir for displacing fluid from the flow cell.

Each of the manifolds may be independently controlled. As shown for example in FIG. 16, each manifold may comprise a plurality of valves that can open or close paths between components of the system. In some instances, fluid passing through the top manifold, bottom manifold, or both can be independently controlled, e.g., through the use of automatically or manually operated valves. In some instances, the fluid passing through the system is controlled via a controller, which is coupled to one or more actuators that open and close valves connected to the flow cell, first reservoir (e.g., reagent reservoir), or second reservoir (e.g., pump, pressurized reservoir, pressure feed, etc.). In such instances, the controller is used to control the amount or rate of fluid or gas flow throughout the system.

In some instances, the system comprises a top manifold that communicates with the portion of the flow cell comprising at least one top opening. In some examples, the top manifold comprises a conduit, which communicates with the flow cell comprising at least one top opening. In some instances, the top manifold comprises at least one opening that connect with or are coextensive with the at least one top opening of the flow cell. In some instances, the system comprises a bottom manifold that communicates with the portion of the flow cell comprising at least one bottom opening. In some examples, the bottom manifold comprises a conduit, which communicates with the flow cell comprising at least one bottom opening. A conduit or tube connection to one or more components of the system, as illustrated in FIG. 16, may comprise, by way of non-limiting example, PFA, however, may be any suitable material known in the art. Further, the dimensions of such conduit may be, for example, about ¼″, ⅛″ or 1/16″ in diameter, but may not be limited to those exemplified in FIG. 16. In some instances, the tubing or conduit comprises an outside diameter and an inside diameter. In some instances, the inside diameter or the outside diameter is about 1/16″ to 2″. In some instances, the inside diameter or the outside diameter is about 1/16″, ⅛″, ¼″, ½″, 1″, 1½″, or 2″. In some instances, the inside diameter or the outside diameter is at least about 1/16″, ⅛″, ¼″, ½″, 1″, 1½″, or 2″. In some instances, the inside diameter or the outside diameter is at most about 1/16″, ⅛″, ¼″, ½″, 1″, 1½″, or 2″. In some instances, the inside diameter or the outside diameter is about 1/16″ to ⅛″, 1/16″ to ¼″, 1/16″ to ½″, 1/16″ to 1″, 1/16″ to 1½″, or 1/16″ to 2″, ⅛″ to ¼″, ⅛″ to ½″, ⅛″ to 1″, ⅛″ to 1½″, or ⅛″ to 2″, ¼″ to ½″, ¼″ to 1″, ¼″ to 1½″, or ¼″ to 2″, ½″ to 1″, ½″ to 1½″, or ½″ to 2″, 1″ to 1½″, 1″ to 2″, or 1½″ to 2″. In some instances, the bottom manifold comprises at least one opening that connects with or is coextensive with the at least one bottom opening of the flow cell. In some instances, when the flow cell is in operation, the top manifold is distal to a surface on which the portion of the flow cell comprising the at least one bottom opening is situated. In some examples, the top manifold can be used to introduce or backfill fluid into a fully charged flow cell.

In some instances, the system comprising the flow cell comprises a plurality of top and bottom submanifolds. The top and bottom submanifolds can allow fluid flow (e.g., liquid or gas) to or from the flow cell, for example, by a common top and bottom conduit respectively. In some examples, the plurality of top and bottom submanifolds are connected to one or more separate dispensing lines. In still other aspects, a top and bottom submanifold can be coupled via a common dispensing line, however fluid through the top or bottom manifold can be independently controlled by appropriately placed valves (e.g., through a controller).

The system may further comprise a vacuum source. In some instances, the vacuum source is connected to or in communication with the flow cell. In some instances, the system comprises one or more electronic sensors, mechanical sensors, or both, that sense conditions of the flow cell. In some instances, a controller as described herein is programed to regulate flow of fluids in the system through the one or more sensors. In some examples, the system comprises a fluid level sensor, one or more pressure transducers, one or more pressure regulators, that may be manually or automatically operated valves and/or pumps.

The system can further comprise a mechanisms for facilitating movement of a substrate into and out of a cavity of a flow cell, as described herein. In a non-limiting example, a system can comprise a lift mechanism for placing a substrate into the cavity of a flow cell and/or lifting the substrate out of the cavity of the flow cell in a controlled manner, e.g., manually or in an automated fashion.

The system can further comprise mechanism for transferring a substrate to and from the system as part of a larger platform. The larger platform, in some instances, may generally be used for biomolecule extraction. Such a platform can comprise a biomolecule extraction system described herein (e.g., FIG. 16), generally comprising one or more components, such as a flow cell comprising a cavity for holding a substrate comprising biomolecules, a first reservoir (e.g., reagent reservoir), and a second reservoir (e.g., a pump). The platform can further comprise any other suitable components of the biomolecule extraction system described herein. The platform can further comprise an apparatus comprising at least one logic element for performing one or more operations in the platform. In some instances, one or more operations are performed based on sensor data from one or more components of the biomolecule extraction system. In some instances, the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC). Such an apparatus may be in communication with or coextensive with a controller of a system for biomolecule extraction, as described herein.

An apparatus in a platform may perform one or more operations, such as (i) determining a timing for opening or closing one or more valves connecting the one or more components, (ii) adjusting one or more parameters of the biomolecule extraction system, (iii) determining a recovery efficiency of the liquid evacuated from the cavity comprising biomolecules, or (iv) any combination thereof. In some instances, one or more metrics, parameters, sensor data, or any combination thereof, may be displayed in real time to a user interface. In some instances, one or more metrics, parameters, sensor data, or any combination thereof, may be analyzed in real time to detect anomalies in a system. In some instances, one or more metrics, parameters, sensor data, or any combination thereof, may be stored on the cloud, random access memory, hard-disk drive, solid-state drive, flash memory device, or any variation thereof. In some examples, the apparatus is communicably coupled to a cloud computing resource, which can be used to execute any of the operations provided herein. In some instances, the one or more parameters comprises a fill rate of the liquid, a volume of the liquid, the liquid, an evacuation rate of the liquid, a capillary number, one or more angles of the flow cell relative to a horizontal plane, or any combination thereof.

In some instances, the platform comprises a mechanism for transferring the substrate from the flow cell to another processing device (e.g., a substrate reaction device, for example, for incubating a substrate with a reactant under reaction conditions, such as a synthesis module, a sequencing module, or an amplification module, a washing device, a scanning device, or any combinations thereof). Such mechanism can also be provided to move the substrate from a printing station (e.g., inkjet printing) to the cavity of the flow cell. Transfer mechanisms can include, but are not limited to, robotic arms, and the like, which can be controlled by an apparatus and/or controllers, as described herein. In some instances, a transfer robot is mounted on a platform of an apparatus used in for synthesis. The transfer robot may include a base, an arm that is movably mounted on the base, and a grasping element adapted to grasp the substrate during transport that is attached to the arm. The element for grasping the substrate may be, for example, movable finger-like projections, and the like. In one aspect, in use, the robotic arm is activated so that the substrate is grasped by the grasping element. The arm of the robot is moved so that the substrate is delivered to the flow cell from a printing device. Other componentry may be used to position the substrate, e.g., motors, pistons, conveyers, cranks, levers, etc., where such will be obvious to those of skill in the art in view of the disclosure. As noted above, in some instances, a substrate may be positioned on a substrate holder or lift mechanism within the chamber of the flow cell. In some instances, the holder may be adapted to be moveable to position the substrate appropriately.

### Methods for Biomolecule Extraction

Provided herein for methods for biomolecule extraction. The methods for biomolecule extraction may employ a device, system, platform, or any combination thereof, provided herein. In some instances, the methods for biomolecule extraction employ a flow cell described herein. In some instances, methods are developed to optimize one or more conditions or parameters of a device, system, or platform comprising a flow cell, in order to maximize the fluid recovered from a cavity of the flow cell. In some examples, methods are developed to maximize extraction of liquid from a cavity by changing a process parameter, such as angles α and β as defined herein, or a flow rate of evacuation (e.g., air flow rate for displacing fluid from the cavity of the flow cell). In some examples, methods are developed to demonstrate a relationship between volume of liquid recovered and the capillary number for the liquid (e.g., water, extraction reagent, etc.). In some examples, methods are developed in order to biomolecule extraction using a reagent, such as oligomer extraction, from a surface.

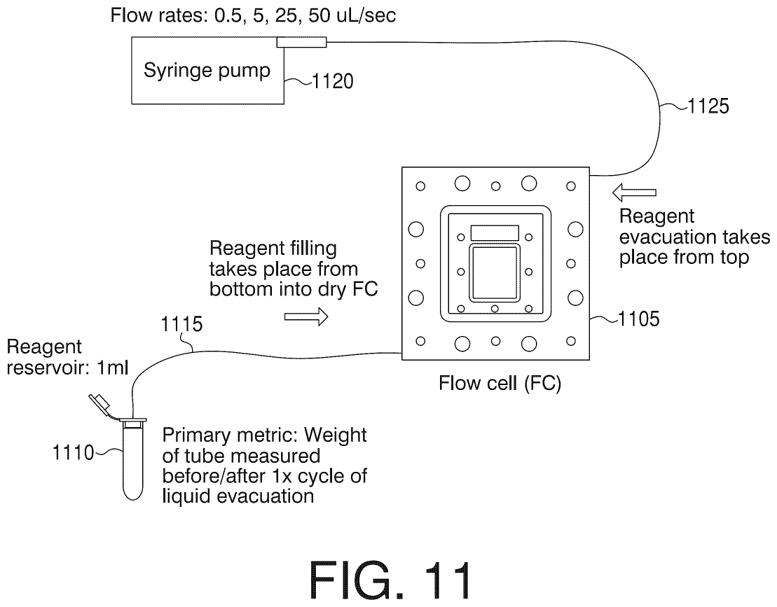

Provided herein is a method for determining one or more conditions for recovering a maximum amount of liquid from a cavity in a flow cell. The method can comprise providing a system, such as the system exemplary shown in FIG. 11. The system can comprise a flow cell comprising the cavity. In some examples, the cavity comprises a planar surface that is substantially parallel to a body force, such as gravity. In some examples, the flow cell comprises a first opening and a second opening, which can be used to fill or evacuate liquid from the cavity. In some examples, the flow cell comprises only two openings (e.g., FIG. 15), which can be used to fill or evacuate liquid from the cavity. In some examples, the flow cell comprises a plurality of openings (e.g., FIG. 6), which can be used to fill or evacuate liquid from the cavity. The system can further comprise a first reservoir for holding a liquid 1110, which can be connected to the first opening using any suitable material known in the art (e.g., PFA) 1115. The system can further comprise a second reservoir, such as a pump 1120, which can be connected to the second opening using any suitable material known in the art (e.g., PFA) 1125.

The method can further comprise introducing the liquid to the cavity of the flow cell. The directionality for filling and evacuating the cavity are provided by the arrows in FIG. 11. For example, the liquid may be the liquid housed in the reservoir 1110, which can be introduced to the cavity via a suitable conduit 1115. In some instances, cavity is filled at a rate (fill rate) of about 0 to 50 μL/s. In some instances, the fill rate is about 0 to 0.5, 0 to 1, 0 to 2.5, 0 to 5, 0 to 10, 0 to 15, 0 to 20, 0 to 25, 0 to 30, 0 to 50, 0.5 to 1, 0.5 to 2.5, 0.5 to 5, 0.5 to 10, 0.5 to 15, 0.5 to 20, 0.5 to 25, 0.5 to 30, 0.5 to 50, 1 to 2.5, 1 to 5, 1 to 10, 1 to 15, 1 to 20, 1 to 25, 1 to 30, 1 to 50, 2.5 to 5, 2.5 to 10, 2.5 to 15, 2.5 to 20, 2.5 to 25, 2.5 to 30, 2.5 to 50, 5 to 10, 5 to 15, 5 to 20, 5 to 25, 5 to 30, 5 to 50, 10 to 15, 10 to 20, 10 to 25, 10 to 30, 10 to 50, 15 to 20, 15 to 25, 15 to 30, 15 to 50, 20 to 25, 20 to 30, 20 to 50, 25 to 30, 25 to 50, or 30 to 50 uL/s. In some instances, the fill rate is about 0, 0.5, 1, 2.5, 5, 10, 15, 20, 25, 30, or 50 μL/s. In some instances, the fill rate is at least about 0, 0.5, 1, 2.5, 5, 10, 15, 20, 25, or 30 μL/s. In some instances, the fill rate is at most about 0.5, 1, 2.5, 5, 10, 15, 20, 25, 30, or 50 μL/s. In some instances, the volume of the liquid filling the cavity is about 0 to 1,000 mL. In some instances, the volume is about 0 to 100, 0 to 200, 0 to 300, 0 to 400, 0 to 500, 0 to 600, 0 to 700, 0 to 800, 0 to 900, 0 to 1,000, 100 to 200, 100 to 300, 100 to 400, 100 to 500, 100 to 600, 100 to 700, 100 to 800, 100 to 900, 100 to 1,000, 200 to 300, 200 to 400, 200 to 500, 200 to 600, 200 to 700, 200 to 800, 200 to 900, 200 to 1,000, 300 to 400, 300 to 500, 300 to 600, 300 to 700, 300 to 800, 300 to 900, 300 to 1,000, 400 to 500, 400 to 600, 400 to 700, 400 to 800, 400 to 900, 400 to 1,000, 500 to 600, 500 to 700, 500 to 800, 500 to 900, 500 to 1,000, 600 to 700, 600 to 800, 600 to 900, 600 to 1,000, 700 to 800, 700 to 900, 700 to 1,000, 800 to 900, 800 to 1,000, or 900 to 1,000 mL. In some instances, the volume is about 0, 100, 200, 300, 400, 500, 600, 700, 800, 900, or 1,000 mL. In some instances, the volume is at least about 0, 100, 200, 300, 400, 500, 600, 700, 800, or 900 mL. In some instances, the volume is at most about 100, 200, 300, 400, 500, 600, 700, 800, 900, or 1,000 mL. In some instances, the cavity is filled, in part, using capillary-based filling.

The method can further comprise evacuating the liquid to the cavity of the flow cell. For example, the liquid can be evacuated from the cavity using a second reservoir, e.g., a pump 1120, which can be used to introduce air into the cavity via a suitable conduit 1125, and evacuate liquid from the cavity. In some instances, cavity is evacuated at a rate (evacuation rate) of about 0 to 50 μL/s. In some instances, the evacuation rate is about 0 to 0.5, 0 to 1, 0 to 2, 0 to 5, 0 to 7, 0 to 10, 0 to 15, 0 to 20, 0 to 25, 0 to 30, 0 to 50, 0.5 to 1, 0.5 to 2, 0.5 to 5, 0.5 to 7, 0.5 to 10, 0.5 to 15, 0.5 to 20, 0.5 to 25, 0.5 to 30, 0.5 to 50, 1 to 2, 1 to 5, 1 to 7, 1 to 10, 1 to 15, 1 to 20, 1 to 25, 1 to 30, 1 to 50, 2 to 5, 2 to 7, 2 to 10, 2 to 15, 2 to 20, 2 to 25, 2 to 30, 2 to 50, 5 to 7, 5 to 10, 5 to 15, 5 to 20, 5 to 25, 5 to 30, 5 to 50, 7 to 10, 7 to 15, 7 to 20, 7 to 25, 7 to 30, 7 to 50, 10 to 15, 10 to 20, 10 to 25, 10 to 30, 10 to 50, 15 to 20, 15 to 25, 15 to 30, 15 to 50, 20 to 25, 20 to 30, 20 to 50, 25 to 30, 25 to 50, or 30 to 50 μL/s. In some instances, the evacuation rate is about 0, 0.5, 1, 2, 5, 7, 10, 15, 20, 25, 30, or 50 μL/s. In some instances, the evacuation rate is at least about 0, 0.5, 1, 2, 5, 7, 10, 15, 20, 25, or 30 μL/s. In some instances, the evacuation rate is at most about 0.5, 1, 2, 5, 7, 10, 15, 20, 25, 30, or 50 μL/s. In some instances, the cavity is evacuated, in part, using gravity-based draining.

The method can further comprise determining an amount of the liquid recovered from the cavity. In some instances, determining the amount of the liquid recovered from the cavity comprises comparing a property of the liquid after evacuating the liquid from the cavity to the property of the liquid before filling the cavity with the liquid. In some examples, the property comprises weight, density, or volume. Thus, in some examples, determining the amount of the liquid recovered from the cavity comprises comparing a weight of the liquid in a reservoir after evacuating the liquid from the cavity to the property of the liquid before filling the cavity with the liquid. In some instances, determining the amount of the liquid recovered from the cavity further comprises determining a recovery efficiency. The recovery efficiency may be determined by the percentage, fraction, or ratio of the amount of liquid evacuated and recovered from the cavity to the amount of liquid that filled the cavity. In some instances, a recovery efficiency may be measured using concentration. As an example, the concentration of biomolecules initially present within the cavity and/or the concentration retrieved can be measured by spectrophotometric means (e.g., A260/A280 readings), fluorescence, secondary reactions, or any other suitable method known in the art.

A method for determining one or more conditions for recovering a maximum amount of liquid from a cavity in a flow cell can further comprise adjusting a parameter of the system. In some instances, the parameter comprises a fill rate of the liquid, a volume of the liquid, the liquid, an evacuation rate of the liquid, a capillary number, one or more angles of the flow cell relative to a horizontal plane, or any combination thereof. In some examples, the one or more angles comprises an angle relative to a horizontal x-y plane. In some examples, the horizontal x-y plane is perpendicular to the body force, such as gravity. In some instances, the one or more angles of the flow cell comprises angle α, β, or both, as defined herein. In some examples, adjusting one or more angles of the flow cell comprises adjusting angle α, where a can be adjusted between 0° to 90°. In some examples, adjusting one or more angles of the flow cell comprises adjusting angle β, where β can be adjusted between 0° to 45°. In some examples, the fill rate is adjusted between 0 to 50 uL/s. In some examples, the evacuation rate is adjusted between 0 to 50 uL/s. In some examples, the volume of the liquid is adjusted between 0 mL to 1000 mL. In some examples, the capitally number is adjusted between 0 to 1 (e.g., 0, 0.1, 0.2, 0.3, 0.4, 0.5, 0.6, 0.7, 0.8, 0.9, 1, etc.). Once a parameter or condition is adjusted, one or more operations in the method provided herein may be repeated to determine the one or more conditions for recovering the maximum amount of liquid from the cavity of the flow cell.

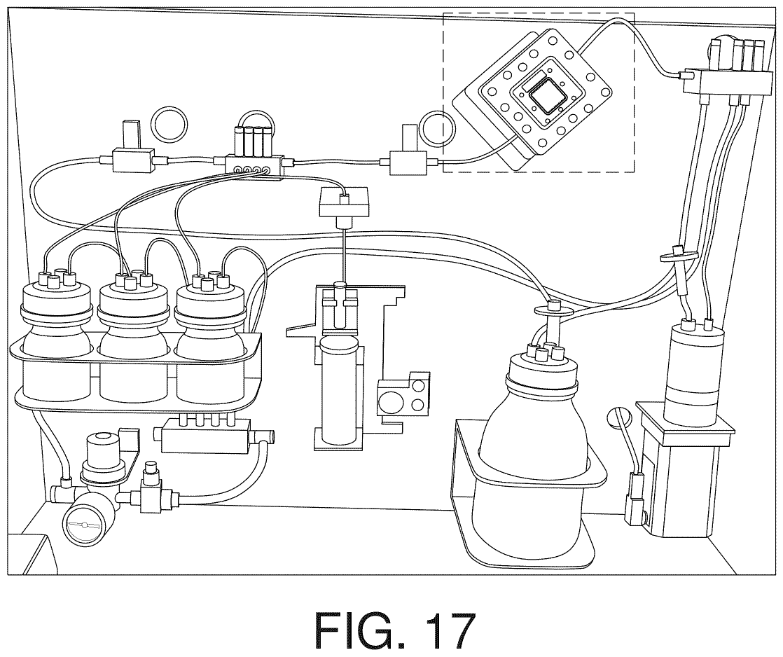

Further provided herein are methods for extracting biomolecules. In some instances, a flow cell, system, or platform is deployed once one or more conditions for maximizing the liquid from a cavity of a flow cell is determined. Such a method can comprise providing a system, the system comprising a flow cell with a cavity, a first reservoir (e.g., for holding liquid), and a second reservoir (e.g., pump, pressurized reservoir, or pressure feed), as illustrated herein (e.g., FIG. 11, FIG. 16, FIG. 17, etc.). In some examples, the flow cell is oriented such that a planar surface of the cavity is substantially parallel to a body force (e.g., gravity). In some examples, the flow cell is oriented such that α>0°, β>0°, or both. In some examples, the flow cell is oriented such that α≤90°, β≤45°, or both. In some examples, the flow cell is oriented such that 0°<α≤90°, 0°<β≤45°, or both.

Methods for extracting biomolecules can comprise providing a substrate comprising a plurality of biomolecules to the cavity. In some instances, the substrate comprises one or more chemicals or molecules. The molecules can comprise, but are not limited to, polymers (e.g., peptides, proteins, nucleic acids or mimetics thereof, e.g. peptide nucleic acids, LNA, UNA molecules), polysaccharides, phospholipids, or any combination thereof, where the polymers may be hetero- or homopolymeric. In some examples, the substrate comprises cells or tissue sections stably immobilized thereto. In some instances, the substrate is placed in the cavity of the flow cell manually. In some instances, the substrate is placed in the cavity of the flow cell using an automated system. The automated system may comprise, but is not limited to, a transfer mechanism (e.g., robotic system, such as a robotic arm), described herein.

Methods can further comprise exposing the substrate placed in the cavity of a flow cell to a fluid. In some instances, the method comprises introducing the liquid to the cavity of the flow cell. In some examples, the liquid is introduced through a first opening of a flow cell or a first plurality of openings of a flow cell. As an example, a fluid may be filled through a single hole located at the bottom of the flow cell, as illustrated in FIG. 15, thus introducing the liquid to the cavity of the flow cell and exposing the substrate placed in the cavity to the liquid. In some examples, the method comprises removing liquid from the cavity, such as removing the liquid in excess from the second opening after introducing the liquid to the cavity of the flow cell. Referring to FIG. 15, liquid may be removed from the cavity through a single hole located at the top of the flow cell. In some instances, liquid is introduced to, or liquid is removed from the cavity through a plurality of holes. In some instances, cavity is filled at a rate (fill rate) of about 0 to 50 μL/s, as described herein. In some instances, the volume of the liquid filling the cavity is about 0 to 1,000 mL, as described herein. In some examples, a cavity is filled by a first fluid, followed by a second fluid, thus exposing the substrate to the first fluid, followed by the second fluid. In some examples, a fluid is used to wash the substrate. In some examples, a fluid comprises a reagent that can react with a biomolecule on the substrate. In some examples, the biomolecule comprise nucleic acid molecules or polynucleotides. In some examples, the fluid comprises fluid for coupling, capping, oxidizing, sulfurizing, deblocking, or washing the substrate or biomolecules on the substrate. In some examples, the fluid is used to remove or cleave biomolecules on a surface of the substrate. The fluid may comprise, by way of non-limiting example, water, acetone, acetonitrile, methanol, ethanol, isopropyl alcohol, or tert-butylamine. In some examples, the fluid comprises tert-butylamine, water, and methanol, for example, at a predetermined ratio. The ratio of three fluids may be, for example, about 1:1:1, 1:1:2, 1:2:1, 2:1:1, 1:2:2, 2:1:2, or 2:2:1.

The fluid may comprise one or more properties suitable for use in the flow cell device or systems described herein. The one or more properties may comprise, by way of non-limiting example, surface tension, viscosity, density, vapor pressure, capillarity, cavitation, specific weight, specific volume, specific gravity, temperature, or pressure. In some examples, the fluid has a surface tension of about 0.001 to 0.1 N/m. In some examples, the fluid has a surface tension of about 0.001 to 0.002, 0.001 to 0.005, 0.001 to 0.01, 0.001 to 0.02, 0.001 to 0.03, 0.001 to 0.04, 0.001 to 0.05, 0.001 to 0.06, 0.001 to 0.07, 0.001 to 0.08, 0.001 to 0.09, 0.001 to 0.1, 0.002 to 0.005, 0.002 to 0.01, 0.002 to 0.02, 0.002 to 0.03, 0.002 to 0.04, 0.002 to 0.05, 0.002 to 0.06, 0.002 to 0.07, 0.002 to 0.08, 0.002 to 0.09, 0.002 to 0.1, 0.005 to 0.01, 0.005 to 0.02, 0.005 to 0.03, 0.005 to 0.04, 0.005 to 0.05, 0.005 to 0.06, 0.005 to 0.07, 0.005 to 0.08, 0.005 to 0.09, 0.005 to 0.1, 0.01 to 0.02, 0.01 to 0.03, 0.01 to 0.04, 0.01 to 0.05, 0.01 to 0.06, 0.01 to 0.07, 0.01 to 0.08, 0.01 to 0.09, 0.01 to 0.1, 0.02 to 0.03, 0.02 to 0.04, 0.02 to 0.05, 0.02 to 0.06, 0.02 to 0.07, 0.02 to 0.08, 0.02 to 0.09, 0.02 to 0.1, 0.03 to 0.04, 0.03 to 0.05, 0.03 to 0.06, 0.03 to 0.07, 0.03 to 0.08, 0.03 to 0.09, 0.03 to 0.1, 0.04 to 0.05, 0.04 to 0.06, 0.04 to 0.07, 0.04 to 0.08, 0.04 to 0.09, 0.04 to 0.1, 0.05 to 0.06, 0.05 to 0.07, 0.05 to 0.08, 0.05 to 0.09, 0.05 to 0.1, 0.06 to 0.07, 0.06 to 0.08, 0.06 to 0.09, 0.06 to 0.1, 0.07 to 0.08, 0.07 to 0.09, 0.07 to 0.1, 0.08 to 0.09, 0.08 to 0.1, or 0.09 to 0.1 N/m. In some examples, the fluid has a surface tension of about 0.001, 0.002, 0.005, 0.01, 0.02, 0.03, 0.04, 0.05, 0.06, 0.07, 0.08, 0.09, or 0.1 N/m. In some examples, the fluid has a surface tension of at least about 0.001, 0.002, 0.005, 0.01, 0.02, 0.03, 0.04, 0.05, 0.06, 0.07, 0.08, or 0.09 N/m. In some examples, the fluid has a surface tension of at most about 0.002, 0.005, 0.01, 0.02, 0.03, 0.04, 0.05, 0.06, 0.07, 0.08, 0.09, or 0.1 N/m. In some examples, the fluid has a viscosity of about 1×10⁻³ to 5×10⁻³ Pa s. In some examples, the fluid has a viscosity of 0.5×10⁻³ to 1×10⁻³, 0.5×10⁻³ to 1.5×10⁻³, 0.5×10⁻³ to 2×10⁻³, 0.5×10⁻³ to 2.5×10⁻³, 0.5×10⁻³ to 3×10⁻³, 0.5×10⁻³ to 3.5×10⁻³, 0.5×10⁻³ to 4×10⁻³, 0.5×10⁻³ to 4.5×10⁻³, 0.5×10⁻³ to 5×10⁻³, 1×10⁻³ to 1.5×10⁻³, 1×10⁻³ to 2×10⁻³, 1×10⁻³ to 2.5×10⁻³, 1×10⁻³ to 3, 1×10⁻³ to 3.5×10⁻³, 1×10⁻³ to 4×10⁻³, 1×10⁻³ to 4.5×10⁻³, 1×10⁻³ to 5×10⁻³, 1.5×10⁻³ to 2×10⁻³, 1.5×10⁻³ to 2.5×10⁻³, 1.5×10⁻³ to 3×10⁻³, 1.5×10⁻³ to 3.5×10⁻³, 1.5×10⁻³ to 4×10⁻³, 1.5×10⁻³ to 4.5×10⁻³, 1.5×10⁻³ to 5×10⁻³, 2×10⁻³ to 2.5×10⁻³, 2×10⁻³ to 3×10⁻³, 2×10⁻³ to 3.5×10⁻³, 2×10⁻³ to 4×10⁻³, 2×10⁻³ to 4.5×10⁻³, 2×10⁻³ to 5×10⁻³, 2.5×10⁻³ to 3×10⁻³, 2.5×10⁻³ to 3.5×10⁻³, 2.5×10⁻³ to 4×10⁻³, 2.5×10⁻³ to 4.5×10⁻³, 2.5×10⁻³ to 5×10⁻³, 3×10⁻³ to 3.5×10⁻³, 3×10⁻³ to 4×10⁻³, 3×10⁻³ to 4.5×10⁻³, 3×10⁻³ to 5×10⁻³, 3.5×10⁻³ to 4×10⁻³, 3.5×10⁻³ to 4.5×10⁻³, 3.5×10⁻³ to 5×10⁻³, 4×10⁻³ to 4.5×10⁻³, 4×10⁻³ to 5×10⁻³, or 4.5×10⁻³ to 5×10⁻³ Pa s. In some examples, the fluid has a viscosity of about 0.5×10⁻³, 1×10⁻³, 1.5×10⁻³, 2×10⁻³, 2.5×10⁻³, 3×10⁻³, 3.5×10⁻³, 4×10⁻³, 4.5×10⁻³, or 5×10⁻³ Pa s. In some examples, the fluid has a viscosity of about 0.5×10⁻³, 1×10⁻³, 1.5×10⁻³, 2×10⁻³, 2.5×10⁻³, 3×10⁻³, 3.5×10⁻³, 4×10⁻³, 4.5×10⁻³, or 5×10⁻³ Pa s. In some examples, the fluid has a viscosity of at least about 0.5×10⁻³, 1×10⁻³, 1.5×10⁻³, 2×10⁻³, 2.5×10⁻³, 3×10⁻³, 3.5×10⁻³, 4×10⁻³, or 4.5×10⁻³ Pa s. In some examples, the fluid has a viscosity of at most about 1×10−⁻³, 1.5×10⁻³, 2×10⁻³, 2.5×10⁻³, 3×10⁻³, 3.5×10⁻³, 4×10⁻³, 4.5×10⁻³, or 5×10⁻³ Pa s.

Methods can further comprises evacuating the liquid from the cavity of the flow cell. In some instances, the liquid in the cavity of a flow cell is evacuated through the first opening. In some instances, the liquid is evacuated from the cavity by introducing air to the cavity, for example, through the second opening. In some instances, cavity is evacuated at a rate (evacuation rate) of about 0 to 50 uL/s, as described herein. Referring to FIG. 15, during evacuation, air may be introduced through a single opening (e.g., referred to as the second opening) at the top of the flow cell. As air is introduced to the cavity, liquid can be evacuated out of the cavity of the flow cell. In some instances, air is introduced to, or liquid is evacuated from the cavity through a plurality of holes. In some instances, the fluid removed the biomolecules from the substrate, and is subsequently evacuated. Thus, in some instances, the liquid comprises a plurality of biomolecules, thereby extracting a plurality of biomolecules from a substrate.

The cavity or the one or more manifolds or tubes connected to the cavity may comprise or be in contact with a heating element. Thus, in some instances, exposing the substrate placed in the cavity of a flow cell to a fluid may comprise heating the cavity. In some instances, evacuating the liquid from the cavity of the flow cell may comprise heating the cavity or heating the one or more tubes or manifolds from which the liquid is evacuated. In some instances, the heating element comprises a heating jacket, a cartridge heater, or a film heater.

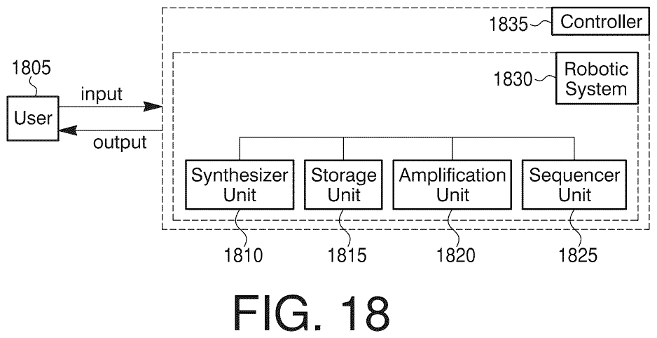

Methods can further comprise collecting the liquid comprising the plurality of biomolecules. In some instances, biomolecules are collected in a sample collector, for example, as shown in FIG. 11, FIG. 16, or FIG. 17. In some examples, the method comprises heating the extracted liquid in the sample collector, using the systems and methods described herein. In some examples, the sample collector comprises an intermediate compartment for transferring biomolecules for further processing or storage. In some examples, the sample collector comprises a storage compartment for storage of the biomolecules. The biomolecules may be stored in systems and platforms, for example, for DNA data storage, such as those provided herein (e.g., FIG. 18).

### Nucleic Acid Based Information Storage

Provided herein are devices, compositions, systems and methods for nucleic acid-based information (data) storage. In some instances, the devices, compositions, platforms, systems, or methods provided herein are used for DNA data storage of biomolecules that have been extracted from a substrate.

A biomolecule such as a DNA molecule provides a suitable host for storage of information, such as digital information, in-part due to its stability over time and capacity for enhanced information coding, as opposed to traditional binary information coding. In addition, a biomolecule such as a DNA molecule can provide high volumetric storage density. In a first step, a digital sequence encoding an item of information (e.g., digital information in a binary code for processing by a computer) is received. The digital sequence can comprise a first plurality of symbols, such an binary, octal, decimal, or hexadecimal data. An encryption scheme is applied to convert the digital sequence from the first string of symbols to a second string of symbols. The second string of symbols can comprise an alternative representation to the first string of symbols. In some examples, the second string of symbols comprises a nucleic acid sequence.

Once an item of information is converted to a nucleic acid sequence, the nucleic acids can be synthesized. A surface material for nucleic acid extension, a design for loci for nucleic acid extension (aka, arrangement spots), and reagents for nucleic acid synthesis are selected. The surface of a structure is prepared for nucleic acid synthesis. De novo polynucleotide synthesis is then performed. The synthesized polynucleotides can be extracted, in whole or in part, using the systems, devices, methods, or platforms provided herein. The synthesized polynucleotides are stored in a structure and, in some cases, are available for subsequent release, in whole or in part. The synthesized polynucleotides may be stored in a structure suitable for long term storage (e.g., weeks, months, years, etc.). A structure suitable for long term storage may be identifiable and/or capable of being catalogues, such as, for example, using a tag (e.g., barcode or RFID tag). Once released, the polynucleotides, in whole or in part, are sequenced, subject to decryption to convert nucleic sequence back to digital sequence. The digital sequence is then assembled to obtain an alignment encoding for the original item of information.

### Items of Information

Optionally, an early step of data storage process disclosed herein includes obtaining or receiving one or more items of information in the form of an initial code. In some instances, the items of information are encoded as a plurality of polynucleotides that have been extracted from a substrate, using systems, methods, platforms, or devices provided herein. Items of information (e.g., digital information) include, without limitation, text, audio and visual information. Exemplary sources for items of information include, without limitation, books, periodicals, electronic databases, medical records, letters, forms, voice recordings, animal recordings, biological profiles, broadcasts, films, short videos, emails, bookkeeping phone logs, internet activity logs, drawings, paintings, prints, photographs, pixelated graphics, and software code. Exemplary biological profile sources for items of information include, without limitation, gene libraries, genomes, gene expression data, and protein activity data. Exemplary formats for items of information include, without limitation, .txt, .PDF, .doc, .docx, .ppt, .pptx, .xls, .xlsx, .rtf, .jpg, .gif, .psd, .bmp, .tiff, .png, and .mpeg. The amount of individual file sizes encoding for an item of information, or a plurality of files encoding for items of information, in digital format include, without limitation, up to 1024 bytes (equal to 1 KB), 1024 KB (equal to 1 MB), 1024 MB (equal to 1 GB), 1024 GB (equal to 1 TB), 1024 TB (equal to 1PB), 1 exabyte, 1 zettabyte, 1 yottabyte, 1 xenottabyte or more. In some instances, an amount of digital information is at least 1 gigabyte (GB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 gigabytes. In some instances, the amount of digital information is at least 1 terabyte (TB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 terabytes. In some instances, the amount of digital information is at least 1 petabyte (PB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 petabytes. In some instances, the digital information does not contain genomic data acquired from an organism. Items of information in some instances are encoded. Non-limiting encoding method examples include 1 bit/base, 2 bit/base, 4 bit/base or other encoding method.

### DNA Data Storage

The devices, systems, or platforms provided herein for biomolecule extraction may be integrated in a data storage system. A system for data storage can comprise one or more modules. In some instances, the some or all of the one or more modules are in communication. In some examples, some or all of the one or more modules are in communication to allow transferring of polynucleotides between them. In some examples, some or all of the one or more modules are fluidically coupled. In some examples, some or all of the one or more modules are fluidically coupled with one or more tubes. A fluid may generally refer to one or more liquids used in various processes involved in handling polynucleotides, including, without limitation, synthesis, amplification, preparation for sequencing, and sequencing. In some examples, some or all of the modules are in communication to allow transferring of control commands between modules of the system. In some examples, some or all of the one or more modules are electronically coupled. A module in the system can comprise, without limitation, a synthesizer unit, an amplification chamber, a sequencer unit, a storage unit, a controller, a robotic system, or any combination thereof. In some examples, a module can further comprise a fluid source, a database or a file system, or both. In some examples, the database or file system keeps track of the storage capacity of the system. For example, the database or file system can keep track of available racks (or trays), slots (for capsules), or both. In some examples, the database or the file system is used to determine the disposition of the rack within the storage system. In some instances, movement of polynucleotides between one or more modules of a system is accomplished by one or more tubes or a robotic system. In some examples, the database or the file system is used to direct the robotic system to the correct position in the storage system. In some instances, the system is autonomous.

A data storage system may be a control system. A control system may generally refer to a framework to coordinate operations between protocols, connections, modules, and devices, so they may be executed properly and on schedule. In some embodiments, the operations may be executed with one or more logic elements comprising a programmable logic controller (PLC), programable logic array (PLA), programmable array logic (PAL), generic logic array (GLA), complex programmable logic decide (CPLD), field programable gate array (FPGA), or application-specific integrated circuit (ASIC). The control system may comprise one or more network communication protocols that may be standard network communication protocols, non-standard network communication protocols, or any combination thereof. In some embodiments, the standard network communication protocols are process field bus (Profibus), process field net (Profinet), highway addressable remote transducer (HART), distributed network protocol (DNP3), Modbus, open platform communication (OPC), building automation and control networks (BACnet), common industrial protocol (CIP), or ethernet for control automation technology (EtherCAT). A data storage system may include industrial, manufacturing, or processing facilities. Such facilities may support objectives on a mass-scale, such as synthesizing, storing, or retrieving information stored in biomolecules. A data storage system may comprise one or more of PLCs, remote terminal units, intelligent electronic devices, engineering workstations, human machine interfaces (HMIs), data historians, communication gateways, and front-end processors. In some embodiments, a data storage system may have different controllable states as steps of a process. In some embodiments, a data storage system may use an open communication protocol.

A non-limiting example of a system for data storage is illustrated in FIG. 18, with a feedback loop. An feedback loop may generally comprise a user 1805 that can interact with a system via a controller 1835 (e.g., PLC), for example, through a human-machine interface (HMI). The HMI may be a user interface (e.g., GUI) that connects a person or a user to one or more components (e.g., equipment, network, etc.) in the system. In some instances, a user may send an input, for example, as a query, to the controller 1835, regarding the state or function of components of the system. In some instances, the query is related to an item of information, whole or in part, that is stored in the system, such as the location, duration, or metadata of the information stored in the system.

The controller 1835 may send a output to a user 1805. The output can comprise a response to the query, which can be provided through a HMI and may be displayed on the user interface. In some instances, the controller 1835 sends status information regarding components of the ICS to the HMI and it is provided to the user 1805. In some instances, the controller 1835 implements control strategies using a system comprising a microprocessor for managing components in the system.

In some cases, the components may be a physical device, such as equipment in the system. The physical devices can be a device employed for storage or retrieval information in biomolecules. For example, physical devices can be part of a synthesizer unit 1810, storage unit 1815, amplification unit 1820, or sequencer unit 1825. In some examples, physical devices comprise one or more components illustrated in FIG. 16 for extraction of biomolecules from a flow cell placed in a substrate. In some examples, physical devices can comprise a robotic system 1830, which can be used for transferring or handling biomolecules in the system. In some cases, the equipment may be on-site or remote. In some examples, the controller 1835 control a physical device or a plurality thereof, such as control motors, valves, switches, etc., in the system.

A controller 1835 may controls a physical device based on one or more measurements obtained from sensors in the system. In some instances, sensors are integrated into one or more modules (e.g., a synthesizer unit 1810, storage unit 1815, amplification unit 1820, or sequencer unit 1825, robotic system 1835, flow cell, or biomolecule extraction systems, etc.). In some instances, sensors determine when and how the physical device should operate. For example, the sensor may be an integrated sensor as part of a control device comprising an actuator. In some cases, the measurements may be physical measurements obtained from sensors, such as pressure, volume, temperature, humidity, torque, vacuum, motion, flow rate (e.g., fill rate or evacuation rate), angles of orientation of devices (e.g., flow cells), etc. In some cases, the sensor is a standalone sensor. In further instances, the controller 1835 receives commands for the physical device to perform functions (e.g., pump actuation, stirrer operation, conveyor belt operation, etc.) from a user 1805, for example through a HMI.

The data from operations or sensors in the system, as described herein, may be fed into one or more software modules for analyzing data in the storage system. For example, the data may be sensor data from one or more compartments or modules in the system, and an algorithm may be used to monitor one or more parameters. In some examples, the algorithm monitors patterns in the sensor data and can be used to detect anomalies, for example, irregular sensor data from one or more compartments and optionally, alert a user through a HMI. As another example, the data may be an item of information or sequencing data and an algorithm may be used to convert the data to another format (e.g., convert an item of information to a nucleic acid sequence, or vice versa). In some examples, the algorithm comprises an error correction scheme that can be used to correct errors that have occurred during processes in the data storage system.

A system for data storage may comprise a synthesizer unit 1810. A synthesizer unit can be used to synthesize a plurality of polynucleotides encoding digital information. In some instances, the system comprises more than one synthesizer units 1810. Polynucleotides may be synthesized using a method provided herein or any other suitable synthesis method known in the art. The fluidic and/or electronic control of polynucleotide synthesis in the synthesizer unit 1810 may be performed by a controller 1835. In some instances, the electronics in the synthesizer unit 1810 are in communication with the controller 1835. In some instances, the synthesizer unit 1810 has an input for receiving DNA sequences. In some instances, the synthesizer unit 1810 has an input for receiving fluids for polynucleotide synthesis. In some instances, the synthesizer unit 1810 has an output for eluting synthesized polynucleotides. In some instances, the synthesized polynucleotides are transferred to another component of the system, such as, by way of non-limiting example, a storage unit, an amplification chamber, or a sequencing unit.

A flow cell, or a system or platform comprising a flow cell, may be connected to or coextensive with one or more components of the system, such as the synthesizer unit 1810, storage unit 1815, amplification unit 1820, or sequencer unit 1825. For example, the synthesized polynucleotides can be transferred to a flow cell (e.g., FIG. 15) or a system comprising a flow cell (e.g., FIG. 16) provided herein for extraction of biomolecules from a synthesis surface, whole or in-part. In some examples, once the polynucleotides are cleaved from the surface, they are collected and transferred to another component of the system, such as, by way of non-limiting example, storage unit 1815, amplification unit 1820, or sequencer unit 1825. In some instances, the flow cell is oriented to maximize the recovery of liquid from the flow cell, for example, by adjusting angles α or β as defined herein. Further, an apparatus comprising at least one logic element for performing one or more operations of a biomolecule extraction platform, as provided herein may be in communication with or may be part of a controller 1835 of a larger data storage system.

A synthesizer unit may comprise a solid support. The solid support may comprise a surface for polynucleotide synthesis. In some instances, the solid support, the surface, or both comprise a material described herein. In some instances, the material comprises a metal or organic polymer. In some instances, the material comprises steel (e.g., stainless steel) or other metal alloy. In some instances, the material comprises polyethylene, polypropylene, or other polymer. In some instances, the structure comprises a flexible material, such as those provided herein. Exemplary flexible materials include, without limitation, modified nylon, unmodified nylon, nitrocellulose, and polypropylene. In some instances, the materials comprise a rigid material, such as those provided herein. Exemplary rigid materials include, without limitation, glass, fuse silica, silicon, silicon dioxide, silicon nitride, plastics (for example, polytetrafluoroethylene, polypropylene, polystyrene, polycarbonate, and blends thereof, and metals (for example, steel, gold, platinum). In some instances, materials disclosed herein may be fabricated from a material comprising silicon, polystyrene, agarose, dextran, cellulosic polymers, polyacrylamides, polydimethylsiloxane (PDMS), glass, or any combination thereof. In some examples, materials disclosed herein are manufactured with a combination of materials listed herein or any other suitable material known in the art.

In some instances, the solid support has varying dimensions. In some instances, a size of the solid support is between about 40 and 120 mm by between about 25 and 100 mm. In some instances, a size of the solid support is about 80 mm by about 50 mm. In some instances, a width of a solid support is at least or about 10 mm, 20 mm, 40 mm, 60 mm, 80 mm, 100 mm, 150 mm, 200 mm, 300 mm, 400 mm, 500 mm, or more than 500 mm. In some instances, a height of a solid support is at least or about 10 mm, 20 mm, 40 mm, 60 mm, 80 mm, 100 mm, 150 mm, 200 mm, 300 mm, 400 mm, 500 mm, or more than 500 mm. In some instances, the solid support has a planar surface area of at least or about 100 mm²; 200 mm²; 500 mm²; 1,000 mm²; 2,000 mm²; 4,500 mm²; 5,000 mm²; 10,000 mm²; 12,000 mm²; 15,000 mm²; 20,000 mm²; 30,000 mm²; 40,000 mm²; 50,000 mm² or more. In some instances, the thickness of the solid support is between about 50 mm and about 2000 mm, between about 50 mm and about 1000 mm, between about 100 mm and about 1000 mm, between about 200 mm and about 1000 mm, or between about 250 mm and about 1000 mm. Non-limiting examples thickness of the solid support include 275 mm, 375 mm, 525 mm, 625 mm, 675 mm, 725 mm, 775 mm and 925 mm. In some instances, the thickness of the solid support is at least or about 0.5 mm, 1.0 mm, 1.5 mm, 2.0 mm, 2.5 mm, 3.0 mm, 3.5 mm, 4.0 mm, or more than 4.0 mm.

In some instances, two or more solid supports are assembled. In some instances, solid supports are interfaced together on a larger unit. Interfacing may comprise exchange of fluids, electrical signals, or other medium of exchange between solid supports. This unit is capable of interface with any number of servers, computers, or networked devices. For example, a plurality of solid support is integrated onto a rack unit, which is conveniently inserted or removed from a server rack. The rack unit may comprise any number of solid supports. In some instances the rack unit comprises at least 1, 2, 5, 10, 20, 50, 100, 200, 500, 1000, 2000, 5000, 10,000, 20,000, 50,000, 100,000 or more than 100,000 solid supports. In some instances, two or more solid supports are not interfaced with each other. Polynucleotides (and the information stored in them) present on solid supports can be accessed from the rack unit. Access includes removal of polynucleotides from solid supports, direct analysis of polynucleotides on the solid support, or any other method which allows the information stored in the polynucleotides to be manipulated or identified. Information in some instances is accessed from a plurality of racks, a single rack, a single solid support in a rack, a portion of the solid support, or a single locus on a solid support. In various instances, access comprises interfacing polynucleotides with additional devices such as mass spectrometers, HPLC, sequencing instruments, PCR thermocyclers, or other device for manipulating polynucleotides. Access to nucleic acid information in some instances is achieved by cleavage of polynucleotides from all or a portion of a solid support. Cleavage in some instances comprises exposure to chemical reagents (ammonia or other reagent), electrical potential, radiation, heat, light, acoustics, or other form of energy capable of manipulating chemical bonds. In some instances, cleavage occurs by placing the solid support in a flow cell, as exemplary shown in FIG. 15. In some examples, one or more orientations of the flow cell has been optimized to maximize a liquid comprising the polynucleotides that can be recovered from the flow cell (e.g., angles α or β). In some instances, cleavage occurs by charging one or more electrodes in the vicinity of the polynucleotides. In some instances, electromagnetic radiation in the form of UV light is used for cleavage of polynucleotides. In some instances, a lamp is used for cleavage of polynucleotides, and a mask mediates exposure locations of the UV light to the surface. In some instances, a laser is used for cleavage of polynucleotides, and a shutter opened/closed state controls exposure of the UV light to the surface. In some instances, access to nucleic acid information (including removal/addition of racks, solid supports, reagents, polynucleotides, or other component) is completely automated.

Solid supports as described herein comprise an active area. In some instances, the active area comprises regions, cells, features, or loci for nucleic acid synthesis. In some instances, the active area comprises regions or loci for nucleic acid storage. In some examples, the regions or loci comprise the one or more modules. In some examples, the regions or loci comprise the second one or more modules. In some instances, the regions are addressable. In some examples, the regions are addressable through an electrode.

The active area comprises varying dimensions. For example, the dimension of the active area is between about 1 mm to about 50 mm by about 1 mm to about 50 mm. In some instances, the active area comprises a width of at least or about 0.5, 1, 1.5, 2, 2.5, 3, 5, 5, 10, 12, 14, 16, 18, 20, 25, 30, 35, 40, 45, 50, 60, 70, 80, or more than 80 mm. In some instances, the active area comprises a height of at least or about 0.5, 1, 1.5, 2, 2.5, 3, 5, 5, 10, 12, 14, 16, 18, 20, 25, 30, 35, 40, 45, 50, 60, 70, 80, or more than 80 mm.

In some instances, the solid support has a number of sites (e.g., spots) or positions for polynucleotides synthesis. In some instances, the solid support may be used to storage of polynucleotides. In some instances, the solid support comprises up to or about 10,000 by 10,000 positions in an area. In some instances, the solid support comprises between about 1000 and 20,000 by between about 1000 and 20,000 positions in an area. In some instances, the solid support comprises at least or about 10, 30, 50, 75, 100, 200, 300, 400, 500, 1000, 2000, 3000, 4000, 5000, 6000, 7000, 8000, 9000, 10,000, 12,000, 14,000, 16,000, 18,000, 20,000 positions by least or about 10, 30, 50, 75, 100, 200, 300, 400, 500, 1000, 2000, 3000, 4000, 5000, 6000, 7000, 8000, 9000, 10,000, 12,000, 14,000, 16,000, 18,000, 20,000 positions in an area. In some instances the area is up to 0.25, 0.5, 0.75, 1.0, 1.25, 1.5, or 2.0 inches squared. In some instances, the solid support comprises loci having a pitch of at least or about 0.1, 0.2, 0.25, 0.3, 0.4, 0.5, 1.0, 1.5, 2.0, 2.5, 3.0, 3.5, 4.0, 4.5, 5, 6, 7, 8, 9, 10, or more than 10 um. In some instances, the solid support comprises loci having a pitch of about 5 um. In some instances, the solid support comprises loci having a pitch of about 2 um. In some instances, the solid support comprises loci having a pitch of about 1 um. In some instances, the solid support comprises loci having a pitch of about 0.2 um. In some instances, the solid support comprises loci having a pitch of about 0.2 um to about 10 um, about 0.2 to about 8 um, about 0.5 to about 10 um, about 1 um to about 10 um, about 2 um to about 8 um, about 3 um to about 5 um, about 1 um to about 3 um or about 0.5 um to about 3 um. In some instances, the solid support comprises loci having a pitch of about 0.1 um to about 3 um.

In some instances, the solid support can be used for polynucleotide storage. In some instances, the solid support comprise a high capacity for storage of data. For example, the capacity of the solid support is at least or about 1, 2, 3, 4, 5, 6, 7, 8, 9, 10, 20, 50, 100, 200, 300, 400, 500, 600, 700, 800, 900, 1000, or more than 1000 petabytes. In some instances, the capacity of the solid support is between about 1 to about 10 petabytes or between about 1 to about 100 petabytes. In some instances, the capacity of the solid support is about 100 petabytes. In some examples, the polynucleotides are stored for a time on the solid support, and subsequently extracted from the solid support using the systems and methods provided herein. For example, polynucleotides on a solid support may be stored for days, months, or years, and subsequently extracted from the solid support using a flow cell, as exemplary shown in FIG. 15, for recovery of information whole or in-part, or quality control of the polynucleotides. In some examples, one or more orientations of the flow cell has been optimized to maximize a liquid comprising the polynucleotides that can be recovered from the flow cell (e.g., angles α or β).

In some instances, the data is stored as arrays of packets as droplets. In some examples, the arrays of packets are addressable packets. In some examples, the packets are addressable using an electrode. In some instances, the data is stored as arrays of packets as droplets on a spot. In some instances, the data is stored as arrays of packets as dry wells. In some instances, the arrays comprise at least or about 1, 2, 3, 4, 5, 6, 7, 8, 9, 10, 20, 50, 100, 200, or more than 200 gigabytes of data. In some instances, the arrays comprise at least or about 1, 2, 3, 4, 5, 6, 7, 8, 9, 10, 20, 50, 100, 200, or more than 200 terabytes of data. In some instances, an item of information is stored in a background of data. For example, an item of information encodes for about 10 to about 100 megabytes of data and is stored in 1 petabyte of background data. In some instances, an item of information encodes for at least or about 1, 10, 20, 30, 40, 50, 60, 70, 80, 90, 100, 150, 200, 300, 400, 500, or more than 500 megabytes of data and is stored in 1, 10, 20, 30, 40, 50, 60, 70, 80, 90, 100, 150, 200, 300, 400, 500, or more than 500 petabytes of background data.

Provided herein is a data storage system comprising a solid support, where following synthesis, the polynucleotides are collected in packets as one or more droplets. In some instances, the polynucleotides are collected in packets as one or more droplets and stored. In some instances, a number of droplets is at least or about 1, 10, 20, 50, 100, 200, 300, 500, 1000, 2500, 5000, 75000, 10,000, 25,000, 50,000, 75,000, 100,000, 1 million, 5 million, 10 million, 25 million, 50 million, 75 million, 100 million, 250 million, 500 million, 750 million, or more than 750 million droplets. In some instances, a droplet volume comprises 5, 10, 15, 20, 25, 30, 35, 40, 45, 50, 55, 60, 65, 70, 75, 80, 85, 90, 95, 100, or more than 100 um (micrometer) in diameter. In some instances, a droplet volume comprises 1-100 um, 10-90 um, 20-80 um, 30-70 um, or 40-50 um in diameter.

In some instances, the polynucleotides that are collected in the packets comprise a similar sequence. In some instances, the polynucleotides further comprise a non-identical sequence to be used as a tag or barcode. For example, the non-identical sequence is used to index the polynucleotides stored on the solid support and to later search for specific polynucleotides based on the non-identical sequence. Exemplary tag or barcode lengths include barcode sequences comprising, without limitation, about 1, 2, 3, 4, 5, 6, 7, 8, 9, 10, 15, 20, 25 or more bases in length. In some instances, the tag or barcode comprise at least or about 10, 50, 75, 100, 200, 300, 400, or more than 400 base pairs in length.

Provided herein is a data storage system comprising a solid support, where the polynucleotides are collected in packets comprising redundancy. For example, the packets comprise about 100 to about 1000 copies of each polynucleotide. In some instances, the packets comprise at least or about 50, 75, 100, 200, 300, 400, 500, 600, 700, 800, 900, 1000, 1200, 1400, 1600, 1800, 2000, or more than 2000 copies of each polynucleotide. In some instances, the packets comprise about 1000× to about 5000× synthesis redundancy. Synthesis redundancy in some instances is at least or about 500×, 1000×, 1500×, 2000×, 2500×, 3000×, 3500×, 4000×, 5000×, 6000×, 7000×, 8000×, or more than 8000×. The polynucleotides that are synthesized using solid support based methods as described herein comprise various lengths. In some instances, the polynucleotides are synthesized and further stored on the solid support. In some instances, the polynucleotide length is in between about 100 to about 1000 bases. In some instances, the polynucleotides comprise at least or about 10, 20, 30, 40, 50, 60, 70, 80, 90, 100, 125, 150, 175, 200, 225, 250, 275, 300, 325, 350, 375, 400, 425, 450, 475, 500, 600, 700, 800, 900, 1000, 1100, 1200, 1300, 1400, 1500, 1600, 1700, 1800, 1900, 2000, or more than 2000 bases in length.

In some instances, the polynucleotides are deprotected, cleaved, and/or eluted from the synthesizer unit 1810 and transferred to another module in the system. In some instances, the polynucleotides are transferred from the synthesizer unit 1810 on the solid support. In some instances, a robotic system 1830 or fluidic tube is used to transports the polynucleotides to another module in the system. A robotic system 1830 may be controlled by a controller 1835. A robotic system generally comprises a system for manipulation of a plurality of polynucleotides. In some instances, the robotic system is used to manipulate a structure comprising a plurality of polynucleotides, such as those described herein. Manipulation can comprise, by way of non-limiting example, moving, storing, retrieving, handling, transferring, or any combination thereof. The robotic system may be similar to those used in semiconductor processing to move trays of wafers and chips between processing devices. A robotic system 1830 may be used to select and transfer polynucleotides between modules of the system. For example, a robotic system 1835 may include a tag reader to verify a structure in a storage unit 1815. In some instances, the robotic system 1835 comprises a reader of a tag (e.g., RFID reader, barcode reader, etc.) and the structure in the storage unit 1815 comprises a tag (e.g., RFID tag, barcode, etc.). Once verified, the robotic system 1830 may transfer the structure to a component of the system. Additionally, the robotic system 1830 may transfer the structure to a precise location in a component of the system. In some instances, the robotic system can allow for polynucleotides to be added and/or removed from modules in the data storage system. In some instances, the robotic system allows for a structure comprising a plurality of polynucleotides to be placed and/or retrieved from a location in an identifiable layout in the storage unit 1815. The robotic system 1830 may be controlled using a controller 1835 as further described herein.

In some instances, one or more droplets comprising polynucleotides are transferred from a synthesizer unit 1810 to a storage unit 1815. In some instances, some or all of the polynucleotides synthesized on a solid support are transferred to a structure for storage. In some examples, the synthesizer unit 1810 is connected to or is coextensive with a system or platform for biomolecule extraction, such as those provided herein (e.g., FIG. 16). Thus in some instances, the polynucleotides are extracted using a system or platform comprising a flow cell, oriented to maximize the recovery of fluid comprising the polynucleotides. The extracted polynucleotides can be collected in a structure for subsequent storage.

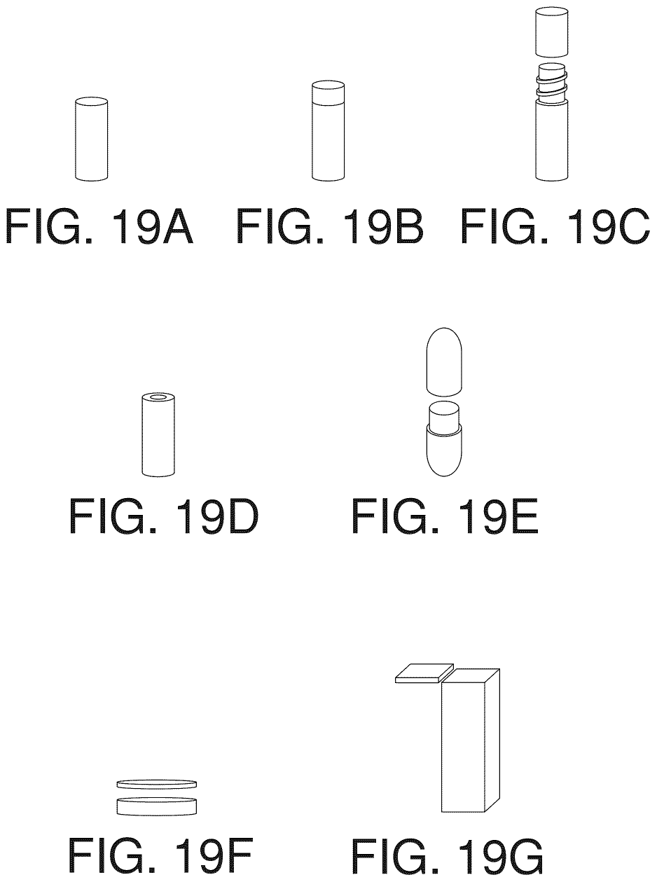

The structure may have a variety of shapes and sizes, such as those described herein (e.g., FIGS. 19A-19G). A structure for storing the plurality of polynucleotides may be any shape or size. In some instances, the structure is substantially spherical, tubular (FIG. 19A), egg-shaped, conical, cubic, cuboid, cylindrical, wedge, hexagonal prism, square base pyramid, triangular based pyramid, triangular prism, toroid, hemisphere, helical, heart-shaped, or other shape. In some instances, shapes are configured to allow the structure to be opened or closed to the outside environment. In some instances, such closures are faciliated by welding, seals, septums, or other mechanism for restricting the movement of gases or other matter in or out of the structure. In some instances, the structure comprises holes, slots, septum, valves, or ports for addition or removal of nucleic acids, fluids, gases, or other material into or out of the structure. In some instances a structure for storing the plurality of polynucleotides comprises a cap and a body that are flush-welded together (FIG. 19B). In some instances, a structure for storing the plurality of polynucleotides comprises a removable screw-cap (FIG. 19C). In some instances, a structure comprises a septum (FIG. 19D). In some instances a structure comprises two rounded, pill-shaped halves that form a seal when one half is inserted into the other (FIG. 19E). In some instances, a structure comprises a substantially flat, disc container with sealable lid (FIG. 19F). In some instances, a structure comprises a box with an optionally attached lid (FIG. 19G). In some examples, the shape is a cylinder or a disk. In some examples, a cylinder or a disk shape is preferrable for automated handling and/or filing of the structures.

The structure may further comprise a tag, such as those described herein. The tag can comprise a barcode or an RFID tag. In some instances, a plurality of polynucleotides are transferred to a structure in the synthesizer unit 1810. In some instances, the plurality of polynucleotides are transferred to a structure from a flow cell (e.g., FIG. 15), which can be part of a biomolecule extraction system (e.g., FIG. 16). In some instances, a plurality of polynucleotides are transferred to a structure in the storage unit 1815. The fluidic and/or electronic control of polynucleotide synthesis in the storage unit 1815 may be performed by a controller 1835. In some instances, the electronics in the storage unit 1815 are in communication with the controller 1835. In some instances, the polynucleotides are stored at room temperature in the storage unit 1815. In some instances, the system comprises a database or a file system for keeping track of the storage capacity in the storage unit 1815. In some examples, the database comprises a control application database. In some instances, the database or the file system is part of the controller 1835.

A structure comprising a plurality of polynucleotides can be stored in an identifiable layout in storage unit 1815. The identifiable layout may comprise a rack or a plurality of racks, or a variation thereof. The rack may be used to hold one or more structures comprising the plurality of polynucleotides. In some instances, each structure is stored at a fixed location in the identifiable layout. In some instances, the tag comprises information about a location of the structure in the identifiable layout. As an example, a tag (e.g., RFID tag) can encode metadata comprising a location of the structure in the identifiable layout. In some instances, the rack may be located in a data center. In some instances, the rack uses mechanical structures commonly used for mounting conventional computing and data storage resources in rack units. For example, a rack may comprise openings adapted to support disk drives, processing blades, and/or other computer equipment. In some instances, a rack comprises a tag. In some examples, the tag comprises information of the structures stored in/on the rack. In some examples, the tag comprises a list of the structures stored in/on the rack.

In some instances, the storage unit 1815 may be accessed using a robotic system 1830. In some instances, the identifiable layout in the storage unit 1815 comprises robotically addressable slots. Each slot may hold a structure comprising a plurality of polynucleotides. In some instances, each slot comprises a width, depth, length, or any combination thereof for accommodating a structure comprising the plurality of polynucleotides. In some instances, a rack comprises a plurality of slots, where each slot holds a structure comprising the plurality of polynucleotides.

The system for storing polynucleotides may further comprise an amplification chamber 1820. The amplification unit may be used to amplify the plurality of polynucleotides. In some instances, the system comprises more than one amplification chamber 1820. In some instances, a structure is selected from a storage unit 1815 and the polynucleotides from the structure are transferred to the amplification chamber 1820. In some instances, the polynucleotides from a synthesizer unit 1810 are transferred to the amplification chamber 1820 for size selection, PCR, or other type of amplification or preparation for storage. Size selection generally involves selecting DNA in the target size and rejecting strands that are much shorter or much longer. In some instances, filters are tuned to capture DNA of a particular size range. In some instances, other methods include PCR, electrophoresis, capture by solid phase bound primers, which are complementary to the end sequences of synthesized oligonucleotides, or the use of an isothermal polymerase. The fluidic and/or electronic control of polynucleotide synthesis in the amplification chamber 1820 may be performed by a controller 1835. In some instances, the electronics in the amplification chamber 1820 are in communication with the controller 1835.

The system for storing polynucleotides may further comprise a sequencing unit 1825. The sequencing unit 1825 may be used to sequence a plurality of polynucleotides. In some instances, the plurality of polynucleotides are transferred from the amplification chamber 1820 to the sequencing unit 1825. In some instances, the system may comprise additional modules for performing additional sequencing preparation steps. In some examples, the plurality of polynucleotides are transferred from the amplification chamber 1820 to the sequencing unit 1825 using one or more tubes or the robotic system 1830. In some instances, the amplification chamber 1820 and the sequencing unit 1825 are fluidically coupled. The fluidic and/or electronic control of polynucleotide synthesis in the sequencing unit 1825 may be performed by a controller 1835. In some instances, the electronics in the sequencing unit 1825 are in communication with the controller 1835.

In some instances, the system comprises large-scale sequencing of polynucleotides. In some instances, large-scale sequencing comprises dense and highly parallel sequencers. In some instances, the system comprises more than one sequencing unit 1825. In some instances, the sequencing unit 1825 use centrifugal forces and/or vacuum/pressure to add or evacuate reagents from the sequencing unit 1825. In some instances, the sequencing unit 1825 is light-based (e.g., with light sources and sensors on chip), nanopore-based (e.g., Oxford Nanopore Technologies (ONT)), or involve other operations (e.g., a light-based method such as PacBio or other sequencing technologies). In some instances, the sequencing unit 1825 employs sequencing methods provided herein. In some instances, the sequencing unit 1825 uses of nanopores or other electrical sequencing technology that benefits from the bulk fluidics provided by semiconductor fabrication equipment. In some instances, the one or more modules described herein comprises a camera. A camera may be used to capture one or more optical features of polynucleotides in a module. As an example, a camera may be used in a synthesizer unit, a sequencing unit, or both, to capture an optical feature of polynucleotides attached to a surface on a solid support as described herein.

The system for storing polynucleotides can comprise a robotic system 1830 as described herein. The robotic system may generally be used to manipulate the polynucleotides in a system. Manipulation can comprise, without limitation, moving, storing, retrieving, handling, transferring, or any combination thereof. In some instances, the robotic system transfers the plurality of polynucleotides between modules in the system. In some examples, the robotic system manipulates (e.g., transfers) the plurality of polynucleotides in structure for storage as described herein. In some instances, the robotic system manipulates (e.g., transfers) the plurality of polynucleotides in a rack. In some examples, the rack comprises a plurality of structures each comprising an RFID tag. In some examples, the rack comprises a plurality of solid supports for synthesis and/or sequencing. In some instances, the robotic system comprises a robotic hand or a robotic picker. In some instances, the robotic system 1830 is fully integrated with the storage system control software and/or firmware in the controller 1835. In some instances, the robotic system 1830 is fully integrated with an external host application. In some instances, the robotic system 1830 is fully automated.

The system for storing polynucleotides can comprise a controller 1835. The controller may generally be used for controlling modules, components, fluidics, robots, or any combination thereof. The modules, components, fluidics, electronics, robots, or any combination thereof may be used for synthesizing, storing, retrieving, sequencing, and/or amplifying polynucleotides. In some instances, the controller 1835 is capable of cataloguing all storage structures loaded, unloaded, and/or stored within a rack. The polynucleotides can encode digital information as described herein. The modules, components, fluidics, electronics, robots, or any combination thereof may be used for performing methods, models, or algorithms, such as encoding or decoding the polynucleotides.

In some instances, the controller 1835 controls the physical location of the plurality of polynucleotides. In some instances, the controller 1835 provides commands to one or more modules of the system. In some examples, the controller 1835 controls robotics (e.g., robotic system 1830), actuators, and fluidic valves, or any other equipment of the system. In some instances, the controller 1835 allows for synchronizing and controlling the modules for processing and/or transferring polynucleotides. In some examples, the polynucleotides are processed and/or transferred via fluidics. In some examples, the controller 1835 controls one or more valves or parameters (e.g., pressure, vacuum, temperature, volume, etc.) in the system for biomolecule extraction, for example, as provided in FIG. 16. In some examples, the controller 1835 can be used to orient or adjust the orientation of a flow cell in a system for biomolecule extraction. This can allow for flexibility of the system and maximize recovery of material (e.g., polynucleotides). In some examples, the polynucleotides are processed and/or transferred via electronics. In some instances, the controller 1835 controls physical parameters in one or more modules, such as, without limitation, pressure, vacuum, temperature, volume (e.g., of fluids), or any combination thereof.

In some instances, the controller 1835 invokes an encoder module or a decoder module. In some instances, the encoder module encodes the digital information as a plurality of polynucleotides. In some instances, the encoder module applies one or more codecs, such as those described herein, to the digital information. In some instances, the decoder module decodes the sequences of the plurality of polynucleotides to retrieve the digital information. In some instances, the decoder module applies one or more codecs, such as those described herein, to the sequences of the plurality of polynucleotides. In some instances, the decode module performs reassembly, error correction, and outputs digital information (e.g., binary data). In some instances, the output comprising digital information is transferred to an operating system and/or a file system. The output may be provided on a display, such as a graphical user interface (GUI), or any other suitable display such as those described herein, for providing the digital information. In some instances, the controller 1835 is implemented on one or more software modules, such as those described herein. In some instances, the controller 1835 responds to commands from an operating system, such as those described herein.

An encoder module generally encodes the digital information as a plurality of polynucleotides. An encoder can apply an encoding scheme to digital information. In some instances, the encoding scheme comprises codecs for encoding binary data as polynucleotide sequences (e.g., inner codec). In some instances, the encoding scheme comprises an error correction code (ECC) (e.g., outer codec). In some instances, employing a flow cell optimized for maximum recovery of material from a substrate decreases the need for error correction, since less material is lost between transfer of material. In some cases, the encoding scheme is designed and implemented to allow streaming read and write API access. In some cases, the encoding scheme is designed and implemented to match the streaming of the systems and methods for digital storage described herein.

The encoding scheme can generally comprise one or more operations. The one or more operations can comprise one or more operation to manipulate or transform data (e.g., digital information). The one or more operations can comprise by way of non-limiting example, splitting, shuffling, concatenating, transposing, translating, duplicating, labeling (e.g., using an index) data or a part of the data, or any combination thereof.

In some instances, the outer codec comprises an error correction code (ECC) or scheme, such as, without limitation, a Reed-Solomon (RS) code, a low-density parity-check (LDPC) code, a polar code, a turbo code, or any variation thereof. This outer codec is used for spreading the digital or binary data to be stored over many oligonucleotides. In some instances, spreading the data builds redundancy to correct for erasures (e.g., lost oligos). In some further embodiments, spreading the data also builds redundancy to correct errors from an inner codec. In some instances, the methods for encoding digital or binary data in a plurality of nucleotide sequences comprise an inner codec. In some instances, the inner codec is applied to the binary data. In some instances, the inner codec is applied to the binary data from the ECC. In some instances, the inner codec is applied to the lanes of the binary data. In some instances, the inner codec is applied to binary data that has been shuffled.

In some instances, the encoding scheme comprises an inner codec. In some instances, an inner codec is applied to encode the binary data as a polynucleotide sequence. The inner codec is used to transform digital or binary data into nucleotide bases. In some instances, the inner codec is capable of correcting deletion, substitution, or insertion errors, or any combination thereof. In some further embodiments, the inner codec is used to validate oligos and discard any suspicious oligos to avoid contaminating the outer decoding. The inner codec further encodes the indices, which can allow for efficient clustering during decoding. In some instances, the encoding scheme adds redundancy across the plurality of oligonucleotide sequences. In some instances, the inner codec comprises generating base candidates. In some instances, base candidates are generated using a codebook, a lookup table, a hash, or any suitable method known in the art. In some instances, the inner codec further comprises a base repetition check. In some instances, the inner codec further comprises performing GC filtering.

A decoder module generally decodes the sequences of the plurality of polynucleotides to retrieve the digital information. A decoder can apply a decoding scheme to the sequences of the plurality of polynucleotides. In some instances, a decoding scheme comprises an inner codec, an outer codec (e.g., ECC), or a combination thereof. In some instances, the decoding scheme decodes a plurality of polynucleotide sequences to generate an output comprising digital information. In some instances, the decoding scheme comprises undoing operations in the encoding scheme. In some examples, the operations comprise, without limitation, splitting, shuffling, concatenating, transposing, translating, duplicating, labeling (e.g., using an index) data or a part of the data, or any combination thereof.

A digital output from a sequencer unit comprising sequences of the plurality of polynucleotides may be provided to the decoding module. In some instances, the decoder module orders, clusters, and/or aligns sequences of the plurality of polynucleotides. In some examples, the decoder module comprises an alignment algorithm, such as with limitation, a pairwise alignment algorithm, a multi-sequence alignment algorithm, or any other suitable algorithm.

In some instances, decoding scheme comprise an inner codec. In some instances, the inner codec is applied to the plurality of polynucleotide sequences. The inner codec is used to transform the polynucleotide sequences into digital or binary data. In some instances, the inner codec is capable of correcting deletion, substitution, or insertion errors, or any combination thereof. In some further embodiments, the inner codec is used to validate oligos and discard any suspicious oligos to avoid contaminating the outer decoding. In some instances, the inner codec allows for efficient decoding using the indices.

An inner codec comprising a decoding scheme can be applied to the plurality of polynucleotide sequences. In some instances, the inner codec transforms each of the plurality of polynucleotide sequences into binary data. In some instances, the inner codec is applied to a plurality of polynucleotides that have been sequenced. In some examples, the plurality of clustered have been ordered, clustered, aligned, or any combination thereof.

In some instances, the inner codec comprises a greedy algorithm. A greedy algorithm generally takes into account transitions from only the most probably state as it decodes each bit position in a sequence. In some instances, the inner codec comprises a maximum likelihood (ML) algorithm. A ML algorithm generally takes into account transitions from all states as it decodes each bit position in a sequence In some instances, the inner codec comprises a mixed greedy ML algorithm. A mixed greedy ML algorithm can generally take into account transitions from a plurality of states as it decodes each bit position in a sequence. In some instances, the inner codec comprises a beam search decoder or a random sampling decoder (e.g., pure sampling decoder, a top-K sampling decoder, etc.). In some cases, a beam search decoder or a random sampling decoder provides a diversity of candidate states compared to a greedy decoder. In some instances, the inner codec further comprises a checksum. In some instances, the inner codec comprises a hash (e.g., SHA-256). In some instances, the hash verifies that the data was correctly decoded. In some instances, by using a hash at the end (after the ECC), the encoding and decoding are performed as a stream. In some instances, this can limit memory use to only temporary buffers.

In some instances, the decoding module comprises an outer codec (e.g., ECC). In some instances, the plurality of nucleotide sequences are decoded into digital or binary data. In some instances, an outer codec (e.g., ECC) is applied to the digital or binary data. In some instances, the outer codec comprises an ECC used to encode the data (e.g., binary data). In some instances, the ECC comprises a Reed-Solomon (RS) code, a LDPC code, a polar code, a turbo code, or any combination thereof. In some instances, the decoding scheme comprises soft decoding. Soft decoding generally refers to decoding by considering a range of possible values (e.g., using probability estimates).

### De Novo Polynucleotide Synthesis

Provided herein are systems and methods for synthesis of libraries of polynucleotides on a substrate. In some instances, the library comprising a plurality of polynucleotides from the encoding scheme are synthesized. In some examples, the library comprising the plurality of polynucleotides from the encoding scheme encode a pool of the plurality of pools. In some examples, the library comprising the plurality of polynucleotides from the encoding scheme encode an index pool. In some instances, methods comprise use of electrochemical deprotection. In some instances, the substrate is a flexible substrate. In some instances, at least 10¹⁰, 10¹¹, 10¹², 10¹³, 10¹⁴, or 10¹⁵ bases are synthesized in one day. In some instances, at least 10×10⁸, 10×10⁹, 10×10¹⁰, 10×10¹¹, or 10×10¹² polynucleotides are synthesized in one day. In some cases, each polynucleotide synthesized comprises at least 20, 50, 100, 200, 300, 400 or 500 nucleobases. In some cases, these bases are synthesized with a total average error rate of less than about 1 in 100; 200; 300; 400; 500; 1000; 2000; 5000; 10000; 15000; 20000 bases. In some instances, these error rates are for at least 50%, 60%, 70%, 80%, 90%, 95%, 98%, 99%, 99.5%, or more of the polynucleotides synthesized. In some instances, these at least 90%, 95%, 98%, 99%, 99.5%, or more of the polynucleotides synthesized do not differ from a predetermined sequence for which they encode. In some instances, the error rate for synthesized polynucleotides on a substrate using the methods and systems described herein is less than about 1 in 200, less than about 1 in 1,000, less than about 1 in 2,000, less than about 1 in 3,000, or less than about 1 in 5,000. Individual types of error rates include mismatches, deletions, insertions, and/or substitutions for the polynucleotides synthesized on the substrate. The term “error rate” refers to a comparison of the collective amount of synthesized polynucleotide to an aggregate of predetermined polynucleotide sequences. In some instances, synthesized polynucleotides disclosed herein comprise a tether of 12 to 25 bases. In some instances, the tether comprises 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more bases.

Described herein are methods, systems, devices, and compositions wherein chemical reactions used in polynucleotide synthesis are controlled using electrochemistry. Electrochemical reactions in some instances are controlled by any source of energy, such as light, heat, radiation, or electricity. For example, electrodes are used to control chemical reactions as all or a portion of discrete loci on a surface. Electrodes in some instances are charged by applying an electrical potential to the electrode to control one or more chemical steps in polynucleotide synthesis. In some instances, these electrodes are addressable. Any number of the chemical steps described herein is in some instances controlled with one or more electrodes. Electrochemical reactions may comprise oxidations, reductions, acid/base chemistry, or other reaction that is controlled by an electrode. In some instances, electrodes generate electrons or protons that are used as reagents for chemical transformations. Electrodes in some instances directly generate a reagent such as an acid. In some instances, an acid is a proton. Electrodes in some instances directly generate a reagent such as a base. Acids or bases are often used to cleave protecting groups, or influence the kinetics of various polynucleotide synthesis reactions, for example by adjusting the pH of a reaction solution. Electrochemically controlled polynucleotide synthesis reactions in some instances comprise redox-active metals or other redox-active organic materials. In some instances, metal or organic catalysts are employed with these electrochemical reactions. In some instances, acids are generated from oxidation of quinones.

Control of chemical reactions is not limited to the electrochemical generation of reagents; chemical reactivity may be influenced indirectly through biophysical changes to substrates or reagents through electric fields (or gradients) which are generated by electrodes. In some instances, substrates include but are not limited to polynucleotides. In some instances, electrical fields which repel or attract specific reagents or substrates towards or away from an electrode or surface are generated. Such fields in some instances are generated by application of an electrical potential to one or more electrodes. For example, negatively charged polynucleotides are repelled from negatively charged electrode surfaces. Such repulsions or attractions of polynucleotides or other reagents caused by local electric fields in some instances provides for movement of polynucleotides or other reagents in or out of region of the synthesis device or structure. In some instances, electrodes generate electric fields which repel polynucleotides away from a synthesis surface, structure, or device. In some instances, electrodes generate electric fields which attract polynucleotides towards a synthesis surface, structure, or device. In some instances, protons are repelled from a positively charged surface to limit contact of protons with substrates or portions thereof. In some instances, repulsion or attractive forces are used to allow or block entry of reagents or substrates to specific areas of the synthesis surface. In some instances, nucleoside monomers are prevented from contacting a polynucleotide chain by application of an electric field in the vicinity of one or both components. Such arrangements allow gating of specific reagents, which may obviate the need for protecting groups when the concentration or rate of contact between reagents and/or substrates is controlled. In some instances, unprotected nucleoside monomers are used for polynucleotide synthesis. Alternatively, application of the field in the vicinity of one or both components promotes contact of nucleoside monomers with a polynucleotide chain. Additionally, application of electric fields to a substrate can alter the substrates reactivity or conformation. In an exemplary application, electric fields generated by electrodes are used to prevent polynucleotides at adjacent loci from interacting. In some instances, the substrate is a polynucleotide, optionally attached to a surface. Application of an electric field in some instances alters the three-dimensional structure of a polynucleotide. Such alterations comprise folding or unfolding of various structures, such as helices, hairpins, loops, or other 3-dimensional nucleic acid structure. Such alterations are useful for manipulating polynucleotides inside of wells, channels, or other structures. In some instances, electric fields are applied to a nucleic acid substrate to prevent secondary structures. In some instances, electric fields obviate the need for linkers or attachment to a solid support during polynucleotide synthesis.

A suitable method for polynucleotide synthesis on a substrate of this disclosure is a phosphoramidite-based synthesis of DNA. In some cases, a reagent for the phosphoramidite-based synthesis comprises any one of or a combination of a nucleoside phosphoramidite, an oxidizer, an activator, or a deblocker or the solvent comprises acetonitrile. In some instances, the phosphoramidite-based synthesis method comprises the controlled addition of a phosphoramidite building block, i.e. nucleoside phosphoramidite, to a growing polynucleotide chain in a coupling step that forms a phosphite triester linkage between the phosphoramidite building block and a nucleoside bound to the substrate. In some instances, the nucleoside phosphoramidite is provided to the substrate activated. In some instances, the nucleoside phosphoramidite is provided to the substrate with an activator. In some instances, nucleoside phosphoramidites are provided to the substrate in a 1.5, 2, 3, 4, 5, 6, 7, 8, 9, 10, 11, 12, 13, 14, 15, 16, 17, 18, 19, 20, 25, 30, 35, 40, 50, 60, 70, 80, 90, 100-fold excess or more over the substrate-bound nucleosides. In some instances, the addition of nucleoside phosphoramidite is performed in an anhydrous environment, for example, in anhydrous acetonitrile. Following addition and linkage of a nucleoside phosphoramidite in the coupling step, the substrate is optionally washed. In some instances, the coupling step is repeated one or more additional times, optionally with a wash step between nucleoside phosphoramidite additions to the substrate. In some instances, a polynucleotide synthesis method used herein comprises 1, 2, 3 or more sequential coupling steps. Prior to coupling, in many cases, the nucleoside bound to the substrate is de-protected by removal of a protecting group, where the protecting group functions to prevent polymerization. Protecting groups may comprise any chemical group that prevents extension of the polynucleotide chain. In some instances, the protecting group is cleaved (or removed) in the presence of an acid. In some instances, the protecting group is cleaved in the presence of a base. In some instances, the protecting group is removed with electromagnetic radiation such as light, heat, or other energy source. In some instances, the protecting group is removed through an oxidation or reduction reaction (e.g., a. In some instances, a protecting group comprises a triarylmethyl group. In some instances, a protecting group comprises an aryl ether. In some instances, a protecting comprises a disulfide. In some instances a protecting group comprises an acid-labile silane. In some instances, a protecting group comprises an acetal. In some instances, a protecting group comprises a ketal. In some instances, a protecting group comprises an enol ether. In some instances, a protecting group comprises a methoxybenzyl group. In some instances, a protecting group comprises an azide. In some instances, a protecting group is 4,4′-dimethoxytrityl (DMT). In some instances, a protecting group is a tert-butyl carbonate. In some instances, a protecting group is a tert-butyl ester. In some instances, a protecting group comprises a base-labile group.

Following coupling, phosphoramidite polynucleotide synthesis methods optionally comprise a capping step. In a capping step, the growing polynucleotide is treated with a capping agent. A capping step generally serves to block unreacted substrate-bound 5′—OH groups after coupling from further chain elongation, preventing the formation of polynucleotides with internal base deletions. Further, phosphoramidites activated with 1H-tetrazole often react, to a small extent, with the 06 position of guanosine. Without being bound by theory, upon oxidation with I2/water, this side product, possibly via O6-N7 migration, undergoes depurination. The apurinic sites can end up being cleaved in the course of the final deprotection of the polynucleotide thus reducing the yield of the full-length product. The O6 modifications may be removed by treatment with the capping reagent prior to oxidation with I2/water. In some instances, inclusion of a capping step during polynucleotide synthesis decreases the error rate as compared to synthesis without capping. As an example, the capping step comprises treating the substrate-bound polynucleotide with a mixture of acetic anhydride and 1-methylimidazole. Following a capping step, the substrate is optionally washed.

Following addition of a nucleoside phosphoramidite, and optionally after capping and one or more wash steps, a substrate described herein comprises a bound growing nucleic acid that may be oxidized. The oxidation step comprises oxidizing the phosphite triester into a tetracoordinated phosphate triester, a protected precursor of the naturally occurring phosphate diester internucleoside linkage. In some instances, phosphite triesters are oxidized electrochemically. In some instances, oxidation of the growing polynucleotide is achieved by treatment with iodine and water, optionally in the presence of a weak base such as a pyridine, lutidine, or collidine. Oxidation is sometimes carried out under anhydrous conditions using tert-Butyl hydroperoxide or (1S)-(+)-(10-camphorsulfonyl)-oxaziridine (CSO). In some methods, a capping step is performed following oxidation. A second capping step allows for substrate drying, as residual water from oxidation that may persist can inhibit subsequent coupling. Following oxidation, the substrate and growing polynucleotide is optionally washed. In some instances, the step of oxidation is substituted with a sulfurization step to obtain polynucleotide phosphorothioates, wherein any capping steps can be performed after the sulfurization. Many reagents are capable of the efficient sulfur transfer, including, but not limited to, 3-(Dimethylaminomethylidene)amino)-3H-1,2,4-dithiazole-3-thione, DDTT, 3H-1,2-benzodithiol-3-one 1,1-dioxide, also known as Beaucage reagent, and N,N,N′N′-Tetraethylthiuram disulfide (TETD).

For a subsequent cycle of nucleoside incorporation to occur through coupling, a protected 5′ end (or 3′ end, if synthesis is conducted in a 5′ to 3′ direction) of the substrate bound growing polynucleotide is be removed so that the primary hydroxyl group can react with a next nucleoside phosphoramidite. In some instances, the protecting group is DMT and deblocking occurs with trichloroacetic acid in dichloromethane. In some instances, the protecting group is DMT and deblocking occurs with electrochemically generated protons. Conducting detritylation for an extended time or with stronger than recommended solutions of acids may lead to increased depurination of solid support-bound polynucleotide and thus reduces the yield of the desired full-length product. Methods and compositions described herein provide for controlled deblocking conditions limiting undesired depurination reactions. In some instances, the substrate bound polynucleotide is washed after deblocking. In some cases, efficient washing after deblocking contributes to synthesized polynucleotides having a low error rate. Methods for the synthesis of polynucleotides on a substrate described herein may involve an iterating sequence of the following steps: application of a protected monomer to a surface of a substrate feature to link with either the surface, a linker or with a previously deprotected monomer; deprotection of the applied monomer so that it can react with a subsequently applied protected monomer; and application of another protected monomer for linking. One or more intermediate steps include oxidation and/or sulfurization. In some instances, one or more wash steps precede or follow one or all of the steps.

Methods for the synthesis of polynucleotides on a substrate described herein may comprise an oxidation step. For example, methods involve an iterating sequence of the following steps: application of a protected monomer to a surface of a substrate feature to link with either the surface, a linker or with a previously deprotected monomer; deprotection of the applied monomer so that it can react with a subsequently applied protected monomer; application of another protected monomer for linking, and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; deprotection of the applied monomer so that it can react with a subsequently applied protected monomer; and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; deprotection of the applied monomer so that it can react with a subsequently applied protected monomer; and oxidation and/or sulfurization. In some instances, one or more wash steps precede or follow one or all of the steps.

In some instances, polynucleotides are synthesized with photolabile protecting groups, where the hydroxyl groups generated on the surface are blocked by photolabile-protecting groups. When the surface is exposed to UV light, such as through a photolithographic mask, a pattern of free hydroxyl groups on the surface may be generated. These hydroxyl groups can react with photoprotected nucleoside phosphoramidites, according to phosphoramidite chemistry. A second photolithographic mask can be applied and the surface can be exposed to UV light to generate second pattern of hydroxyl groups, followed by coupling with 5′-photoprotected nucleoside phosphoramidite. Likewise, patterns can be generated and oligomer chains can be extended. Without being bound by theory, the lability of a photocleavable group depends on the wavelength and polarity of a solvent employed and the rate of photocleavage may be affected by the duration of exposure and the intensity of light. This method can leverage a number of factors such as accuracy in alignment of the masks, efficiency of removal of photo-protecting groups, and the yields of the phosphoramidite coupling step. Further, unintended leakage of light into neighboring sites can be minimized. The density of synthesized oligomer per spot can be monitored by adjusting loading of the leader nucleoside on the surface of synthesis.

The surface of a substrate described herein that provides support for polynucleotide synthesis may be chemically modified to allow for the synthesized polynucleotide chain to be cleaved from the surface. In some instances, the polynucleotide chain is cleaved at the same time as the polynucleotide is deprotected. In some cases, the polynucleotide chain is cleaved after the polynucleotide is deprotected. In an exemplary scheme, a trialkoxysilyl amine such as (CH₃CH₂O)₃Si—(CH₂)₂—NH₂ is reacted with surface SiOH groups of a substrate, followed by reaction with succinic anhydride with the amine to create an amide linkage and a free OH on which the nucleic acid chain growth is supported. Cleavage includes gas cleavage with ammonia or methylamine. In some instances cleavage includes linker cleavage with electrically generated reagents such as acids or bases. In some instances, once released from the surface, polynucleotides are assembled into larger polynucleotides that are sequenced and decoded to extract stored information.

The surfaces described herein can be reused after polynucleotide cleavage to support additional cycles of polynucleotide synthesis. For example, the linker can be reused without additional treatment/chemical modifications. In some instances, a linker is non-covalently bound to a substrate surface or a polynucleotide. In some embodiments, the linker remains attached to the polynucleotide after cleavage from the surface. Linkers in some embodiments comprise reversible covalent bonds such as esters, amides, ketals, beta substituted ketones, heterocycles, or other group that is capable of being reversibly cleaved. Such reversible cleavage reactions are in some instances controlled through the addition or removal of reagents, or by electrochemical processes controlled by electrodes. Optionally, chemical linkers or surface-bound chemical groups are regenerated after a number of cycles, to restore reactivity and remove unwanted side product formation on such linkers or surface-bound chemical groups.

Alternatively, the polymer synthesis can be enzymatic DNA synthesis. In some cases, the enzymatic DNA synthesis uses water as a solvent and the reagent is an enzyme terminal deoxynucleotidyl transferase (TdT) or a deblocker. In some cases, enzymatic synthesis of DNA uses a template-independent DNA polymerase, terminal deoxynucleotidyl transferase (TdT), which is a protein that evolved to rapidly catalyze the linkage of naturally occurring dNTPs. TdT adds nucleotides indiscriminately so it is stopped from continuing unregulated synthesis by various techniques such a tethering the TDT, creating variant enzymes, and using nucleotides that include reversible terminators to prevent chain elongation. TdT activity is maximized at approximately 37 °C and performs enzymatic reactions in an aqueous environment.

### Sequencing

Polynucleotides are extracted and/or amplified from surfaces where they are synthesized or stored. After extraction and/or amplification of polynucleotides from the surface of a structure, suitable sequencing technology may be employed to sequence the polynucleotides. In some cases, the DNA sequence is read on the substrate or within a feature of a structure. In some cases, the polynucleotides stored on the substrate are extracted is optionally assembled into longer polynucleotides and then sequenced.

Polynucleotides synthesized and stored on the structures described herein encode data that can be interpreted by reading the sequence of the synthesized polynucleotides and converting the sequence into binary code readable by a computer. In some cases the sequences require assembly, and the assembly step may need to be at the nucleic acid sequence stage or at the digital sequence stage.

Provided herein are detection systems comprising a device capable of sequencing stored polynucleotides, either directly on the synthesis structure and/or after removal from the main structure (e.g., synthesis structure, storage structure, etc.). In cases where the synthesis structure is a reel-to-reel tape of flexible material, the detection system comprises a device for holding and advancing the structure through a detection location and a detector disposed proximate the detection location for detecting a signal originated from a section of the tape when the section is at the detection location. In some instances, the signal is indicative of a presence of a polynucleotide. In some instances, the signal is indicative of a sequence of a polynucleotide (e.g., a fluorescent signal). In some instances, information encoded within polynucleotides on a continuous tape is read by a computer as the tape is conveyed continuously through a detector operably connected to the computer. In some instances, a detection system comprises a computer system comprising a polynucleotide sequencing device, a database for storage and retrieval of data relating to polynucleotide sequence, software for converting DNA code of a polynucleotide sequence to binary code, a computer for reading the binary code, or any combination thereof.

Provided herein are sequencing systems that can be integrated into the devices described herein. Various methods of sequencing are well known in the art, and comprise “base calling” wherein the identity of a base in the target polynucleotide is identified. In some instances, polynucleotides synthesized using the methods, devices, compositions, and systems described herein are sequenced after cleavage from the synthesis surface. In some instances, sequencing occurs during or simultaneously with polynucleotide synthesis, wherein base calling occurs immediately after or before extension of a nucleoside monomer into the growing polynucleotide chain. Methods for base calling include measurement of electrical currents/voltages generated by polymerase-catalyzed addition of bases to a template strand. In some instances, synthesis surfaces comprise enzymes, such as polymerases. In some instances, such enzymes are tethered to electrodes or to the synthesis surface. In some instances, enzymes comprise terminal deoxynucleotidyl transferases, or variants thereof.

### Computing System

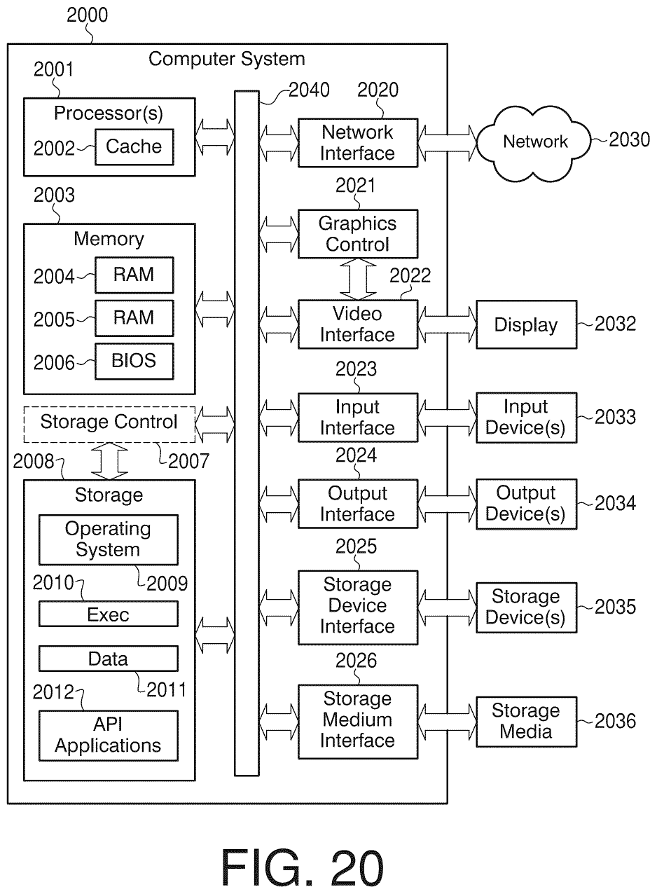

Referring to FIG. 20, a block diagram is shown depicting an exemplary machine that includes a computer system 2000 (e.g., a processing or computing system) within which a set of instructions can execute for causing a device to perform or execute any one or more of the aspects and/or methodologies for static code scheduling of the present disclosure. The components in FIG. 20 are examples only and do not limit the scope of use or functionality of any hardware, software, embedded logic component, or a combination of two or more such components implementing particular embodiments. A computing system as generally illustrated in FIG. 20 may be part of a data storage system, as exemplary illustrated in FIG. 18.

In various aspects, any of the systems (e.g., FIG. 16, FIG. 18, etc.) described herein are operably linked to a computer and are optionally automated through a computer either locally or remotely. In various instances, the methods and systems described herein further comprise software programs on computer systems and use thereof. Accordingly, computerized control for the synchronization of the dispense/vacuum/refill functions such as orchestrating and synchronizing the material deposition device movement, dispense action and vacuum actuation are within the bounds of the disclosure provided herein. In some instances, the computer systems are programmed to interface between the user specified base sequence and the position of a material deposition device to deliver the correct building blocks and/or reagents to specified regions of the substrate (e.g., specific loci).

As an example, a computer system, such as the system shown in FIG. 20, may be used for encoding data represented as a set of symbols to another set of symbols. For example, the data may be represented as numerical symbols, such as binary values of “0”s and “1”'s and the computer system may execute a program comprising a codec (e.g., an error correction code, such as RS code, LDPC code, Turbo code, etc.). In some instances, the computer system converts a first string of symbols to a second string of symbols using the program. In some instances, the computer system executes a program to convert the data to a plurality of nucleic acid sequences, convert a plurality of nucleic acid sequences to data, or both. In some instances, the computer system executes a program to convert a first one or more nucleic acid sequence to a second one or more nucleic acid sequences. For example, the computer program may convert a first one or more nucleic acid sequence to a second one or more nucleic acid sequence, where the second one or more nucleic acid sequences is more resistant to oxidation compared to the first one or more nucleic acid sequences.

As an example, a computer system, such as the system shown in FIG. 20, may be used for monitoring one or more components in a data storage system (e.g., FIG. 18) or a biomolecule extraction system (e.g., FIG. 16). For example, the computer system may be used to monitor one or more sensor data from a sensor integrated in or connected to a components or modules in the systems illustrated herein. In some instances, the computer system employs an program to monitor and detect irregularities in one or more parameters, such as pressure, volume, flow rate, temperature, vacuum, angles of orientation, humidity, or any other physical parameters that can be measured in the systems and platforms described herein. The computer system comprising the program may analyze patterns in one or more sensor data and optionally alert a user through a HMI if any irregularities are detected or if any data or combination of data fall outside of a threshold (e.g., predetermined or dynamic thresholds).

A program may be executed on a computer system provided herein. In some instances, a program comprises a statistical algorithm or a machine learning algorithm. In some instances, an algorithm comprising machine learning (ML) is trained to perform the functions or operations described herein. In some cases, the algorithm comprises classical ML algorithms for classification and/or clustering (e.g., K-means clustering, mean-shift clustering, density-based spatial clustering of applications with noise (DBSCAN), expectation-maximization (EM) clustering, agglomerative hierarchical clustering, logistic regression, naïve Bayes, K-nearest neighbors, random forests or decision trees, gradient boosting, support vector machines (SVMs), or a combination thereof).

In some cases, the algorithm comprises a learning algorithm comprising layers, such as one or more neural networks. Neural networks may comprise connected nodes in a network, which may perform functions, such as transforming or translating input data. In some examples, the output from a given node may be passed on as input to another node. In some embodiments, the nodes in the network may comprise input units, hidden units, output units, or a combination thereof. In some cases, an input node may be connected to one or more hidden units. In some cases, one or more hidden units may be connected to an output unit. The nodes may take in input and may generate an output based on an activation function. In some embodiments, the input or output may be a tensor, a matrix, a vector, an array, or a scalar. In some embodiments, the activation function may be a Rectified Linear Unit (ReLU) activation function, a sigmoid activation function, or a hyperbolic tangent activation function. In some embodiments, the activation function may be a Softmax activation function. The connections between nodes may further comprise weights for adjusting input data to a given node (e.g., to activate input data or deactivate input data). In some embodiments, the weights may be learned by the neural network. In some embodiments, the neural network may be trained using gradient-based optimizations. In some cases, the gradient-based optimization may comprise of one or more loss functions. In some examples, the gradient-based optimization may be conjugate gradient descent, stochastic gradient descent, or a variation thereof (e.g., adaptive moment estimation (Adam)). In further examples, the gradient in the gradient-based optimization may be computed using backpropagation. In some embodiments, the nodes may be organized into graphs to generate a network (e.g., graph neural networks). In some embodiments, the nodes may be organized into one or more layers to generate a network (e.g., feed forward neural networks, convolutional neural networks (CNNs), recurrent neural networks (RNNs), etc.). In some cases, the neural network may be a deep neural network comprising of more than one layer.

In some cases, the neural network may comprise one or more recurrent layer. In some examples, the one or more recurrent layer may be one or more long short-term memory (LSTM) layers or gated recurrent unit (GRU), which may perform sequential data classification and clustering. In some embodiments, the neural network may comprise one or more convolutional layers. The input and output may be a tensor representing of variables or attributes in a data set (e.g., features), which may be referred to as a feature map (or activation map). In some cases, the convolutions may be one dimensional (1D) convolutions, two dimensional (2D) convolutions, three dimensional (3D) convolutions, or any combination thereof. In further cases, the convolutions may be 1D transpose convolutions, 2D transpose convolutions, 3D transpose convolutions, or any combination thereof. In some examples, one-dimensional convolutional layers may be suited for time series data since it may classify time series through parallel convolutions. In some examples, convolutional layers may be used for analyzing a signal (e.g., sensor data) from one or more components of a system described herein.

The layers in a neural network may further comprise one or more pooling layers before or after a convolutional layer. The one or more pooling layers may reduce the dimensionality of the feature map using filters that summarize regions of a matrix. This may down sample the number of outputs, and thus reduce the parameters and computational resources needed for the neural network. In some embodiments, the one or more pooling layers may be max pooling, min pooling, average pooling, global pooling, norm pooling, or a combination thereof. Max pooling may reduce the dimensionality of the data by taking only the maximums values in the region of the matrix, which helps capture the significant feature. In some embodiments, the one or more pooling layers may be one dimensional (1D), two dimensional (2D), three dimensional (3D), or any combination thereof. The neural network may further comprise of one or more flattening layers, which may flatten the input to be passed on to the next layer. In some cases, the input may be flattened by reducing it to a one-dimensional array. The flattened inputs may be used to output a classification of an object (e.g., classification of signals (e.g., sensor data) in a system described herein). The neural networks may further comprise one or more dropout layers. Dropout layers may be used during training of the neural network (e.g., to perform binary or multi-class classifications). The one or more dropout layers may randomly set certain weights as 0, which may set corresponding elements in the feature map as 0, so the neural network may avoid overfitting. The neural network may further comprise one or more dense layers, which comprise a fully connected network. In the dense layer, information may be passed through the fully connected network to generate a predicted classification of an object, and the error may be calculated. In some embodiments, the error may be backpropagated to improve the prediction. The one or more dense layers may comprise a Softmax activation function, which may convert a vector of numbers to a vector of probabilities. These probabilities may be subsequently used in classifications, such as classifications of signal (e.g., sensor data) from a system described herein, or probable nucleobases during decoding (e.g., as part of a codec).

Computer system 2000 may include one or more processors 2001, a memory 2003, and a storage 2008 that communicate with each other, and with other components, via a bus 2040. The bus 2040 may also link a display 2032, one or more input devices 2033 (which may, for example, include a keypad, a keyboard, a mouse, a stylus, etc.), one or more output devices 2034, one or more storage devices 2035, and various tangible storage media 2036. All of these elements may interface directly or via one or more interfaces or adaptors to the bus 2040. For instance, the various tangible storage media 2036 can interface with the bus 2040 via storage medium interface 2026. Computer system 2000 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 2000 includes one or more processor(s) 2001 (e.g., central processing units (CPUs), general purpose graphics processing units (GPGPUs), or quantum processing units (QPUs)) that carry out functions. Processor(s) 2001 optionally contains a cache memory unit 2002 for temporary local storage of instructions, data, or computer addresses. Processor(s) 2001 are configured to assist in execution of computer readable instructions. Computer system 2000 may provide functionality for the components depicted in FIG. 20 as a result of the processor(s) 2001 executing non-transitory, processor-executable instructions embodied in one or more tangible computer-readable storage media, such as memory 2003, storage 2008, storage devices 2035, and/or storage medium 2036. The computer-readable media may store software that implements particular embodiments, and processor(s) 2001 may execute the software. Memory 2003 may read the software from one or more other computer-readable media (such as mass storage device(s) 2035, 2036) or from one or more other sources through a suitable interface, such as network interface 2020. The software may cause processor(s) 2001 to carry out one or more processes or one or more steps of one or more processes described or illustrated herein. Carrying out such processes or steps may include defining data structures stored in memory 2003 and modifying the data structures as directed by the software.

The memory 2003 may include various components (e.g., machine readable media) including, but not limited to, a random access memory component (e.g., RAM 2004) (e.g., static RAM (SRAM), dynamic RAM (DRAM), ferroelectric random access memory (FRAM), phase-change random access memory (PRAM), etc.), a read-only memory component (e.g., ROM 2005), and any combinations thereof. ROM 2005 may act to communicate data and instructions unidirectionally to processor(s) 2001, and RAM 2004 may act to communicate data and instructions bidirectionally with processor(s) 2001. ROM 2005 and RAM 2004 may include any suitable tangible computer-readable media described below. In one example, a basic input/output system 2006 (BIOS), including basic routines that help to transfer information between elements within computer system 2000, such as during start-up, may be stored in the memory 2003.

Fixed storage 2008 is connected bidirectionally to processor(s) 2001, optionally through storage control unit 2007. Fixed storage 2008 provides additional data storage capacity and may also include any suitable tangible computer-readable media described herein. Storage 2008 may be used to store operating system 2009, executable(s) 2010, data 2011, applications 2012 (application programs), and the like. Storage 2008 can also include an optical disk drive, a solid-state memory device (e.g., flash-based systems), or a combination of any of the above. Information in storage 2008 may, in appropriate cases, be incorporated as virtual memory in memory 2003.

In one example, storage device(s) 2035 may be removably interfaced with computer system 2000 (e.g., via an external port connector (not shown)) via a storage device interface 2025. Particularly, storage device(s) 2035 and an associated machine-readable medium may provide non-volatile and/or volatile storage of machine-readable instructions, data structures, program modules, and/or other data for the computer system 2000. In one example, software may reside, completely or partially, within a machine-readable medium on storage device(s) 2035. In another example, software may reside, completely or partially, within processor(s) 2001.

Bus 2040 connects a wide variety of subsystems. Herein, reference to a bus may encompass one or more digital signal lines serving a common function, where appropriate. Bus 2040 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2000 may also include an input device 2033. In one example, a user of computer system 2000 may enter commands and/or other information into computer system 2000 via input device(s) 2033. Examples of an input device(s) 2033 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 2033 may be interfaced to bus 2040 via any of a variety of input interfaces 2023 (e.g., input interface 2023) including, but not limited to, serial, parallel, game port, USB, FIREWIRE, THUNDERBOLT, or any combination of the above.

In particular embodiments, when computer system 2000 is connected to network 2030, computer system 2000 may communicate with other devices, specifically mobile devices and enterprise systems, distributed computing systems, cloud storage systems, cloud computing systems, and the like, connected to network 2030. In some embodiments, the computing system 2000 may communicate with one or more components of a system of data storage (e.g., FIG. 20). For example, the computing system 2000 may communicate with (e.g., control or manage) the robotic system 1330. Communications to and from computer system 2000 may be sent through network interface 2020. For example, network interface 2020 may receive incoming communications (such as requests or responses from other devices) in the form of one or more packets (such as Internet Protocol (IP) packets) from network 2030, and computer system 2000 may store the incoming communications in memory 2003 for processing. Computer system 2000 may similarly store outgoing communications (such as requests or responses to other devices) in the form of one or more packets in memory 2003 and communicated to network 2030 from network interface 2020. In some embodiments, the computing system 2000 has access to a tag on a structure for data storage, such as, for example, an RFID tag. In some embodiments, the computing system 2000 manages the information of the tag, as well as an associated file system or database. Processor(s) 2001 may access these communication packets stored in memory 2003 for processing.

Examples of the network interface 2020 include, but are not limited to, a network interface card, a modem, and any combination thereof. Examples of a network 2030 or network segment 2030 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 2030, may employ a wired and/or a wireless mode of communication. In general, any network topology may be used.

Information and data can be displayed through a display 2032. Examples of a display 2032 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 2032 can interface to the processor(s) 2001, memory 2003, and fixed storage 2008, as well as other devices, such as input device(s) 2033, via the bus 2040. The display 2032 is linked to the bus 2040 via a video interface 2022, and transport of data between the display 2032 and the bus 2040 can be controlled via the graphics control 2021. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 2032, computer system 2000 may include one or more other peripheral output devices 2034 including, but not limited to, an audio speaker, a printer, a storage device, and any combinations thereof. In some instances, a peripheral output device 2034 may correspond to a tag on a structure, such as, for example, an RFID tag. Such peripheral output devices may be connected to the bus 2040 via an output interface 2024. Examples of an output interface 2024 include, but are not limited to, a serial port, a parallel connection, a USB port, a FIREWIRE port, a THUNDERBOLT port, and any combinations thereof.

In addition or as an alternative, computer system 2000 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information, such as information related to a system or platform (e.g., for data storage or biomolecule extraction) provided herein. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### CERTAIN DEFINITIONS

Unless otherwise defined, all technical terms used herein have the same meaning as commonly understood by one of ordinary skill in the art to which the present subject matter belongs.

Throughout this disclosure, numerical features are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the invention, subject to any specifically excluded limit in the stated range. Where the stated range includes one or both of the limits, ranges excluding either or both of those included limits are also included in the invention, unless the context clearly dictates otherwise.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference throughout this specification to “some instances,” “further instances,” or “a particular instance,” means that a particular feature, structure, or characteristic described in connection with the instance is included in at least one instance. Thus, the appearances of the phrase “in some instances,” or “in further instances,” or “in a particular instance” in various places throughout this specification are not necessarily all referring to the same instance. Furthermore, the particular features, structures, or characteristics may be combined in any suitable manner in one or more instances.

Unless specifically stated or obvious from context, as used herein, the term “about” in reference to a number or range of numbers is understood to mean the stated number and numbers+/−10% thereof, or 10% below the lower listed limit and 10% above the higher listed limit for the values listed for a range.

Polynucleotide sequences described herein may be, unless stated otherwise, comprise DNA or RNA or an analog or derivative thereof. As used herein, the terms nucleic acids, polynucleotides, oligonucleotides, oligos, oligonucleic acids are used synonymously throughout to represent a polymer of nucleoside monomers. In some instances, nucleic acids are connected via phosphate or sulfur-containing linkages. Nucleic acids in some instances comprise DNA, RNA, non-canonical nucleic acids, unnatural nucleic acids, or other nucleoside. In some instances, nucleotides comprise non-canonical bases, sugars, or other moiety. In some instances, nucleotides comprise terminators which are configured to prevent extension reactions. In some instances, such terminators are removed before addition of subsequent nucleotides to the growing chain.

### EXAMPLES

The following illustrative examples are representative of embodiments of the software applications, systems, and methods described herein and are not meant to be limiting in any way.

### Example 1—Flow Cell Development and Optimization

An experimental setup was constructed to develop and optimize fluid extraction from a flow cell. The experimental set up is shown in FIG. 11. Fluid handling was achieved using a Harvard Apparatus Pico 11 Elite (Model number 70-4504) syringe pump (continuous displacement pump). The flow cell consisted of a recessed PEEK surface and a functionalized glass substrate with the target molecules adsorbed to its surface, forming the outer faces of the cavity. A 2 mL Eppendorf© tube acted as a reservoir for collecting the extracted product and the efficiency of liquid-retrieval was measured gravimetrically.

The experimental protocol that was used to test and optimize parameters is as follows: (i) place the flow cell in a vertical orientation with collection tube attached to the bottom and syringe pump attached to the top; (ii) fill 1 ml reagent (liquid to be tested) in the collection tube and measure tube weight for ‘weight before’; (iii) fill reagent being tested in the flow cell with the right process parameters; (iv) evacuate reagent from the flow cell at the specified flow rate and volume; (v) measure tube weight for ‘weight after’; and (vi) determine weight loss/density=volume loss to assess recovery efficiency.

The following parameters were kept constant: (i) reagent fill rate: 25 μL/s; (ii) total volume filled in the flow cell: 600 μL; and (iii) the reagent: water.

The following parameters were varied for experimentation: (i) angle α (representing the angle the cavity planes makes with the horizontal plane (x-y plane)): 90°; (ii) angle β (representing the angle formed between the bottom of the cavity and the horizontal plane (x-y plane)): 0° and 45°; and (iii) flow rate of evacuation (capillary number): 0.5, 5, 25, and 50 μL/s. For angle α, the visual observations demonstrated a more stable air-liquid interface when the angle was 90°, i.e., a vertical flow cell. This was demonstrated repeatedly, and the vertical flow cell was maintained as the control condition in all experimentation that followed. For angle β, a 45° angle was best suited for this parameter to minimize the oscillating flow. The recovery volume improved due to less liquid being entrapped by oscillating flow in the flow cell, as shown in the experimental results described below.

### Volume Loss as a Function of Flow Rate of Evacuation of a Fluid for β=0° and 450

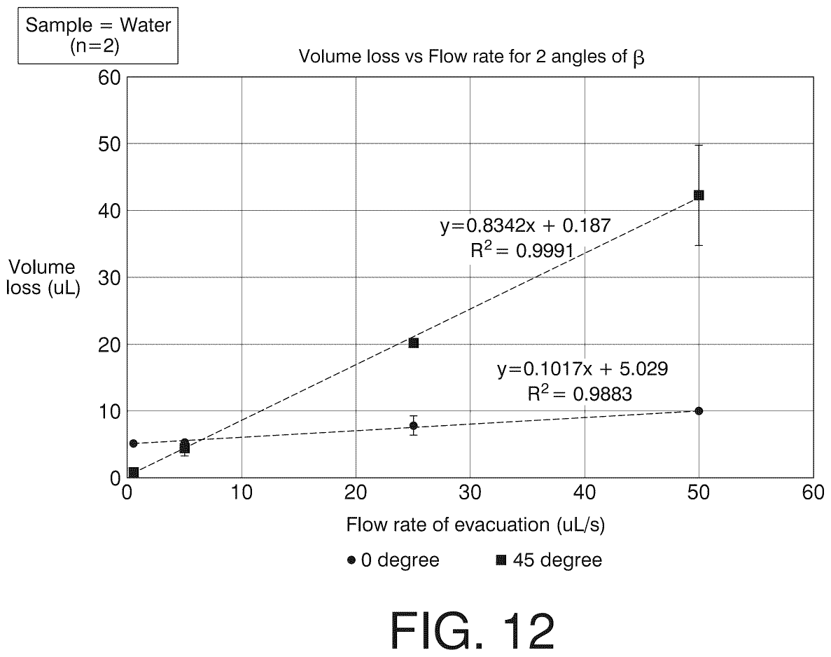

Volume loss (μL) as a function of flow rate of evacuation of a fluid (μL/s) for water from a flow cell was tested at two angles of orientation β=0° and 45° (FIG. 12). The flow rate of evacuation of the water was tested at 0.5, 5, 25, and 50 μL/s and the volume loss was measured based on the recovered amount of water. For the flow rate of evacuation, since a continuous displacement pump was used, the flow rate of air used to displace liquid from the cavity was varied to find an optimum value. It was seen that as the flow rate decreased the volume recovered increased. A flow rate of 5 μL/s was chosen as optimal since it gave acceptable volume recoveries and was practically suitable to give fast operation times.

### Volume Loss as a Function of Capillary Number for β=0° and 45°

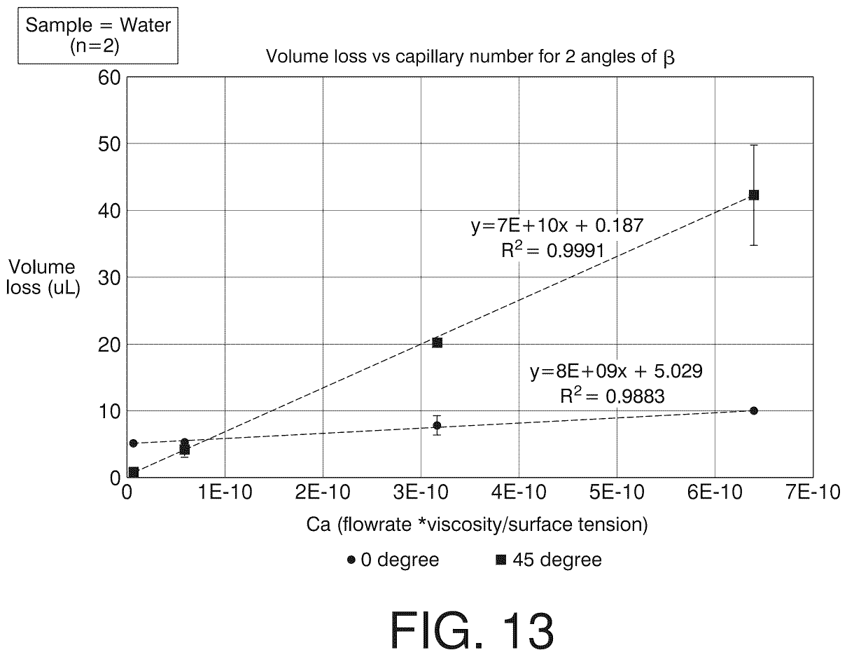

Volume loss (μL) as a function of capillary number (“Ca”) for water from a flow cell was tested at two angles of orientation β=0° and 45° (FIG. 13). The capillary number was calculated as follows: flow rate X viscosity/surface tension. For water, the functional relationship between the volume recovered and the capillary number was seen to be linear. The lower the capillary number, the surface tension forces counteract the body forces on the fluid thereby stabilizing the interface and improving volume recovered from the cavity.

Application of Flow Cell with Extraction Reagent

The general experimental setup and protocol described above is used to test the flow cell with a reagent for oligomer extraction. Oligomer extraction from a substrate surface can be achieved by having one of the surfaces in the cavity be replaced by the substrate containing biomolecules, such as oligomers, and use of a liquid-based reagent for chemical extraction. The primary reagent tested for liquid-based oligomer extraction from a substrate surface is a mixture of TBA, water and methanol in a 1:1:2 (volume/volume) ratio. Provided below is a table (Table 1) showing the difference in liquid properties between water and the reagent used for extraction of oligomers from substrates.

TABLE 1
Surface Tension and Viscosity of Liquids

| Water | | Extraction Reagent | |
|---|---|---|---|
| Surface | | Surface | |
| Tension | Viscosity | Tension | Viscosity |
| (N/m) × 10⁻³ | (Pa · s) × 10⁻³ | (N/m) × 10⁻³ | (Pa · s) × 10⁻³ |
| 71 | 0.91 | 2.3 | 2.5 |

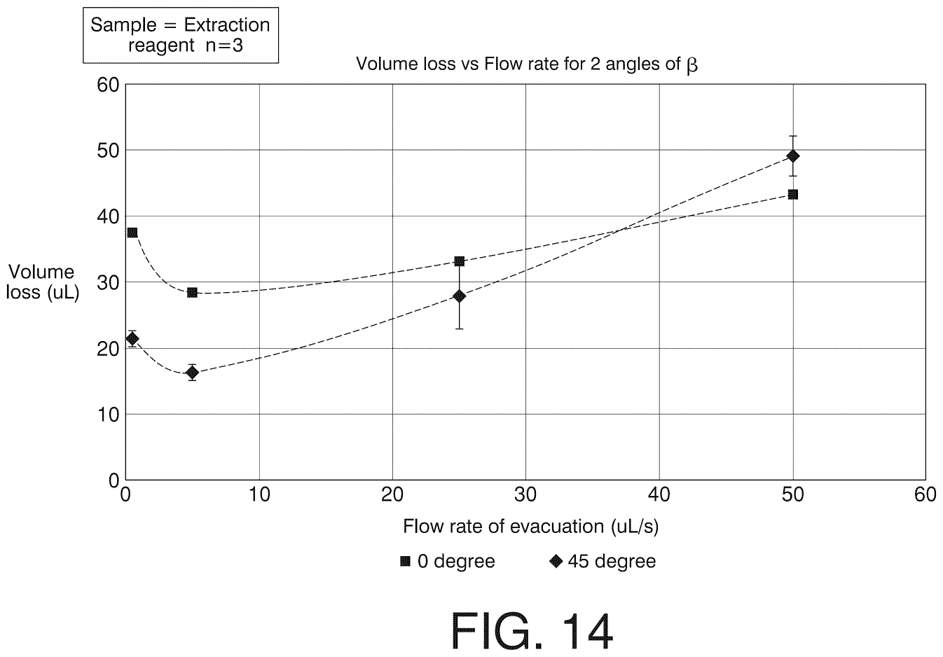

The following process parameters: angle β and flow rate of evacuation, were tested empirically for the vertical flow cell using the reagent mixture and the general method developed described above. The volume loss (μL) was measured as a function of flow rate of evacuation of the extraction reagent (μL/s) at two angles of the flow cell orientation: β=0° and 45° (FIG. 14). An optimal flow rate of evacuation for the extraction mixture was determined to be 5 μL/s with an angle β of 45° inclination.

The setups and methods demonstrated using a syringe pump, vertical flow cell and optimized process parameters for maximum recovery of liquid from a cavity. The method was applied to the reagent used for oligomer extraction and shown to be reliable in volume recovery. A vertical flow cell with a 90° angle of inclination for angle α helped to minimize the Saffman-Taylor instability for an air-liquid interface. An angle of inclination of 45° for the angle β helped to minimize the oscillating flow behavior observed due to the orifices and makes use of gravity to drain the liquid from the flow cell. A linear relationship was obtained between the capillary number and the volume recovered, with higher flow rates of evacuation showing reduced volume recovered due to unequal balances between the surface tension forces and the bulk inertial forces. A practical optimum of 5 μL/s for the flow rate of evacuation was chosen.

### Example 2—Modified Flow Cell with a Single Inlet and Outlet

A concept for a modified flow cell fluidic architecture was developed to eliminate multi-orifice-based complexity. In some instances, the presence of multiple orifices and a collector/distribution manifold in a flow cell can result in secondary phenomenon of oscillating flow. In some instances, each orifice can act as a source for this oscillating flow to develop, which can further increase the volume entrapped in the cavity. A single inlet and single outlet design was conceptualized with the other process parameters from Example 1, maintained to further simplify the design and minimize this phenomenon (FIG. 15).

### Example 3—Automated System for Liquid Extraction

The modified flow cell as generally illustrated in Example 2 was integrated into an automated system for liquid extraction. An exemplary automated system for liquid extraction was developed, as generally illustrated in piping and instrumentation (P&ID) diagram in FIG. 16, in order to maximize the liquid extracted from the flow cell. FIG. 17 shows a real experimental set up that was developed, including the flow cell integrated with a liquid handling system to make use of the method developed herein (Examples 1-2) to extract oligomers from substrates. As shown, the flow cell was oriented vertically (α=90°) and rotated 45° (β=45°), and connected through a first manifold to a plurality of reservoirs comprising reagents and a collection tube. The flow cell was also connected to a VICI pump through the second manifold, and a waste collection tube via the first and second manifold.

### Example 4—Automated System for DNA Data Storage

The biomolecule extraction system as generally illustrated in Example 3 is integrated into a data storage system as illustrated in FIG. 18. An item of information represented by a first string of symbols is converted to a second string of symbols comprising sequences of a plurality of nucleic acids using an inner codec and outer codec provided herein. The plurality of polynucleotides are synthesized in a synthesizer unit 1810. The substrate may be part of the cavity of the flow cell, and liquid comprising a reagent for biomolecule extraction is introduced to the cavity in a biomolecule extraction system illustrated in FIG. 16. After a time, a pump is used to displace liquid from the cavity using the methods for biomolecule extraction provided herein. The liquid comprising the plurality of nucleic acids are collected in a sample collection reservoir. The robotic system 1830 is used to transfer the sample collection reservoir to a storage unit 1815. The sample collection reservoir can be stored under one or more controlled conditions, such as temperature, humidity, pressure, vacuum, or any other physical parameter, in an identifiable layout (e.g., tray or rack) as described herein.

Alternatively, the substrate can be transferred using the robotic system 1830 to the storage unit 1815 for storage under one or more controlled conditions, such as temperature, humidity, pressure, vacuum, or any other physical parameter, in an identifiable layout (e.g., tray or rack) as described herein. When the item of information, whole or in-part, that is stored in the nucleic acids is retrieved, the robotic system 1830 can be used to transfer the substrate to a biomolecule extraction system as illustrated in FIG. 16. The substrate is placed in the cavity of the flow cell and liquid comprising a reagent for biomolecule extraction is introduced to the cavity. After a time, a pump is used to displace liquid from the cavity. The liquid comprising the plurality of nucleic acids are collected in a sample collection reservoir. The sample collection reservoir may be connected to or coextensive with the amplification unit 1820 and/or the sequencer unit 1825. The nucleic acids can be amplified and/or sequenced, and a codec as described herein may be applied to the output sequence to retrieve the item of information.

The present disclosure is further described by the following non-limiting items.

Item 1. A system for extracting biomolecules from a substrate, comprising:
(a) a flow cell comprising a cavity, wherein the cavity comprises a planar surface that is substantially parallel to a body force, and wherein the planar surface comprises a substrate comprising a plurality of biomolecules;
(b) a first reservoir connected to the flow cell, wherein the first reservoir comprises a liquid for extracting the plurality of biomolecules from the substrate; and
(c) a second reservoir connected to the flow cell for displacing liquid in the cavity.

Item 2. The system of item 1, further comprising a controller communicatively coupled to one or more actuators that open and close valves connected to the flow cell, the first reservoir, or the second reservoir.

Item 3. The system of item 2, wherein the controller is communicatively coupled to one or more electronic sensors, mechanical sensors, or both that sense conditions of the flow cell, wherein the controllers is programed to regulate flow of fluids in the system.

Item 4. The system of any one of items 1-3, wherein the cavity comprises a first opening and a second opening.

Item 5. The system of item 4, further comprising a first manifold connecting the cavity and the first reservoir, wherein the first manifold is connected to the first opening.

Item 6. The system of item 4 or 5, further comprising a second manifold connecting the cavity and the second reservoir, wherein the second manifold is connected to the second opening.

Item 7. The system of any one of items 4-6, wherein the first opening, the second opening, or both are located on opposite sides of the cavity.

Item 8. The system of any one of items 4-7, wherein the first opening, the second opening, or both comprises a plurality of holes.

Item 9. The system of item 8, wherein the plurality of holes comprises two to fifteen holes.

Item 10. The system of item 8 or 9, wherein each of the plurality of holes are 100 microns to 400 microns.

Item 11. The system of any one of items 1-10, wherein the second reservoir comprises a pressurized reservoir.

Item 12. The system of any one of items 1-11, wherein the second reservoir comprises a pump.

Item 13. The system of any one of items 1-12, further comprising a sample collection reservoir connected to the flow cell for collecting the plurality of biomolecules.

Item 14. The system of item 13, wherein the sample collection reservoir is connected to the flow cell through the first manifold.

Item 15. The system of any one of items 1-14, wherein the flow cell and the second reservoir are connected through a second manifold.

Item 16. The system of any one of items 1-15, further comprising a waste reservoir connected to the flow cell for collecting waste from the system.

Item 17. The system of item 16, wherein the waste reservoir is connected to the flow cell through the first manifold, the second manifold, or both.

Item 18. The system of any one of items 1-17, further comprising a plurality of reservoirs for holding liquid.

Item 19. The system of item 18, wherein each liquid of the plurality of reservoirs comprises a different liquid.

Item 20. The system of any one of items 1-19, wherein the liquid comprises a reagent for biomolecule extraction.

Item 21. The system of any one of items 1-20, wherein the liquid has a surface tension of 1×10⁻³ N/m to 90×10⁻³ N/m.

Item 22. The system of any one of items 1-21, wherein the liquid has a viscosity of 0.1×10⁻³ Pa s to 5×10⁻³ Pa s.

Item 23. The system of any one of items 1-22, wherein the cavity is oriented at a first angle of 90° relative to a horizontal plane, wherein the horizontal plane is perpendicular to the body force.

Item 24. The system of item 23, wherein the cavity is further oriented a second angle of 45° relative to the horizontal plane.

Item 25. The system of any one of items 1-24, wherein the cavity has a first length of 15 mm to 22 mm and a second length of 15 mm to 22 mm.

Item 26. The system of any one of items 1-25, wherein the cavity has third length of 0.1 mm to 0.4 mm.

Item 27. The system of any one of items 1-26, wherein the cavity is formed from a recess in the flow cell.

Item 28. The system of any one of items 1-27, wherein the cavity is enclosed by an O-ring, wherein the O-ring creates a fluidic boundary.

Item 29. The system of any one of items 1-28, wherein the flow cell comprises a Hele-Shaw flow cell.

Item 30. A flow cell device comprising
(a) a cavity comprising a first opening and a second opening, wherein the cavity comprises a planar surface that is substantially parallel to a body force;
(b) a first manifold connected to the first opening; and
(c) a second manifold is connected to the second opening, wherein the second manifold is located diagonally from the first manifold.

Item 31. The device of item 30, wherein the body force comprises a gravitational force.

Item 32. The device of item 30 or 31, wherein the cavity is oriented at a first angle of 90° relative to a horizontal plane, wherein the horizontal plane is perpendicular to the body force.

Item 33. The device of item 32, wherein the cavity is further oriented a second angle of 45° relative to the horizontal plane.

Item 34. The device of any one of items 30-33, wherein the cavity has a first length of 15 mm to 22 mm and a second length of 15 mm to 22 mm.

Item 35. The device of any one of items 30-34, wherein the cavity has third length of 0.1 mm to 0.4 mm.

Item 36. The device of any one of items 30-35, wherein the cavity is formed from a recess in the flow cell.

Item 37. The device of any one of items 30-36, wherein the cavity is enclosed by an O-ring, wherein the O-ring creates a fluidic boundary.

Item 38. The device of any one of items 30-37, wherein the flow cell comprises a Hele-Shaw flow cell.

Item 39. The device of any one of items 30-38, wherein the first opening, the second opening, or both are located on opposite sides of the cavity.

Item 40. The device of any one of items 30-39, wherein the first opening, the second opening, or both comprises a plurality of holes.

Item 41. The device of item 40, wherein the plurality of holes comprises about two to fifteen holes.

Item 42. The device of item 40 or 41, wherein each of the plurality of holes are 100 microns to 400 microns.

Item 43. A method for determining one or more conditions for recovering a maximum amount of liquid from a cavity in a flow cell, comprising:
(a) providing a system comprising:
   i. a flow cell comprising a cavity, wherein the cavity comprises a first opening and a second opening, wherein the cavity comprises a planar surface that is substantially parallel to a body force;
   ii. a first reservoir for holding a liquid connected to the first opening; and
   iii. a second reservoir connected to the second opening;
(b) introducing the liquid to the cavity of the flow cell;
(c) evacuating the liquid from the cavity of the flow cell;
(d) determining an amount of the liquid recovered from the cavity;
(e) adjusting a parameter of the system, wherein the parameter comprises a fill rate of the liquid, a volume of the liquid, the liquid, an evacuation rate of the liquid, a capillary number, or one or more angles of the flow cell relative to a horizontal plane, wherein the horizontal plane is perpendicular to a body force;
(f) repeating (b)-(e) to determine the one or more conditions for recovering the maximum amount of liquid from the cavity of the flow cell.

Item 44. The method of item 43, wherein determining the amount of the liquid recovered from the cavity comprises comparing a property of the liquid after evacuating the liquid from the cavity to the property of the liquid before filling the cavity with the liquid.

Item 45. The method of item 44, wherein the property comprises weight, density, or volume.

Item 46. The method of any one of items 43-45, wherein determining the amount of the liquid recovered from the cavity further comprises determining a recovery efficiency.

Item 47. The method of any one of items 43-46, wherein the body force comprises a gravitational force.

Item 48. The method of any one of items 43-47, wherein the fill rate of the liquid is 10 uL/s to 50 uL/s.

Item 49. The method of any one of items 43-48, wherein the volume of the liquid is 500 uL to 700 uL.

Item 50. The method of any one of items 43-49, wherein the evacuation rate of the liquid is about 0.5 uL/s to 50 uL/s.

Item 51. The method of any one of items 43-50, wherein the cavity is oriented at a first angle of 90° relative to the horizontal plane, wherein the horizontal plane is perpendicular to the body force.

Item 52. The method of any one of items 43-51, wherein the cavity is further oriented a second angle of 45° relative to the horizontal plane.

Item 53. The method of any one of items 43-52, wherein the cavity has a first length of 15 mm to 22 mm and a second length of 15 mm to 22 mm.

Item 54. The method of any one of items 43-53, wherein the cavity has third length of 0.1 mm to 0.4 mm.

Item 55. The method of any one of items 43-54, wherein the cavity is formed from a recess in the flow cell.

Item 56. The method of any one of items 43-55, wherein the cavity is enclosed by an O-ring, wherein the O-ring creates a fluidic boundary.

Item 57. The method of any one of items 43-56, wherein the flow cell comprises a Hele-Shaw flow cell.

Item 58. The method of any one of items 43-57, wherein the first opening, the second opening, or both are located on opposite sides of the cavity.

Item 59. The method of any one of items 43-58, wherein the first opening, the second opening, or both comprises a plurality of holes.

Item 60. The method of item 59, wherein the plurality of holes comprises two to fifteen holes.

Item 61. The method of item 59 or 60, wherein each of the plurality of holes are 100 microns to 400 microns.

Item 62. A method of extracting biomolecules from a substrate, comprising:
(a) providing a system comprising:
   i. a flow cell comprising a cavity, wherein the cavity comprises a first opening and a second opening, wherein the cavity comprises a planar surface that is substantially parallel to a body force;
   ii. a first reservoir for holding a liquid connected to the first opening; and
   iii. a second reservoir connected to the second opening;
(b) providing a substrate comprising a plurality of biomolecules to the cavity;
(c) introducing the liquid to the cavity of the flow cell through the first opening;
(d) evacuating the liquid from the cavity of the flow cell through the first opening, wherein the liquid comprises the plurality of biomolecules, thereby extracting the plurality of biomolecules from the substrate.

Item 63. The method of item 62, further comprising removing the liquid in excess from the second opening after introducing the liquid to the cavity of the flow cell.

Item 64. The method of item 62 or 63, wherein evacuating the liquid from the cavity of the flow cell through the first opening comprises introducing air to the cavity through the second opening.

Item 65. The method of any one of items 62-64, further comprising collecting the liquid comprising the plurality of biomolecules in a sample collector.

Item 66. The method of any one of items 62-65, further comprising storing the sample collector.

Item 67. The method of any one of items 62-66, wherein the liquid is introduced at a fill rate of 10 uL/s to 50 uL/s.

Item 68. The method of any one of items 62-67, wherein a volume of the liquid introduced to the cavity is 500 uL to 700 uL.

Item 69. The method of any one of items 62-68, wherein the liquid is evacuated from the cavity at an evacuation rate of 0.5 uL/s to 50 uL/s.

Item 70. The method of any one of items 62-69, further comprising mixing more than one liquid from a plurality of reservoirs, each holding a different liquid.

Item 71. The method of any one of items 62-70, wherein the liquid comprises a reagent for biomolecule extraction.

Item 72. The method of any one of items 62-71, wherein the liquid has a surface tension of 1×10⁻³ N/m to 90×10⁻³ N/m.

Item 73. The method of any one of items 62-72, wherein the liquid has a viscosity of 0.1×10⁻³ Pa s to 5×10⁻³ Pa s.

Item 74. The method of any one of items 62-73, wherein the cavity is oriented at a first angle of 90° relative to the horizontal plane, wherein the horizontal plane is perpendicular to the body force.

Item 75. The method of any one of items 62-74, wherein the cavity is further oriented a second angle of 45° relative to the horizontal plane.

Item 76. The method of any one of items 62-75, wherein the cavity has a first length of 15 mm to 22 mm and a second length of 15 mm to 22 mm.

Item 77. The method of any one of items 62-76, wherein the cavity has third length of 0.1 mm to 0.4 mm.

Item 78. The method of any one of items 62-77, wherein the cavity is formed from a recess in the flow cell.

Item 79. The method of any one of items 62-78, wherein the cavity is enclosed by an O-ring, wherein the O-ring creates a fluidic boundary.

Item 80. The method of any one of items 62-79, wherein the flow cell comprises a Hele-Shaw flow cell.

Item 81. The method of any one of items 62-80, wherein the first opening, the second opening, or both are located on opposite sides of the cavity.

Item 82. The method of any one of items 62-81, wherein the first opening, the second opening, or both comprises a plurality of holes.

Item 83. The method of item 82, wherein the plurality of holes comprises two to fifteen holes.

Item 84. The method of item 82 or 83, wherein each of the plurality of holes are 100 microns to 400 microns.

Item 85. A platform for biomolecule extraction, comprising:
(a) a biomolecule extraction system comprising one or more components, wherein the one or more components comprise a flow cell comprising a cavity for holding a substrate comprising biomolecules, a first reservoir, and a second reservoir; and
(b) an apparatus comprising at least one logic element for performing one or more operations based on sensor data from one or more components of the biomolecule extraction system; wherein one or more operations comprise:
   (i) determining a timing for opening or closing one or more valves connecting the one or more components;
   (ii) adjusting one or more parameters of the biomolecule extraction system, wherein the one or more parameters comprises a fill rate of the liquid, a volume of the liquid, the liquid, an evacuation rate of the liquid, a capillary number, or one or more angles of the flow cell relative to a horizontal plane, wherein the horizontal plane is perpendicular to a body force;
   (iii) determining a recovery efficiency of the liquid evacuated from the cavity comprising biomolecules; or
   (iv) any combination thereof.

Item 86. The platform of item 85, further comprising a cloud computing resource communicably coupled to the apparatus.

Item 87. The platform of item 85 or 86, wherein the computer-implemented system comprises at least one processor, a memory, and instructions executable by at least one processor.

Item 88. The platform of any one of items 85-87, wherein the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC).

Item 89. The platform of any one of items 85-88, wherein the body force comprises gravity.

Item 90. The platform of any one of items 85-89, wherein the platform further comprises a synthesis module, a sequencing module, an amplification module, or any combination thereof.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

1. A system for extracting biomolecules from a substrate, comprising:
(a) a flow cell comprising a cavity, wherein the cavity comprises a planar surface that is substantially parallel to a body force, and wherein the planar surface comprises a substrate comprising a plurality of biomolecules;
(b) a first reservoir connected to the flow cell, wherein the first reservoir comprises a liquid for extracting the plurality of biomolecules from the substrate; and
(c) a second reservoir connected to the flow cell for displacing liquid in the cavity.

2. The system of claim 1, further comprising a controller communicatively coupled to one or more actuators that open and close valves connected to the flow cell, the first reservoir, or the second reservoir.

3. The system of claim 2, wherein the controller is communicatively coupled to one or more electronic sensors, mechanical sensors, or both that sense conditions of the flow cell, wherein the controllers is programed to regulate flow of fluids in the system.

4. The system of claim 1, wherein the cavity comprises a first opening and a second opening.

5. The system of claim 4, further comprising a first manifold connecting the cavity and the first reservoir, wherein the first manifold is connected to the first opening.

6. The system of claim 4, further comprising a second manifold connecting the cavity and the second reservoir, wherein the second manifold is connected to the second opening.

7. The system of claim 4, wherein the first opening, the second opening, or both are located on opposite sides of the cavity.

8. The system of claim 4, wherein the first opening, the second opening, or both comprises a plurality of holes.

9. The system of claim 8, wherein the plurality of holes comprises two to fifteen holes.

10. The system of claim 8, wherein each of the plurality of holes are 100 microns to 400 microns.

11. The system of claim 1, wherein the second reservoir comprises a pressurized reservoir.

12. The system of claim 1, wherein the second reservoir comprises a pump.

13. The system of claim 1, further comprising a sample collection reservoir connected to the flow cell for collecting the plurality of biomolecules.

14. The system of claim 13, wherein the sample collection reservoir is connected to the flow cell through the first manifold.

15. The system of claim 6, wherein the flow cell and the second reservoir are connected through the second manifold.

16. The system of claim 1, further comprising a waste reservoir connected to the flow cell for collecting waste from the system.

17. The system of claim 16, wherein the waste reservoir is connected to the flow cell through the first manifold, the second manifold, or both.

18. The system of claim 1, further comprising a plurality of reservoirs for holding liquid.

19. The system of claim 18, wherein each liquid of the plurality of reservoirs comprises a different liquid.

20. The system of claim 1, wherein the liquid comprises a reagent for biomolecule extraction.
